(19) United States
(12) Patent Application Publication
(10) Pub. No.: US 2021/0383115 A1
(43) Pub. Date: Dec. 9, 2021

(54) SYSTEMS AND METHODS FOR 3D SCENE AUGMENTATION AND RECONSTRUCTION

(71) Applicants: Emil Alon, Pardes Hana (IL); Eyal Rozenman, Motsa Illit (IL); RESONAI INC., Tel Aviv (IL)

(72) Inventors: Emil ALON, Pardes Hana (IL); Eyal ROZENMAN, Motsa Illit (IL)

(73) Assignee: Resonai Inc., Tel Aviv (IL)

(21) Appl. No.: 17/283,280

(22) PCT Filed: Oct. 9, 2019
(86) PCT No.: PCT/IB2019/058618

§ 371 Date: Apr. 7, 2021

Related U.S. Application Data
(60) Provisional application No. 62/814,513, filed on Mar. 6, 2019.
(60) Provisional application No. 62/743,065, filed on Oct. 9, 2018.

(51) Int. Cl. G06K 9/00; G06K 9/62; B25J 9/16; B25J 19/02

(52) U.S. Cl. CPC G06K 9/00671; B25J 19/023; B25J 9/1602; G06K 9/6202

(57) ABSTRACT

A computer-implemented visual input reconstruction system for enabling selective insertion of content into preexisting media content frames may include at least one processor configured to perform operations. The operations may include accessing a memory storing object image identifiers associated with objects and transmitting, to one or more client devices, an object image identifier. The operations may include receiving bids from one or more client devices and determining a winning bid. The operations may include receiving winner image data from a winning client device and storing the winner image data in the memory. The operations may include identifying, in a preexisting media content frame, an object insertion location. The operations may include generating a processed media content frame by inserting a rendition of the winner image data at the object insertion location in the preexisting media content frame and transmitting the processed media content frame to one or more user devices.

### I. CROSS-REFERENCE TO RELATED APPLICATIONS

This application is based on and claims benefit of priority of U.S. Provisional Patent Application No. 62/743,065, filed Oct. 9, 2018, and U.S. Provisional Patent Application No. 62/814,513, filed Mar. 6, 2019, the contents of both of which are incorporated herein by reference in their entireties.

### II. TECHNICAL FIELD

The present disclosure relates generally to systems and methods for generating, augmenting or reconstructing a two-dimensional (2D) or three-dimensional (3D) scene or image. More particularly, the disclosed embodiments are directed to receiving a scene from an audiovisual environment and altering, augmenting, or reconstructing one or more portions of the received scene. The scene may be from, for example, a virtual reality environment, an augmented reality environment, a mixed reality environment, a 2D or 3D videogame environment, a 2D or 3D scan, a 2D or 3D still or video camera image or images, etc.

### III. BACKGROUND INFORMATION

Advertisers and others may wish to place advertisements or other messages or images within 2D or 3D environments in a targeted and effective way to reach audiences. Advertisers may include individuals or organizations seeking to sell products or services, a political organization with a message, a religious organization, an agent or an agency, a non-profit organization, and/or any other individuals or organizations.

Media content providers may wish to provide competitive bidding opportunities for advertisers. Media content providers may include game developers, video producers, a streaming service provider, virtual reality providers, augmented or mixed reality providers, and/or any other media content provider. Further, media content providers and advertisers may wish to dynamically insert messages, images, and/or other data into content. Media content providers and advertisers may wish to insert content into media for targeted audiences in real-time. Generally, media content providers and advertisers may wish to place content into 2D or 3D environments in a natural manner so that content may appear to be a part of scene and not foreign to the scene.

For example, a content provider may wish to provide a competitive bidding opportunity to replace a beverage container appearing in a 2D or 3D environment with a branded beverage. Advertisers may wish to place certain branded beverages in content provided to a specific audience (e.g., a diet soda for a health-conscious audience). Advertisers may wish to place a different branded beverage in the same or different content when provided to a different specific audience (e.g., an energy drink for a late-night audience).

Conventional approaches for identifying and creating bidding opportunities and for dynamically inserting content suffer from several drawbacks. For example, conventional approaches may be unable to place advertisements based on the intended audience. Further, conventional approaches may suffer from deficiencies when attempting to identify a target media item to replace with a matching substitute from an advertiser or other third-party. As another example, conventional approaches may be unable to adapt advertisement content into a 2D or 3D environment in a natural manner.

Therefore, in view of the shortcomings and problems with conventional approaches, there is a need for flexible, unconventional approaches that efficiently, effectively, and in real-time identify and manage competitive bidding opportunities and place content in a 2D or 3D scene in a natural manner and for a particular audience.

In some cases, a content provider (e.g., a game developer, an advertiser, a movie maker, etc.) may receive a scan of a real-world environment and wish to develop a 3D model of the environment (i.e., a scene). A content provider may receive a scene from a memory device associated with the content provider or from a device associated with another party. In some cases, a content provider may wish to insert a new object into a scene. For example, a content provider may wish to create a scene that includes a living room based on a scan of a living room. A content provider may wish to insert a new chair into a scene or to replace a scene chair with a new chair.

However, conventional methods of inserting content suffer from deficiencies. For example, conventional approaches may be unable to accept an incomplete scan (i.e., a scan that captures a partial representation) of an object and generate a scene, modify a scene, or replace the object in the scene. Further, conventional methods may be unable to combine aspects of one object with another object. For example, conventional methods may be unable to apply a texture of a new object (e.g., an object received from a memory device) onto an object in a scene.

Further, a conventional system may be unable to identify which possible replacement objects may most closely match an object in a scene and select an appropriate match. Generally, conventional methods may be unable to render a modified scene to incorporate a new object in a natural-looking manner so that the incorporated object appears to be part of the scene.

Therefore, in view of the shortcomings and problems with conventional approaches, there is a need for unconventional approaches that can identify a matching object, insert a matching object into a scene, and generate a natural-looking modified scene based on a complete or an incomplete scan.

A content provider or user may receive an image from a memory device associated with the content provider or user, or from a device associated with another party. In some cases, a content provider or user may receive a still image and wish to animate a portion of the image to make the image appear more lifelike or to bring attention to the image.

Conventional methods of inserting content such as animation of an object suffer from deficiencies. Conventional methods may be unable to combine aspects of one object with another object. For example, conventional methods may be unable to apply a feature of a new object (e.g., animation of a movable portion of the object) onto an object within an image or scene. Generally, conventional methods may be unable to render a modified scene to incorporate a new object including a moving portion in a natural-looking manner so that the incorporated object appears to be part of the image or scene.

Therefore, in view of the shortcomings and problems with conventional approaches, there is a need for unconventional approaches that may identify an object similar to an object in an image or scene, construct a movable version of the object using movement data associated with the similar object, construct a hybrid image, and output the hybrid image for display.

In some cases, a content provider or user (e.g., a game developer, an advertiser, a movie maker, a game player, a student, etc.) may receive a partial image of an object. Such a rendering may not be usable. For example, a player may scan his or her own room, and may want to play a 3D game based on the room where he/she may move objects. The game may, therefore, need to generate a room with objects that are similar to those in the player's room, to be able to “view” the back side of various moved objects, a view not available in the scan. Thus, content providers may desire an ability to complete the partial image to make a complete 3D model of the object for insertion in a scene in an augmented reality or virtual gaming environment.

However, conventional methods for creating 3D audiovisual content may suffer from deficiencies. For example, conventional approaches may be unable to transfer an incomplete scan (i.e., a scan that captures a partial representation) of an object into 3D content. Further, conventional methods may be unable to generate a complete image of an object based on an incomplete or partial image. More generally, conventional methods may be unable to render a modified scene to incorporate a partial image of an object in a natural looking manner so that the incorporated object appears complete and part of the scene.

Therefore, in view of the shortcomings and problems with conventional approaches, there is a need for unconventional approaches that can combine a partial image of an object with additional information in order to construct a simulated full 3D model, and output the full 3D model.

In many cases a robot may interact with an environment to perform a variety of operations. For example, a robot cleaner may move around a room for cleaning purposes. As another example, a robot lawn mower may travel around a lawn or outdoor area for the purpose of mowing grass. In yet another example, an autonomous vehicle may be used to perform various operations at a work site or an industrial location, or a robot may be used to perform assembly, welding, etc., on an automated assembly line. The robot may encounter, for example, one or more objects (e.g. chair, table, lamp, etc. in a room) or obstacles (e.g. rocks, water faucets, etc. in a garden) or tools and fixtures (e.g. assembly or welding tools on an assembly line) in the environment associated with the robot.

It may be helpful for the robot to recognize whether the objects it encounters in its environment may be movable or immovable. If an object is movable, it may also be helpful for the robot to recognize the movement characteristics (distance of movement, speed of movement, force of movement/force required to move, acceleration characteristics, etc.) of the object. For example, it may be helpful for a cleaning robot to recognize whether an object in the room is movable, which in turn may allow the robot to move the object from its current location to allow the robot to clean the room more efficiently. It may also be helpful for the robot to recognize an amount or speed of movement of an object in the room in response to an applied stimulus so that the robot may adjust a magnitude and/or direction of a stimulus applied to the object to control a movement of the object.

Conventional methods of controlling robots in a home, commercial, or industrial environment, however, suffer from deficiencies. For example, conventional robots may not be capable of determining whether an object is movable or the manner in which the object may be movable in response to an external stimulus. Consequently, operations of such robots may be limited to moving the robots around the objects in the environment without interacting with the objects. These limitations may make the operations of the robots inefficient. For example, if a cleaning robot must always go around an object, the amount of time required to clean a room may be greater than if the robot were able to move the object to one side making it easier for the robot to clean the room. As another example, the cleaning robot may not be able to clean the location occupied by the object if the robot is not capable of moving the object.

Therefore, in view of the shortcomings and problems with conventional approaches for controlling robots, there is a need for unconventional approaches that can identify one or more objects in the environment associated with a robot, determine the movability characteristics of the identified objects, and control the robots to interact with the objects based on the movability characteristics.

In some cases, a media content provider may receive a scan of a real-world environment and wish to develop a 3D model of the environment (i.e., a scene). A media content provider may receive the scan of a scene from a device associated with the media content provider or from a device associated with another party. A content provider may wish to insert a new object into a scene. For example, a content provider may receive a scene of a living room and may wish to add to that scene additional complementary objects (e.g. flower vase, coffee table, etc.) that typically form part of a living room. In other cases the content provider may wish to replace an object already present in the room (e.g. replace scene chair with a new chair of different type or design).

A consumer user may also wish to create a scene with additional objects that complement the objects found in a scene. For example, a user may receive a scene of a portion of the user's home (e.g. backyard). The user may wish to receive suggestions for additional complementary objects that would be appropriate with current objects found in the scene. For example, the user may be shopping for yard furniture (e.g. hammock, umbrella, etc.). The user may wish to receive suggestions for the complementary objects and may further wish to preview the scene including the complementary objects, for example, before making purchases.

Conventional methods of generating 3D content, however, may suffer from deficiencies. For example, conventional approaches may be unable to correctly identify and suggest relevant objects that are typically associated with objects found in a particular scene. Conventional approaches may also be incapable of allowing user interaction to identify appropriate complementary objects that typically are found in a particular scene.

Therefore, in view of the shortcomings and problems with conventional approaches, there is a need for unconventional approaches that can identify a complementary object, insert a complementary object into a scene, and generate a hybrid scene based on a scan of a scene.

Advertisers and others may wish to place advertisements or other messages or images within 2D or 3D environments in a targeted and effective way to reach audiences. Advertisers may include individuals or organizations seeking to sell products or services, a political organization with a message, a religious organization, an agent or an agency, a non-profit organization, and/or any other individuals or organizations.

Media content providers may wish to provide competitive bidding opportunities for advertisers. Media content providers may include game developers, video producers, a streaming service provider, virtual reality providers, augmented or mixed reality providers, and/or any other media content provider. Further, media content providers and advertisers may wish to dynamically insert messages, images, and/or other data into broadcast content. Media content providers and advertisers may wish to insert content into media for targeted audiences in real-time. Generally, media content providers and advertisers may wish to place content into 3D environments in a natural manner so that content may appear to be a part of scene and not foreign to the scene.

For example, a content provider may wish to provide a competitive bidding opportunity to replace a beverage container appearing in a 3D broadcast scene with a branded beverage. Advertisers may wish to place certain branded beverages in the broadcast scene provided to a specific audience (e.g., a diet soda for a health-conscious audience). Advertisers may wish to place a different branded beverage in the same or different broadcast scene when provided to a different specific audience (e.g., an energy drink for a late-night audience).

Conventional approaches for identifying and creating bidding opportunities and for dynamically inserting content suffer from several drawbacks. For example, conventional approaches may be unable to place advertisements based on the intended audience. Further, conventional approaches may suffer from deficiencies when attempting to identify a target media item to replace with a matching substitute from an advertiser or other third-party. As another example, conventional approaches may be unable to adapt advertisement content into a 3D environment of a preexisting broadcast 3D scene in a natural manner.

Therefore, in view of the shortcomings and problems with conventional approaches, there is a need for flexible, unconventional approaches that efficiently and effectively identify and manage competitive bidding opportunities and place content in a 3D scene in a natural manner and for a particular audience.

### IV. BRIEF DESCRIPTION OF THE DRAWINGS

The accompanying drawings, which are incorporated in and constitute a part of this disclosure, illustrate various disclosed embodiments. in the drawings:

FIG. 1 depicts an exemplary system for augmenting or reconstructing a 2D or 3D scene or image, consistent with embodiments of the present disclosure.

FIG. 2 illustrates an exemplary computational device, consistent with embodiments of the present disclosure.

FIG. 3 depicts an exemplary system for selecting bids from advertisers and inserting an image corresponding to a winning bid into an existing scene from an audiovisual environment, consistent with embodiments of the present disclosure.

FIG. 4 depicts an exemplary method of selecting and inserting advertisement images into an existing scene from an audiovisual environment, consistent with embodiments of the present disclosure.

FIG. 5 depicts an exemplary method of enabling selective insertion of content into preexisting content frames, consistent with embodiments of the present disclosure.

FIG. 6 depicts an exemplary method of placing a bid to insert content into preexisting content frames, consistent with embodiments of the present disclosure.

FIG. 7 depicts an exemplary method of selecting a 3D model for replacing a CAD object in a scene, consistent with embodiments of the present disclosure.

FIG. 8 depicts an exemplary method of selecting a 3D model and replacing a CAD object in an existing scene with the selected 3D model, consistent with embodiments of the present disclosure.

FIG. 9 depicts an exemplary method of generating a 3D scene, consistent with embodiments of the present disclosure.

FIG. 10 depicts an exemplary system for augmenting, reconstructing and providing animation to a 2D or 3D scene or image, consistent with embodiments of the present disclosure.

FIG. 11 depicts an exemplary object (e.g., a fan) in an input 3D scene being viewed by a user, consistent with embodiments of the present disclosure.

FIG. 12 depicts replacement of one or more portions of an object from an input 3D scene with corresponding portions of an object in a data structure, including animations, consistent with embodiments of the present disclosure.

FIG. 13 depicts a flowchart for a process of animating portions of a still image, consistent with embodiments of the present disclosure.

FIG. 14 depicts an example of meshing a partial image to simulate a full 3D model, consistent with embodiments of the present disclosure.

FIG. 15 depicts an exemplary method of meshing a partial image to simulate a full 3D model, consistent with embodiments of the present disclosure.

FIG. 16 depicts an exemplary system for controlling a robot, consistent with embodiments of the present disclosure.

FIG. 17 depicts an exemplary method of controlling a robot based on characteristics of a segmented object from a scene, consistent with embodiments of the present disclosure.

FIG. 18 depicts an exemplary method of controlling a robot based on the movability characteristics associated with an object in the robot's environment, consistent with embodiments of the present disclosure.

FIG. 19 depicts an exemplary system for generating 3D content, consistent with embodiments of the present disclosure.

FIG. 20 depicts an exemplary method of automating 3D content creation for adding a complementary object in a scene, consistent with embodiments of the present disclosure.

FIG. 21 depicts an exemplary method of selecting a complementary object and combining a 3D representation of the complementary object in an existing scene, consistent with embodiments of the present disclosure.

FIG. 22 depicts an exemplary method of identifying at least one complementary object, consistent with embodiments of the present disclosure.

FIG. 23 depicts an exemplary method of selecting and inserting advertisement images into a broadcast scene from an audiovisual environment, consistent with embodiments of the present disclosure.

### V. SUMMARY

Some disclosed embodiments include a computer-implemented visual input reconstruction system for enabling selective insertion of content into preexisting content frames. The system may include at least one processor. The processor may be configured to access a memory storing a plurality of object image identifiers associated with a plurality of objects. The processor may be configured to transmit, to one or more client devices, at least one object image identifier of the plurality of object image identifiers. The processor may be configured to receive, from the one or more client devices, one or more bids associated with the at least one object image identifier. The processor may be configured to determine a winning bid from among the received one or more bids, the winning bid being associated with a winning client device from among the one or more client devices. The processor may be configured to receive winner image data from the winning client device and store the winner image data in the memory. The processor may be configured to identify, in at least one preexisting media content frame, an object insertion location for an object corresponding to the at least one object image identifier. The processor may be configured to generate at least one processed media content frame by processing the at least one preexisting media content frame to insert at least a rendition of the winner image data at the object insertion location. The processor may be configured to transmit the at least one processed media content frame to one or more user devices.

In some embodiments, the at least one object image identifier comprises at least one of a shape, a descriptor of a shape, a product, or a descriptor of a product.

In some embodiments, the preexisting media content frames include at least one of a still image, a series of video frames, a series of virtual three dimensional content frames, or a hologram.

In some embodiments, the at least one processor is further configured to perform image processing on the winner image data to render the winner image data compatible with a format of the preexisting media content frame.

In some embodiments, the at least one preexisting media content frame includes a plurality of frames constituting a virtual reality field of view, and wherein the inserting renders an object from the winning image data within the plurality of frames.

In some embodiments, transmitting includes transmission over a network.

In some embodiments, transmitting includes transmitting the processed media content frame to a first user device of the one or more user devices, and wherein the at least one processor is configured to transmit the at least one preexisting media content frame to a second user device in a manner excluding the winner image data.

In some embodiments, the winner image data is inserted into the at least one preexisting media content frame such that the winner image data is overlaid on preexisting content in the at least one preexisting media content frame.

In some embodiments, the winner image data is inserted into the at least one preexisting media content frame such that an object of the winner image data replaces preexisting content in the at least one preexisting media content frame.

In some embodiments, the winner image data is inserted on a portion of the object corresponding to the at least one object image identifier.

In some embodiments, the processor is further configured to receive instructions from the winning client device, the instructions comprising size restrictions for the object corresponding to the at least one object image identifier, and wherein inserting at least a rendition of the winner image data is based on the instructions.

In some embodiments, the object corresponding to the at least one object image identifier includes at least one of a wall, a billboard, a picture frame, or a window.

In some embodiments, the winner image data displayed in the preexisting media content frame changes after a predetermined period of time.

In some embodiments, the processor is further configured to obtain the at least one preexisting media content frame in real time and to insert the rendition of the winner image data in the at least one preexisting media content frame in real time.

Further disclosed embodiments include a computer-implemented method for enabling selective insertion of content into preexisting content frames. The method may include accessing a memory storing a plurality of object image identifiers associated with a plurality of objects. The method may include transmitting, to one or more client devices, at least one object image identifier of the plurality of object image identifiers. The method may include receiving, from the one or more client devices, one or more bids associated with the at least one object image identifier. The method may include determining a winning bid from among the received one or more bids. The winning bid may be associated with a winning client device from among the one or more client devices. The method may include receiving winner image data from the winning client device and storing the winner image data in the memory. The method may include identifying, in at least one preexisting media content frame, an object insertion location for an object corresponding to the at least one object image identifier. The method may include generating at least one processed media content frame by processing the at least one preexisting media content frame to insert at least a rendition of the winner image data at the object insertion location. The method may include transmitting the at least one processed media content frame to one or more user devices.

Additional disclosed embodiments include non-transitory computer readable storage media that may store program instructions, which when executed by at least one processor, may cause the at least one processor to execute operations enabling selective insertion of content into preexisting content frames. The operations may include accessing a memory storing a plurality of object image identifiers associated with a plurality of objects. The operations may include transmitting, to one or more client devices, at least one object image identifier of the plurality of object image identifiers. The operations may include receiving, from the one or more client devices, one or more bids associated with the at least one object image identifier. The operations may include determining a winning bid from among the received one or more bids. The winning bid may be associated with a winning client device from among the one or more client devices. The operations may include receiving winner image data from the winning client device and storing the winner image data in the memory. The operations may include identifying, in at least one preexisting media content frame, an object insertion location for an object corresponding to the at least one object image identifier. The operations may include generating at least one processed media content frame by processing the at least one preexisting media content frame to insert at least a rendition of the winner image data at the object insertion location. The operations may include transmitting the at least one processed media content frame to one or more user devices.

Additional disclosed embodiments include a system for generating a three-dimensional (3D) scene. The system may include at least one processor. The processor may be configured to receive a scene based on a scan. The scene may include at least one object. The processor may be configured to process image elements in the scene to segment the scene into scene-components. The image elements may comprise at least one of a voxel, a point, or a polygon. The processor may be configured to identify, based on a comparison of the scene-components with stored image data, a matched-component from among the scene-components. The matched-component may correspond to a component of the at least one object. The processor may be configured to identify, based on the matched-component, image elements corresponding to the at least one object. The processor may be configured to obtain a CAD model from a storage location based on the image elements corresponding to the at least one object. The processor may be configured to generate a modified scene by combining the CAD model of the object and the scene. The processor may be configured to output the modified scene for 3D display.

In some embodiments, the modified scene is a hybrid scene comprising at least a portion of the CAD model and at least a portion of the at least one object.

In some embodiments, the scan is an incomplete scan and wherein the modified scene comprises a refinement of the scene based on the semantics of the CAD model.

In some embodiments, the at least one at least one processor is further configured to: access semantics associated with the CAD model, the semantics including a script representing movability characteristics of the at least one object; and apply the script to the CAD model in the hybrid scene, the script being configured to be executed to render the object movable in the hybrid scene.

In some embodiments, the hybrid scene including the script is outputted for 3D display.

In some embodiments, the at least one processor is further configured to: select another script associated with the object, the another script representing an interaction between the object and at least one other object in the scene; and apply the script to the CAD model in the hybrid scene.

In some embodiments, the at least one processor is further configured to: extract material properties from the matched component; and apply the extracted material properties to the CAD model.

Additional disclosed embodiments include a computer-implemented method for generating a three-dimensional (3D) scene. The method may include receiving a scene based on a scan. The scene may include at least one object. The method may include processing image elements in the scene to segment the scene into scene-components. The image elements may comprise at least one of a voxel, a point, or a polygon. The method may include identifying, based on a comparison of the scene-components with stored image data, a matched-component from among the scene-components. The matched-component may correspond to a component of the at least one object. The method may include identifying, based on the matched-component, image elements corresponding to the at least one object. The method may include obtaining a CAD model from a storage location based on the image elements corresponding to the at least one object. The method may include generating a modified scene by combining the CAD model of the object and the scene. The method may include outputting the modified scene for 3D display.

In some embodiments, the method further includes: accessing semantics associated with the CAD model, the semantics including a script representing movability characteristics of the at least one object; and applying the script to the CAD model in the hybrid scene, the script being configured to be executed to render the object movable in the hybrid scene.

In some embodiments, the method further includes: selecting another script associated with the object, the another script representing an interaction between the object and at least one other object in the scene; and applying the script to the CAD model in the hybrid scene.

In some embodiments, the method further includes: extracting material properties from the matched component; and applying the extracted material properties to the CAD model.

Additional disclosed embodiments include non-transitory computer readable storage media that may store program instructions, which when executed by at least one processor, may cause the at least one processor to execute operations enabling generation of a 3D scene. The operations may include receiving a scene based on a scan. The scene may include at least one object. The operations may include processing image elements in the scene to segment the scene into scene components. The image elements may comprise at least one of a voxel, a point, or a polygon. The operations may include identifying, based on a comparison of the scene components with stored image data, a matched component from among the scene components. The matched component may correspond to a component of the at least one object. The operations may include identifying, based on the matched component, image elements corresponding to the at least one object. The operations may include obtaining a CAD model from a storage location based on the image elements corresponding to the at least one object. The operations may include generating a modified scene by combining the CAD model of the object and the scene. The operations may include outputting the modified scene for 3D display.

Additional disclosed embodiments include a computer-implemented system for animating portions of a still image. The system may include at least one processor. The processor may be configured to receive a still image of an object. The processor may be configured to perform a look up to identify at least one image of a similar object stored in a memory. The memory may include segmentation data differentiating in a stored image of a similar object a movable portion from an immovable portion, and movement data associated with the movable portion. The processor may be configured to perform an analysis of voxels in a received still image of an object to segment the still image into discrete components. The processor may be configured to compare the discrete components with the movable portion of at least one similar object, to identify in a received image at least one still rendering of a movable discrete component, different from immovable components of the still image. The processor may be configured to extract a still rendering of movable discrete component from a still image. The processor may be configured to construct using a still rendering and movement data, a movable version of a still rendering of a movable component. The processor may be configured to construct a hybrid image by combining immovable components of a still image with a constructed movable version of a still rendering of a movable component to thereby enable a movable version of a movable discrete component to move in the hybrid image while immovable components from the still image remain motionless.

In some embodiments, the still image includes a head of a person, the discrete components include a head and hair of the person, and the at least one processor is configured to cause in the hybrid image the head to remain motionless and the hair to move.

In some embodiments, the still image includes a body of water, the discrete components include waves and a shore, and the at least one processor is configured to cause in the hybrid image the shore to remain motionless and the waves to move.

In some embodiments, the still image includes a tree, the discrete components include a trunk and leaves, and the at least one processor is configured to cause in the hybrid image the trunk to remain motionless and the leaves to move.

In some embodiments, the still image includes a person, the discrete components include a body of the person and an article of clothing, and wherein the at least one processor is configured to cause in the hybrid image the body to remain motionless and the article of clothing to move.

In some embodiments, the still image includes a timepiece, the discrete components include a face and hands, and the at least one processor is configured to cause in the hybrid image the timepiece to display a different time.

In some embodiments, the still image includes a pet, the discrete components include a body and fur, and the at least one processor is configured to cause in the hybrid image the body to remain motionless and the fur to move.

In some embodiments, the still image includes an animal, the discrete components include a body and a tail, and the at least one processor is configured to cause in the hybrid image the body to remain motionless and the tail to move.

In some embodiments, the movable portion in the stored image of the similar object includes a plurality of movable portions, and the at least one processor is further configured to: receive selection of a selected movable portion from among the movable portions; compare the discrete components with the selected movable portion to identify the at least one still rendering of the movable discrete component; construct using the still rendering and the movement data, the movable version of the still rendering of the selected movable component; and construct the hybrid image by combining the immovable components of the still image with the constructed movable version of the still rendering of the selected movable component.

In some embodiments, the at least one processor is configured to detect the plurality of movable portions and prompt the user for the selection.

In some embodiments, the movement data is configurable by a user.

Additional disclosed embodiments include a computer-implemented method for animating portions of a still image. The method may include receiving a still image of an object. The method may include performing a look up to identify at least one image of a similar object stored in memory. The memory may include segmentation data differentiating in a stored image of a similar object a movable portion from an immovable portion. The memory may include movement data associated with a movable portion. The method may include performing an analysis of voxels in a received still image of an object to segment the still image into discrete components. The method may include comparing the discrete components with the movable portion of at least one similar object, to identify in a received image at least one still rendering of a movable discrete component, different from immovable components of a still image. The method may include extracting the still rendering of a movable discrete component from a still image. The method may include constructing using a still rendering and movement data, a movable version of the still rendering of a movable component. The method may include constructing a hybrid image by combining immovable components of a still image with a constructed movable version of a still rendering of a movable component to thereby enable the movable version of a movable discrete component to move in the hybrid image while the immovable components from the still image remain motionless. The method may include outputting the hybrid image.

In some embodiments, outputting the hybrid image includes displaying the hybrid image.

In some embodiments, outputting the hybrid image includes storing the hybrid image.

In some embodiments, outputting the hybrid image includes transferring the hybrid image.

In some embodiments, the first and second objects are similar.

In some embodiments, the first and second objects are substantially different.

In some embodiments, the first and second objects are selected by a user.

In some embodiments, the movement data is configurable by a user.

Additional disclosed embodiments include non-transitory computer readable storage media that may store program instructions, which when executed by at least one processor, may cause the at least one processor to execute operations enabling animating portions of a still image. The operations may include receiving a still image of an object. The operations may include performing a look up to identify at least one image of a similar object stored in memory. The memory may include segmentation data differentiating in a stored image of a similar object a movable portion from an immovable portion. The memory may include movement data associated with a movable portion. The operations may include performing an analysis of voxels in a received still image of an object to segment the still image into discrete components. The operations may include comparing the discrete components with the movable portion of at least one similar object, to identify in a received image at least one still rendering of a movable discrete component, different from immovable components of a still image. The operations may include extracting the still rendering of a movable discrete component from a still image. The operations may include constructing using a still rendering and movement data, a movable version of the still rendering of a movable component. The operations may include constructing a hybrid image by combining immovable components of a still image with a constructed movable version of a still rendering of a movable component to thereby enable the movable version of a movable discrete component to move in the hybrid image while the immovable components from the still image remain motionless. The operations may include outputting the hybrid image.

Additional disclosed embodiments include a computer-implemented system for simulating a complete 3D model of an object from incomplete 3D data. The system may include at least one processor. The processor may be configured to receive a partial image of an object, wherein the partial image is at least one of a 2D image or an incomplete 3D image. The processor may be configured to use a partial image, and to search at least one data structure for additional information corresponding to the partial image. The processor may be configured to determine that a data structure does not include a corresponding 3D model of an object. The processor may be configured to search at least one data structure for a reference 3D model different from an object in a partial image but having similarities to the object in the partial image. The processor may be configured to compare a partial image with a reference 3D model to determine portions of a 3D reference model that generally correspond to missing characteristics of the partial image. The processor may be configured to combine a partial image with additional information to construct a simulated full 3D model of an object. The processor may be configured to output a simulated full 3D model for display on a display device.

In some embodiments, the additional information includes a 3D model that corresponds to the received partial image.

In some embodiments, the additional information includes information derived from partial scans of at least one object similar to the object in the partial image.

In some embodiments, combining includes meshing the partial image with determined portions of the 3D reference model.

In some embodiments, the at least one processor is further configured to identify at least one of a texture and a color of the partial image and, during meshing, to apply the at least one texture and color to the determined portions of the 3D reference model.

In some embodiments, the at least one processor is configured to export the simulated full 3D model into a format compatible with a 3D consumable environment.

In some embodiments, the 3D consumable environment includes at least one of a virtual reality environment and an augmented reality environment.

In some embodiments, the at least one processor is further configured to: receive an input for rotation of the simulated full 3D model by an angle ranging between about 0° and about 360°; rotate the simulated full 3D model based on the input; and display the rotated simulated full 3D model on the display device.

In some embodiments, the at least one processor is further configured to receive an input for scaling the simulated full 3D model, scale the simulated full 3D model based on the input, and display the scaled simulated full 3D model on the display device.

Additional disclosed embodiments include a computer-implemented method for simulating a complete 3D model of an object from incomplete 3D data. The method may include receiving a partial image of an object, wherein the partial image is at least one of a 2D image or an incomplete 3D image. The method may include searching at least one data structure for additional information corresponding to the partial image. The method may include determining that a data structure does not include a corresponding 3D model of an object. The method may include searching at least one data structure for a reference 3D model different from an object in a partial image but having similarities to the object in the partial image, the reference 3D model including additional data. The method may include comparing a partial image with a reference 3D model to determine portions of a 3D reference model that generally correspond to missing characteristics of the partial image. The method may include combining a partial image with additional information, additional data or a combination of additional information and additional data to construct a simulated full 3D model of an object. The method may include outputting a simulated full 3D model for display on a display device.

In some embodiments, the method further includes receiving an input for rotation of the simulated full 3D model by an angle ranging between about 0° and about 360°; rotating the simulated full 3D model based on the input; and displaying the rotated simulated full 3D model on the display device.

In some embodiments, the method further includes receiving an input for scaling the simulated full 3D model, scale the simulated full 3D model based on the input, and display the scaled simulated full 3D model on the display device.

Additional disclosed embodiments include non-transitory computer readable storage media that may store program instructions, which when executed by at least one processor, may cause the at least one processor to execute operations enabling simulating a complete 3D model of an object from incomplete 3D data. The operations may include receiving a partial image of an object, wherein the partial image is at least one of a 2D image or an incomplete 3D image. The operations may include searching at least one data structure for additional information corresponding to the partial image. The operations may include determining that a data structure does not include a corresponding 3D model of an object. The operations may include searching at least one data structure for a reference 3D model different from an object in a partial image but having similarities to the object in the partial image, the reference 3D model including additional data. The operations may include comparing a partial image with a reference 3D model to determine portions of a 3D reference model that generally correspond to missing characteristics of the partial image. The operations may include combining a partial image with additional information, additional data or a combination of additional information and additional data to construct a simulated full 3D model of an object. The operations may include outputting a simulated full 3D model for display on a display device.

Additional disclosed embodiments include a control system for a robot. The system may include at least one processor. The processor may be configured to receive image information for a scene depicting an environment associated with the robot. The processor may be configured to segment the scene to extract an image of at least one object in the scene. The processor may be configured to access a data structure storing information about a plurality of objects. The processor may be configured to compare the extracted image with the information in the data structure to identify corresponding information in the data structure about the at least one object. The corresponding information may include a script representing movability characteristics of the at least one object. The processor may be configured to control the robot by applying the script. Applying the script may cause the robot to interact with the at least one object based on the movability characteristics defined by the script.

In some embodiments, the at least one processor is configured to segment the scene by processing image elements in the scene, the image elements including at least one of a voxel, a point, or a polygon.

In some embodiments, the robot includes a camera configured to generate the image information for the scene.

In some embodiments, the movability characteristics include at least one rule defining a movement of the at least one object based on an external stimulus.

In some embodiments, the at least one processor is configured to adjust the external stimulus exerted by the robot on the at least one object based on the movability characteristics of the at least one object.

In some embodiments, the at least one processor is configured to generate a modified scene based on an interaction of the robot with the at least one object.

In some embodiments, the at least one processor is configured to output the modified scene for display.

In some embodiments, the at least one processor is further configured to: select another script associated with the at least one object, the another script representing an interaction between the at least one object and at least one other object in the scene; and apply the script to the at least one object.

Additional disclosed embodiments include a computer-implemented method for controlling a robot. The method may include receiving image information for a scene depicting an environment associated with the robot. The method may include segmenting the scene to extract an image of at least one object in the scene. The method may include accessing a data structure storing information about a plurality of objects. The method may include comparing the extracted image with the information in the data structure to identify corresponding information in the data structure about the at least one object. The corresponding information may include a script representing movability characteristics of the at least one object. The method may include controlling the robot by applying the script. Applying the script may cause the robot to interact with the at least one object based on the movability characteristics defined by the script.

In some embodiments, segmenting the scene includes processing image elements in the scene, the image elements including at least one of a voxel, a point, or a polygon.

In some embodiments, receiving the image information includes generating the image information for the scene using a camera associated with the robot.

In some embodiments, the method further includes adjusting the external stimulus exerted by the robot on the at least one object based on the movability characteristics of the at least one object.

In some embodiments, the method further includes generating a modified scene based on an interaction of the robot with the at least one object.

In some embodiments, the method further includes outputting the modified scene for display.

In some embodiments, the method further includes: selecting another script associated with the at least one object, the another script representing an interaction between the at least one object and at least one other object in the scene; and applying the script to the at least one object.

Additional disclosed embodiments include non-transitory computer readable storage media that may store program instructions, which when executed by at least one processor, may cause the at least one processor to execute operations for controlling a robot. The operations may include segmenting the scene to extract an image of at least one object in the scene. The operations may include accessing a data structure storing information about a plurality of objects. The operations may include comparing the extracted image with the information in the data structure to identify corresponding information in the data structure about the at least one object. The corresponding information may include a script representing movability characteristics of the at least one object. The operations may include controlling the robot by applying the script. Applying the script may cause the robot to interact with the at least one object based on the movability characteristics defined by the script.

Additional disclosed embodiments include a system for automating three-dimensional (3D) content creation. The system may include at least one processor. The processor may be configured to receive a scan of a scene. The processor may be configured to segment the scan to identify at least one object in the scene. The processor may be configured to extract image data corresponding to the identified object from the scan. The processor may be configured to use the extracted image data to search at least one data structure to identify at least one image of at least one complementary object to the identified object. The processor may be configured to obtain from the at least one data structure a 3D representation of the at least one complementary object. The processor may be configured to generate a hybrid scene by combining the 3D representation of the at least one complementary object with portions of the scan of the scene other than portions corresponding to the identified object. The processor may be configured to output the hybrid scene for presentation on a display device.

In some embodiments, the at least one image of at least one complementary object includes a plurality of images of a plurality of complementary objects.

In some embodiments, the at least one processor is further configured to output for display an index of the plurality of images of the plurality of complementary objects.

In some embodiments, the at least one processor is further configured to: receive, from a user, a selection of at least one of the plurality of complementary objects; and insert the selection into the scan of the scene.

In some embodiments, the extracted image data includes a classification for the identified object.

In some embodiments, the at least one processor identifies the at least one complementary object based on the classification.

In some embodiments, the at least one processor is configured to generate a semantic tag for the at least one identified object in the scene.

In some embodiments, the at least one processor is configured to: compare the semantic tag of the identified object with semantic tags for objects stored in the at least one data structure; and select the at least one complementary object based on the comparison.

In some embodiments, the at least one data structure includes 3D scenes associated with semantic tags.

Additional disclosed embodiments include a computer-implemented method for automating 3D content. The method may include receiving a scan of a scene. The method may include segmenting the scan to identify at least one object in the scene. The method may include extracting imaging data corresponding to the identified object from the scan. The method may include using the extracted image data to search at least one data structure to identify at least one image of at least one complementary object to the identified object. The method may include obtaining from the at least one data structure a 3D representation of the at least one complementary object. The method may include generating a hybrid scene by combining the 3D representation of the at least one complementary object with portions of the received scan other than portions corresponding to the extracted object. The method may include outputting the hybrid scene for presentation on a display device.

In some embodiments, the method further includes outputting for display an index of the plurality of images of the plurality of complementary objects.

In some embodiments, the method further includes: receiving, from a user, a selection of at least one of the plurality of complementary objects; and inserting the selection into the scan of the scene.

In some embodiments, the method further includes identifying the at least one complementary object based on the classification.

In some embodiments, the method further includes generating a semantic tag for the at least one identified object in the scene.

In some embodiments, the method further includes: comparing the semantic tag of the identified object with semantic tags for objects stored in the at least one data structure; and selecting the at least one complementary object based on the comparison.

In some embodiments, the operations further include generating a semantic tag for the at least one identified object in the scene.

Additional disclosed embodiments include non-transitory computer readable storage media that may store program instructions, which when executed by at least one processor, may cause the at least one processor to execute operations enabling automated 3D content creation. The operations may include segmenting the scan to identify at least one object in the scene. The operations may include extracting imaging data corresponding to the identified object from the scan. The operations may include using the extracted image data to search at least one data structure to identify at least one image of at least one complementary object to the identified object. The operations may include obtaining from the at least one data structure a 3D representation of the at least one complementary object. The operations may include generating a hybrid scene by combining the 3D representation of the at least one complementary object with portions of the received scan other than portions corresponding to the extracted object. The operations may include outputting the hybrid scene for presentation on a display device.

Additional disclosed embodiments include a computer-implemented system for adding 3D content to a 3D broadcast scene. The system may include at least one processor. The processor may be configured to display on a plurality of client devices at least one 3D broadcast scene. The processor may be configured to display on the client devices at least one tag corresponding to at least one object in the 3D broadcast scene. The processor may also be configured to display on the client devices instructions for placing at least one bid on the at least one tagged object. Further, the processor may be configured to receive, from the client devices, one or more bids on the at least one tagged object. The processor may be configured to determine a winning bid from among the received one or more bids, the winning bid being associated with a winning client device from among the client devices. The processor may also be configured to receive from the winning client device, winner image data corresponding to the at least one tagged image. The processor may be configured to isolate from the 3D broadcast scene, 3D image data corresponding to the at least one tagged object. Further, the processor may be configured to generate a 3D hybrid rendering of the tagged object by combining the winner image data with the extracted 3D image data. And, the processor may be configured to insert the hybrid rendering into a hybrid 3D broadcast scene.

In some embodiments, the 3D broadcast scene is part of a video game.

In some embodiments, the 3D broadcast scene is part of a 3D movie.

In some embodiments, the 3D broadcast is part of an online advertisement.

In some embodiments, the at least one processor is further configured to perform image processing on the winner image data to render the winner image data compatible with a format of the 3D broadcast scene.

In some embodiments, the 3D broadcast scene includes a plurality of frames, and wherein the inserting renders an object from the winning image data within the plurality of frames.

In some embodiments, the winner image data is inserted into the 3D broadcast scene such that the winner image data is overlaid on preexisting content in the 3D broadcast scene.

In some embodiments, the at least one processor is configured to: generate a spatial semantic graph for each scene, compare the generated spatial semantic graph with spatial semantic graphs of scenes stored in a data structure, identify scenes in the data structure having spatial semantic graphs similar to the generated spatial semantic graph, and determine information about the 3D broadcast scene based on identified scenes in the data structure.

Additional disclosed embodiments include a computer-implemented method for adding 3D content to a 3D broadcast scene. The method may include displaying on a plurality of client devices at least one 3D broadcast scene. The method may also include displaying on the client devices at least one tag corresponding to at least one object in the 3D broadcast scene. Further, the method may include displaying on the client devices instructions for placing at least one bid on the at least one tagged object. The method may include receiving, from one or more client devices, one or more bids on the at least one tagged object. The method may include determining a winning bid from among the bids, the winning bid being associated with a winning client device from the client devices. The method may also include receiving, from the winning client device, winner image data corresponding to the at least one tagged image. The method may also include isolating from the 3D broadcast scene, 3D image data corresponding to the at least one tagged object. The method may include generating a 3D hybrid rendering of the tagged object by combining the winner image data with the extracted 3D image data. The method may also include inserting the hybrid rendering into a hybrid 3D broadcast scene. In addition, the method may include broadcasting the 3D hybrid broadcast scene.

In some embodiments, the method further includes: generating a spatial semantic graph for each scene; comparing the generated spatial semantic graph with spatial semantic graphs of scenes stored in a data structure; identifying scenes having spatial semantic graphs similar to the generated spatial semantic graph; and determining information about the 3D broadcast scene based on the identified scenes in the data structure.

Additional disclosed embodiments include non-transitory computer readable storage media that may store program instructions, which when executed by at least one processor, may cause the at least one processor to execute operations enabling selective insertion of content into a 3D broadcast scene. The operations may include displaying on a plurality of client devices at least one 3D broadcast scene. The method may also include displaying on the client devices at least one tag corresponding to at least one object in the 3D broadcast scene. Further, the operations may include displaying on the client devices instructions for placing at least one bid on the at least one tagged object. The operations may include receiving, from one or more client devices, one or more bids on the at least one tagged object. The operations may include determining a winning bid from among the bids, the winning bid being associated with a winning client device from the client devices. The method may also include receiving, from the winning client device, winner image data corresponding to the at least one tagged image. The method may also include isolating from the 3D broadcast scene, 3D image data corresponding to the at least one tagged object. The operations may include generating a 3D hybrid rendering of the tagged object by combining the winner image data with the extracted 3D image data. The method may also include inserting the hybrid rendering into a hybrid 3D broadcast scene. In addition, the operations may include broadcasting the 3D hybrid broadcast scene.

The disclosed systems and methods may be implemented using a combination of conventional hardware and software as well as specialized hardware and software, such as a machine constructed and/or programmed specifically for performing functions associated with the disclosed method steps. The foregoing general description and the following detailed description are exemplary and explanatory only and are not restrictive of the claims.

### VI. DETAILED DESCRIPTION

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It should also be noted that as used herein and in the appended claims, the singular forms “a,” “an,” and “the” include plural references unless the context clearly dictates otherwise.

### Terms

Voxel: A voxel may be a closed n-sided polygon (e.g., a cube, a pyramid, or any closed n-sided polygon). Voxels in a scene may be uniform in size or non-uniform. Voxels may be consistently shaped within a scene or may vary in a scene.

Mesh: In embodiments of the present disclosure, a mesh may include a set of polygons (e.g., triangles, quadrangles, etc.) in 2D or 3D space representing the external surface of objects in a scene. A mesh may be defined by a set of control points and a set of n-sided polygons created by the control points. An n-sided polygon may have any number “n” of sides. Sides of a polygon may be of any length, and the length of sides may be irregular (i.e., side length may vary within a scene). A mesh may include any number of control points or polygons, such as millions of control points. In some embodiments, a mesh may be created by establishing set of control points and relationships between them. In some embodiments, generating a mesh may include inserting a previously-generated object. A point cloud may include a set of data points in a coordinate system, such orthogonal planes (e.g., X, Y, and Z coordinates). A mesh may be configured to be presented to a user from one or more perspectives comprising a viewpoint location, orientation, and/or zoom. A mesh or point cloud may be created based on a scan. More generally, generating a scene based on a scan may include processing an image to represent it as a mesh, point cloud, or other format. For example, a scan may include taking a snapshot of the real world and representing it digitally in one of the forms discussed above. A mesh may include a plurality of voxels representing a scene or a voxel-mapping of a subset of space. A mesh or point cloud may be created using software, such as WEBVR, VRMESH, MESHROOMVR, FARO SCENE, MESHMAKER, and/or any other program or application configured to generate and/or edit a mesh. A mesh or point cloud may be associated with computing code (i.e., script) defining objects, boundaries, animation, or other properties of a mesh.

Segmenting or Segmentation: Consistent with embodiments of this disclosure, segmenting may include any process or computation that allows for separation of an image into portions or objects identifiable by the system. In some embodiments, the still image may be segmented or characterized into discrete components or parts. Discrete components or parts may include all or a portion of an object. A scene or image may be segmented, for example, by associating groups of image elements (e.g., pixels, points, polygons, voxels, etc.) with each other, and identifying the groups as being associated with separate objects or portions of objects. During segmentation, these groups of elements can be assigned to an object. Segmenting may include tagging, labeling, identifying or otherwise classifying one or more basic elements of a scanned scene (e.g., a triangle in 3D, or a point in 3D) as belonging to an object in the scene. That is, segmenting may include partitioning (i.e., classifying) image elements of a scene into objects. Segmenting may include mapping large numbers of points or polygons (e.g., hundreds of thousands of polygons) to a plurality of discrete components in the still image. Segmenting may include implementing a segmenting algorithm, including implementing object recognition algorithms and/or machine-learning models, to map basic image elements (e.g. voxels) to one or more discrete components. Examples of image segmentation algorithms and methods that can be used include, but are not limited to thresholding, clustering methods, compression methods, histogram-based methods, edge detection, dual clustering methods, region-growing methods, partial differential equation-based methods, such as parametric methods, level-set methods, and fast marching methods; variation methods, graph partitioning methods, watershed transformations, model-based methods, multi-scale methods, semi-automatic segmentation, trainable segmentation, and deep learning algorithms. Segmenting may be based on color, shape, contrast, and/or other features of a scene. Segmenting may include assigning a probability that an image element belongs to a particular discrete component. As an example, the system may segment an image into a plurality of discrete components. Segmenting may include implementing a deep learning model to classify basic elements of an image (e.g., a convolutional neural network model, for example, PointNet). In some embodiments, segmenting may include generating a plurality of 2D representations of a scanned scene (i.e., 2D snapshots), the 2D representations including projections of the 3D scanned scene into two dimensions from various angles. A 2D snapshot may include a plurality of pixels. A pixel may correspond to a plurality of image elements. For example, a set of image elements along a line of sight may correspond to a pixel in a 2D snapshot (i.e., generating a 2D snapshot by mapping sets of image elements to pixels). 2D snapshot may overlap (i.e., include one or more of the same objects). Segmenting may include tagging, labeling, identifying, or otherwise classifying one or more pixels of a 2D snapshot as belonging to a discrete component, and mapping the one or more pixels to a set of 3D elements (e.g., by performing an inverse mapping of a mapping used to generate a 2D snapshot). Segmenting may include identifying components that correspond to a known classification and/or to an unknown classification, and may include implementing a classification model.

Comparing objects and/or image data: Consistent with disclosed embodiments, comparing objects and/or image data (e.g. full or partial image representations, image elements, 3D models CAD models, textual or other information associated with the image) may include implementing a classification algorithm (e.g., a machine learning model). Comparing objects and/or image data may include generating one or more criteria such as a similarity metric, as described herein. Comparing objects and/or image data may include segmenting an object within a scene, i.e., identifying components of an object, such as an object face, a line, a surface, or a component that is itself an object (e.g., identifying a wheel as a component object of a car object). Comparing objects and/or image data may be based on an image object identifier. Comparing objects and/or images may include comparing semantic tags or spatial semantic graphs associated with the objects and/or images. Comparing objects and/or images may include comparing feature vectors associated with the objects and/or images. Comparing may include comparing based on text data, shape data, user data, and/or any other data. Such a comparison may involve by way of example only, statistical analysis of similarities or artificial intelligence based approaches that identify similarities. In one example, comparing may involve determining a similarity metric indicating a degree of similarity between the compared objects and/or images. For example, the disclosed system may generate or retrieve feature vectors corresponding to the compared objects and/or images and compare the feature vectors. In some embodiments, the disclosed system may generate feature vectors using, for example, multi-view neural networks or other types of neural networks. The disclosed system may determine similarity between the compared objects and/or images based on a similarity metric. A similarity metric may include a score representing some measure of a degree of similarity. The similarity metric may be based on a statistical similarity such as a covariance, a least-squares distance, or a Hausdorff distance between aligned objects.

Generating a combined or hybrid image (by inserting, merging, or replacing images): Consistent with disclosed embodiments, generating a combined or hybrid image may include combining some or all portions of a first image with some or all portions of a second image. Thus, for example, a processor may combine some or all image elements associated with the first image with some or all image elements associated with the second. Generating the combined or hybrid image may include positioning objects in the first image in the same orientation (i.e., aligning an object) and similar size (i.e., scaling an object) with objects in the second imaged. By way of example, an alignment of objects in the first image with objects in the second image may include an Affine transformation that transforms the (x, y, z) coordinates of the image elements of the first image to T(x, y, z) which is the desired location of this element in the second image coordinates or vice-versa. In other embodiments, generating the combined or hybrid image may include taking a union of some or all of the two families of image elements. In yet other embodiments, generating a combined or hybrid image may include combining properties of some or all image elements of the first image and some or all image elements of the second image to obtain a fused element. For example, suppose the first image and the second image include a family of polygons. Each polygon may be associated with a texture. A texture may be a 2D-mapping from an image to the polygon representing how this polygon appears to a viewer (different parts of the polygon may have different colors for example). The alignment T of the first image and the second image may be used to determine a matching of the corresponding polygon families. For example, a polygon from the first image may be mapped to a polygon in the second image using the transformation T to locate the closest first image polygon relative to a polygon in the first image. Using the matching, the system may match vertices of the polygons of the first and second images. The disclosed system may also transfer a color, a texture, material properties, etc., from the polygon of the first image to the polygon of the second image or vice-versa. In some embodiments, aligning an object and/or scaling an object may include using Principal Component Analysis (PCA). Generating the combined or hybrid image may also include using image processing techniques (e.g., adjusting brightness, adjusting lighting, implementing a gradient domain method, etc.), consistent with disclosed embodiments. As one of skill in the art will appreciate, a gradient domain method may include constructing the hybrid image by integrating the gradient of image elements of the first image with the gradients of the image elements of the second image or vice-versa. Generating the combined or hybrid image may also include transferring one or more properties such as texture, material, movability, color, shading, etc. from some or all image elements of the first image to some or all image elements of the second image or vice-versa. In some embodiments, generating the combined or hybrid image may further include generating additional image elements in the second image based on the image elements in the first image or vice-versa.

Data Structure: A data structure consistent with the present disclosure may include any collection of data values and relationships among them. The data may be stored linearly, horizontally, hierarchically, relationally, non-relationally, uni-dimensionally, multidimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database or NoSQL alternatives for data storage/search such as, for example, MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Processor: Consistent with disclosed embodiments, “at least one processor” may constitute any physical device or group of devices having electric circuitry that performs a logic operation on input or inputs. For example, the at least one processor may include one or more integrated circuits (IC), including Application-specific integrated circuit (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory.

Memory: The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively. The processors may be coupled electrically, magnetically, optically, acoustically, mechanically or by other means that permit them to interact.

The present disclosure relates to computer-implemented advertising bidding systems for use in virtual reality (VR), augmented reality (AR), and mixed reality (MR) technology and applications. The present disclosure provides a solution to a new kind of advertising within AR, VR, and MR technology and applications to deliver accurate and effective targeting of advertisements and matching real-time consumer intent to a real-time market advertisement inventory or real-time generated supply. While the present disclosure provides examples of AR, VR, and MR technologies and applications, it should be noted that aspects of the disclosure in their broadest sense are not limited to particular examples. Rather, it is contemplated that the foregoing principles may be applied to other computerized-reality technologies and applications.

In the following description, various specific details are given to provide a more thorough understanding of the present disclosure. However, for a skilled person it will be apparent that the present disclosure may be practiced without one or more of these details.

The present disclosure generally relates to bidding to insert content into computerized environments. Bidding includes offering something of value (e.g., money) in exchange for inserting content. Bidding may involve specifying aspects of a bid itself (e.g., an offer-period in which a bid may be accepted). Bidding may involve specifying aspects of inserted content, such as the timing, an intended audience, a duration, a monetary value, or any other aspect of inserted content. In some embodiments, bidding might involve an object (e.g., car, bottle, chair, door), a scene type (e.g., office, living room, art gallery), a time (e.g., between 1 PM-2 PM) or/and targeted to a specific place (e.g., New York City, 5th Avenue), or a class of user (i.e., a class of viewer).

Consistent with the present embodiments, bidding may be in real-time. For example, bidding may occur during a transmission to an online audience or other broadcast. The disclosed system may be configured to determine, based on a scene analysis or an analysis of an object in a scene, which objects, scenes, or elements within the scene match an inventory or a real-time market supply. Consistent with disclosed embodiments, matching may be performed based on a plurality of extracted data or features of a scene, an inventory, or a real-time market supply.

The terms VR, AR, and MR refer generally to computerized environments that are modeled after or simulate a physical environment, such as a three-dimensional (3D) environment. AR, VR and MR are technologies, which enable users to interact in an immersive and natural way with functionalities and information associated with real scenes and objects (in case of AR & MR) within the environment, and with virtual objects. VR, AR, and MR environments may or may not be based on data describing a real-world physical environment. VR in its broadest sense may refer to any immersive multimedia or computer-simulated reality, including AR and MR environments. An immersive multimedia experience may be one that presents information in such a way as to simulate an interactive, real-world experience in 3D (e.g., via a headset) and that may capture user inputs that correspond to real-world inputs such as gestures, eye gaze, speech, etc. AR and MR may refer to a partially-computerized or hybrid environment that may merge sensor data from real world with digital objects, allowing users to interact with digital objects in real-time. VR, AR, and MR technologies may involve a combination of hardware, such as a head-mounted display, a computer, or other hardware to generate and display a computerized reality.

The present disclosure also relates to advertising. Advertising, from a broad perspective, includes acts of displaying information for audiences through a medium, which may include displaying specific information for a specific audience through a particular medium. Display banners, images, videos, 3D models, 3D filters, audio, or textual clickable ads are all types of advertisement units that may be targeted for specific audience segments, or even highly personalized for a specific user. The advertising industry may invest significant effort in the study of a particular media for specific audiences and their use of targeted advertising through various analysis techniques, such as incorporating big data analysis, user interactions analysis and various types of machine learning optimization techniques.

The present disclosure may relate to broadcasting AR, VR, and MR technologies. Broadcasting as used in this disclosure may include transmission to a plurality of individuals over a network. For example, broadcasting may include transmission to many players playing a multi-player game or many viewers watching a sporting event. In general, broadcasting may include transmissions to viewers exposed to a same or similar view of a real or virtual scene. Broadcasting may include transmission over the internet, cable TV, or any other medium for transmitting data to many users simultaneously

In some embodiments, an advertiser object may be inserted in a transmission to all individuals receiving a broadcast. In some embodiments, an advertiser object may be inserted in a transmission to a subset of individuals receiving a broadcast. For example, an advertiser object may be inserted into or excluded from a viewer transmission based on properties of a viewer such as age and gender, properties of a. viewer's environment such as time of day, country, or language, etc.

In the following description, various specific details are given to provide a more thorough understanding of the present disclosure. However, for a skilled person it will be apparent that the present disclosure may be practiced without one or more of these details.

The present disclosure is intended to provide a technique to target advertising to specific audiences or specific users. The application may be used in an environment consumed through a device equipped with AR, MR, or VR application. The disclosure enables a novel way to match an observed scene or a portion of a scene or even a single or partial object within the scene, with a real-time bidding system that associates a value to a given object or objects that may be advertised within the AR, MR, VR consumed scene.

The bidding system enables advertisers or advertisements agents to bid or to associate a suggested value with a given object. Associating a value may be accomplished with/or without specific filters such as time, place, scene descriptions, etc. The bidding system may push specific objects or portions of scenes to the advertisers or advertisements agents to enable them to associate their advertisement unit (e.g., a banner, an image, a video or a 3D model) and to associate a suggested value to those specific advertisements units.

In some embodiments, advertisers or advertisement agents may associate an advertisement unit to a given object or objects. For example, a car manufacturer may associate a specific banner, 3D model, image, or video to an object identified as a ‘sports car.’ Based on a value the manufacturer assigns to an object ‘sports car,’ a matching system may determine when, where, and to which user an advertisement will be displayed (i.e., the matching system may determine a scene, object, time, or location for displaying an advertisement).

A typical use case may include adding a banner in an immersive manner to a real sports car in an AR or MR environment. Another use case may include adding a banner to a digitized sports car model within a VR consumed scene. Still another use case may involve an AR or MR environment and include replacing a real sports car in the AR or MR environment with an advertised sports car, so a user experiencing the AR or MR environment will see the advertised sports car displayed instead of the real one. Similar applications may involve replacing an original model in a VR scene with an advertised model.

In a VR-constructed scene for some embodiments of this disclosure, a designer or creator of the scene may predetermine which objects are good candidates for replacements or for embedding advertisement units.

In some exemplary embodiments, an owner of a real object, a content provider, or any other person, machine, or organization may predefine which objects may be replaced with advertised objects in an AR or MR environment, or which objects may embed advertisements. For example, in an AR or MR environment comprising a real-world store, the store or a manufacturer of a product can embed AR or MR based advertisements to add content describing the product, its price, or use.

The bidding system may choose various parameters regarding which of the advertisement units should be incorporated in an AR/MR/VR consumer scene. Such parameters may include, but are not limited to, the similarity of a real or digitized shape to an advertised shape; a value associated with an object as assigned by an advertiser or advertisement agent; or a likelihood of a user to interact with an advertisement unit, time zone, place, etc.

According to various exemplary embodiments of the present disclosure, a novel scene augmentation and reconstruction concept may permit advertisers to bid on a shape or an object (i.e., shape-based search), and to thereafter insert products into still or video content. For example, in connection with a virtual gaming environment, automotive manufacturers may be able to bid on the shape of a car, and the winning bidder's car w ll then be displayed in the gaming environment. Similarly, beverage manufacturers may be permitted to bid on a bottle, and the winning bidder's beverage bottle may thereafter appear in an online video. And in a more general sense, anyone may be able to bid on a wall, and the winning bidder's message may appear on the wall as part of the display of other online content.

An example of an implementation of an advertising system (or visual input reconstruction system) based on the present disclosure follows. In the example, a user may play a game using a VR headset and, within the game, the user may enter a room with an office chair generated by the game (i.e., a “game-chair”). In the example, the disclosed advertising system may replace the game-chair with another chair provided by an advertiser such as a branded chair.

In one embodiment, the game may be programmed by a game developer using a 3D-representation of an environment. The advertising system may analyze a part of the environment visible to a user in the game. The disclosed system may detect (i.e., recognize) objects by, for example, using scene segmentation to partition the visible environment into separate detected objects such as chair, table, bed, etc. Segmenting may include identifying components of a scene or an object, such as a face of an object, a surface, or a component that is itself an object (e.g., identifying a wheel as an object-component of a car). Segmenting may additionally or alternatively be performed using techniques for segmenting discussed above, consistent with the embodiments of this disclosure. For example, the system may use object recognition models, including machine-learning models. The advertising system may compare a detected object from the visible scene with objects in a data structure of objects. Exemplary data structures, consistent with the embodiments of this disclosure, are described above. Consistent with embodiments of this disclosure, the advertising system may additionally or alternatively perform the comparison using techniques for comparing objects and/or image data discussed above.

The data structure may include text describing objects, and the disclosed system may determine a measure of similarity between a detected object and a data-structure-object. The measure of similarity may be based on a label, text, user input, a shape, or a model output (e.g., classification model output or statistical model output). The disclosed system and/or a user may tag an object with text corresponding to a data structure label based on a measure of similarity and a criteria (e.g., meeting a threshold). In the example, the disclosed system may identify a scene-object in the scene that is similar to a data-structure-object tagged “office chair.”

Continuing with the example, the advertising system may receive and compare bids that are identified as being associated with “office chair” (e.g., bids that contain the text “office chair”). The bid may be associated with an advertiser chair. The system may determine a maximum bid (e.g., bid with the highest dollar value) based on the comparison and select that bid as the winning bid. Accordingly, the advertising system may remove the game chair-object from the scene and insert the advertiser chair in the scene, in the correct orientation, size, and lighting, to match the existing scene as naturally as possible.

In the example, the advertising system may analyze received bids to determine a winning bid. For example, consistent with disclosed embodiments, a bid may include an image of a chair, and the disclosed system may scan the image, detect the chair, and further determine that the chair is an office chair. The disclosed system may attach a banner to the back of this chair, when viewable by a user.

As one of skill in the art will appreciate, in the exemplary embodiment, the game plus the VR headset is a special case of a visual input reconstruction system. A game environment viewable by the user at a certain instance as designed by the game developer is a special case of pre-existing content frames. In the example, representation of the office chair object by the text “office chair” is a special case of an object image identifier. Other examples consistent with the present disclosure are possible.

In accordance with the present disclosure, a computer-implemented visual input reconstruction system for enabling selective insertion of content into preexisting content frames is disclosed. A visual input reconstruction system may include a system capable of generating and/or displaying any 2D or 3D media, including VR, AR, or MR environments. For example, a special case of a visual input reconstruction system may include system that generates content viewable on a VR headset such as a software-based game played on the VR headset. A visual input reconstruction system may include a VR headset. Other exemplary visual input reconstruction systems may include or be capable of producing content compatible with a phone or tablet with an MR experience adding elements to a camera-view of a room; an MR headset representing a 3D-experience of a viewed room, with additional elements added to the real environment; or any other device used by a user to interact with a real or virtual scene.

Consistent with disclosed embodiments, a preexisting content frame may include an image as seen or intended to be seen by a user in a particular time. A preexisting content frame may include, for example a representation of a game environment designed by a game developer. A preexisting content frame may include an image of reality itself, as seen through a phone, computer screen, MR headset, or other device. In some embodiments, preexisting content frames may include images of reality and virtual objects (i.e., AR/MR). A preexisting content frame may include information comprising a property of a viewer (e.g., a user playing a game), such as an age or an interest. Properties of reality may be included in a preexisting content frame, such as a date, time, or location. In some embodiments, properties of an experience may be included in a preexisting content frame, such as an angular speed of a view of a user experiencing a game, image data (e.g., RGB data); and/or depth camera data. A pre-existing content frame may also include sensor data such as accelerometer data, gyroscope data, or GPS data embedded in a user device to extract position, translation and rotation of the user device, and/or speed and acceleration of a user device. Some devices, such as certain head mounted devices, capture eye movements and track eye gazing of the user to determine which elements of the scene may be more relevant to the user in a specific timing.

Preexisting content frames may include at least one of a still image, a series of video frames, a series of virtual 3D content frames, or a hologram. A still image may include an image in any image format (e.g., .JPG). A series of video frames may include a sequence of frames in 2D or 3D that, when provided to a viewer at a speed, give the appearance of motion. A series of video frames may be formatted in a known video format, such as .MP4 or any other known format. A series of virtual 3D content frames may include a series of 3D video frames configured for presentation in a VR, MR, or AR context, consistent with disclosed embodiments. A hologram may include data configured for projection so that the resulting projected light has the appearance of a 3D object. For example, a hologram may comprise data that, when provided to a device capable of emitting a split coherent beam of radiation (e.g., a laser), creates a three-dimensional image that arises from a pattern of interference by a split coherent beam of radiation.

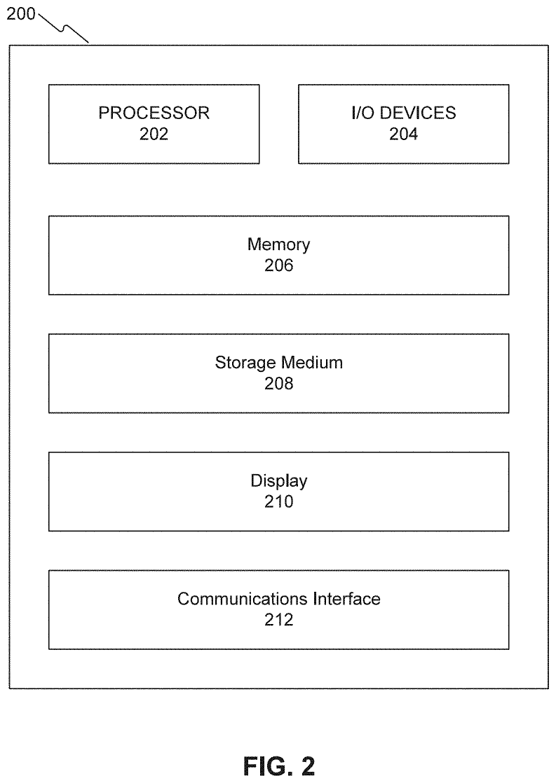

In some embodiments, the visual input reconstruction system may include at least one processor. The processor may be configured to access a memory. Exemplary descriptions of a processor and memory are described above, and also with reference to FIG. 2.

In some embodiments, a processor of the system may be configured to access a memory storing a plurality of object image identifiers. An object image identifier may include text representing an object image. For example, an object image of an office chair may be represented by the text “office chair.” In some embodiments, an object image identifier may comprise at least one of a shape, a descriptor of a shape, a product, or a descriptor of a product. A shape may include shape data, the shape data comprising coordinates, vectors, a mesh or grid, a representation of a shape (e.g., a 2D or 3D model), or any other data relating to a shape. A descriptor of a shape may include text data, a label, a classification, a tag, and/or any other data describing or identifying a shape. A product may include shape data (e.g., shape data providing a representation of a physical surface of a product, such as a surface of a sports car). A descriptor of a product may include text data, a label, a classification, a tag, and/or any other data describing or identifying a product.

In some embodiments, an object image identifier may include output of a shape-similarity engine. To illustrate this example, an advertiser may run an image of a particular office chair through a shape-similarity engine provided by an advertising system, comparing the image of the advertiser chair to a game chairs in the object data structure. The advertiser may approve or otherwise indicate search results that represent the advertiser's understanding of the office chair. In some exemplary embodiments, an advertising system may run a similarity search during a game comparing an image of a game-chair to an image of advertiser chairs in a data structure. The system may identify results that satisfy a similarity metric between the game chair and candidate advertiser chairs. A similarity metric may include a score representing some measure of a degree of similarity between image data, object data, and/or shape data between two object images. A similarity metric may be based on a statistical similarity such as a covariance, a least-squares distance, a distance between vectors associated with image elements (e.g., feature vectors), or a Hausdorff distance between aligned objects. A similarity metric may be based on a feature vector, as described in greater detail elsewhere herein. Based on similarity between the game chair and an advertiser chair, the system may determine that the advertiser may be interested in putting an image of the advertiser chair in the game scene. The system may additionally or alternatively employ one or more techniques for comparing objects and/or image data discussed above for comparing an image of a game-chair to an image of advertiser chairs in a data structure, consistent with the embodiments of this disclosure.

In some embodiments, an object image identifier may include text generated by an algorithm. For example, an advertiser may provide text describing an object, and a text-parsing system may extract relevant keywords from the text for use in an object image identifier. In some embodiments, an object image identifier may include information based on results of a classification model. For example, an advertiser may provide one or more images of a product, and a 3D- or 2D-matching algorithm may identify similar objects in a game scene. As an example of a 2D-matching algorithm, a neural network may segment an image into one or more objects and classify the object. In some embodiments, a neural network may include a deep learning model trained to identify similar objects and/or classify objects in a 3D-scene or 2D-image (e.g., a convolutional neural network model). For example, the neural network may tag, label, identify or otherwise classify one or more pixels of a 2D snapshot as belonging to an object.

In some embodiments, a matching algorithm may include mapping an object in a 3D scene to a feature vector (i.e., generating a feature vector). In some embodiments, the system may compute a feature vector of a scene component and/or feature vector of an object in a 3D scene. A feature vector may include a sequence of real numbers or other data. A feature vector may include information relating to a rotation and/or a location change of a scene-component or matched-component. Generating a feature vector may include using a machine learning model such as a multi-view convolutional neural network. For example, a multi-view convolutional neural network may accept a plurality of 2D representations of a 3D shape (i.e., snapshots), the 2D representations including projections of the 3D shape onto 2D images from various perspectives (e.g., photos of an object).

Consistent with the present disclosure, interactions between an object and other properties of an experience may be included in an object image identifier. For example, an object image identifier may include properties of a user playing a game (i.e., user data), such as an age or an interest. Other user data may include identifying information, usage information, purchase history, interaction history, etc. In some embodiments, properties of reality such as the date of year and time of day may be included in an object image identifier. An object image identifier may include properties of an experience, such as the angular speed of the view of the user experiencing the game.

In accordance with the present disclosure, a plurality of object image identifiers may be associated with a plurality of objects. In some embodiments, an object image identifier may be associated with a respective object. Each object image identifier may be associated with a different object (i.e., object image identifiers may be unique). In some embodiments, an object image identifier may be associated with a plurality of objects. For example, an object image identifier for “sports car” may be associated with a variety of sports car makes and models. In some embodiments, a plurality of object image identifiers may be associated with the same object. As a specific example, an object image identifier for “chair” and an object image identifier for “office furniture” may be associated with an object image representing an office chair. As one of skill in the art will appreciate, an object corresponding to an object image identifier may include at least one of a wall, a billboard, a picture frame, a window, a computer screen, a book cover, a door, or any other object. For example, a VR scene may include a representation of a room having a wall (or other object on which a 2D image may be projected), and an object image identifier may correspond to the wall. In some embodiments, an image object identifier may include a 2D image of an object, an abstracted image of an object (e.g., a generic bottle), 3D data of an object, and/or any other data representing an object.

In some exemplary embodiments, a visual input reconstruction system may transmit, to one or more client devices, an object image identifier of the plurality of object image identifiers. Transmitting may include transmitting over any network, such as a TCP/IP network. A client device may include a phone, a tablet, a mobile device, a computer, a server, a cluster of servers, a cloud computing service, and/or any other client device. In some embodiments, a client device may comprise or be a component of an advertising system (i.e., a system managed by an advertiser, an advertising agency, an agent, or the like). A client device may connect to the visual input reconstruction system via a network (e.g., network 140), consistent with disclosed embodiments. In some embodiments, a client device may connect to the visual input reconstruction system via a short-range wireless technology (e.g., BLUETOOTH, WI-FI) or a wired connection (e.g., a USB cable). In some embodiments, a client device may be configured to receive and transmit information based on an image object identifier (e.g., via an interface). In some embodiments, a client device may be configured to implement an algorithm based on an image object identifier (e.g., an algorithm to generate or place a bid).

In some embodiments, transmitting at least one object image identifier may cause to be displayed, by the one or more client devices, the at least one object image identifier. Displaying an object image identifier may include displaying by a screen, by a projection, by a light-emitting component, or other means of displaying information. Displaying may include playing an audio signal over a speaker.

In some exemplary embodiments, transmitting at least one object image identifier may cause an interface to be displayed by the one or more client devices. An interface may include a display, a VR headset, a touchscreen, a keyboard, a mouse, gaming console, and/or any other input or output device capable of providing information to a user and receiving information from user inputs. An interface may be dedicated to a particular use context (e.g., a kiosk). An interface may be configurable by a user.

An interface may be configured for placing at least one bid on at least one object image identifier. Placing a bid may include receiving user input associating a value with an object image identifier. A bid may include a duration (e.g., a bid to place an advertisement for a specific amount of time), a number of users (e.g., 1,000 game players), a rate (a cost per unit time displayed or per person who receives a broadcast), or any other information. As an example, a client device (e.g., a client device operated by an advertiser) may place a bid for $0.10 per broadcast recipient. As one of skill in the art will appreciate, other examples of bids are possible. Placing a bid may include updating a previously placed bid.

An interface may include an auction system for placing a bid. For example, an interface may be configured to receive and transmit a price or a set of prices. An interface may be configured to include a plurality of bidding options. For example, an interface may include one option to add a small image projected on an object identifier, another option for a larger image, another option for replacing an object, and yet another for replacing an object and changing a feature of a 3D environment (e.g., adjusting lighting, changing a volume level, etc.). Bidding may be related to a similarity metric, as described herein, between an object identifier image and an advertiser object (e.g., lower prices may be available for metrics indicating a low degree of similarity).

An interface may present data on top of an object or object identifier, such as data that may provide information relating to compatibility of potential advertiser objects to a scene. For example, a toy office chair in a scene may be labeled in such a way as to indicate it is not a full-size office chair, or that it is incompatible with a full-size office chair. Other properties of the object may be displayed, including color, style, material, and any other property of an object or its relation with its surroundings that may be relevant to a bid.

In accordance with the present disclosure, the visual input reconstruction system may receive, from the one or more client devices, one or more bids associated with the at least one object image identifier. In some embodiments, a bid may be based on user input received at a client device (e.g., a client device operated by an advertiser). In some embodiments, a bid may be based on an algorithm or other executable code of a client device that generates and places a bid with or without user input.

In some embodiments, the visual input reconstruction system may determine a winning bid from among the received one or more bids. The winning bid may be associated with a winning client device from among the one or more client devices. In some embodiments, determining a winning bid may be based on one or more criteria such as a value (i.e., a monetary amount), a compatibility of an advertiser object to a scene, information relating to an audience, and/or any other information. In some embodiments, a criterion for determining a winning bid may be based on a likelihood that the bid winner will place a second bid after winning a first bid. For example, the visual input reconstruction system may determine that an advertiser may be likely to receive a positive result from winning the bid and that the advertiser may be likely to place a second bid at a future time. A positive result may include, for example, a product purchase, an increase in website traffic, mentions on social media, or the like. The examples provided herein of criteria for determining a winning bid are not limiting, and other criteria are possible. Further, as one of skill in the art will appreciate, the visual input reconstruction system may determine more than one winning bid from among the received one or more bids associated with respective object image identifiers.

In greater detail, a criterion may include a numerical value such as a price and/or a similarity metric of an object in a scene to winner image data (e.g., a 3D model of an object). In some embodiments, a similarity metric may be based on a feature vector of an object. For example, a similarity metric may include a least squares-distance estimate between two feature vectors associated with respective objects. A least squares distance may be normalized to set zero (0) as the average similarity of an object to a plurality of objects (e.g., a plurality of random objects in a data structure) with one (1) representing a similarity metric of an object to itself. In some embodiments, a criterion may include a measure of similarity between tags associated with an advertised object and tags associated scene object. A criterion may include a spatial criterion or other semantic criterion to be satisfied in the scene. For example, a spatial criterion may specify that image data be “on a table.” As another example, a semantic criterion may include a request to place image data for a computer mouse to be placed “near a laptop.” Additionally or alternatively, in some embodiments, spatial criterion may include spatial semantic graphs, which are discussed in more detail below in this disclosure. In some embodiments, a criterion may be written in a computing language (e.g., code, script, or the like). For example, a criterion may be written in a pre-determined computing language supplied by the system and a bidder may provide a script defining a criterion, and the system may check if this criterion is satisfied in a scene, along with a suggested placement of an object.

In some embodiments, the visual input reconstruction system may receive winner image data from a winning client device. Winner image data may include any image data, consistent with disclosed embodiments. The winner image data may comprise a 2D or 3D image or model of an object. For example, an object image identifier may include an identifier associated with a soda can, and the winner image data may include a 2D logo of a beverage manufacturer suitable for display on the soda can. As another example, the winner image data may include a 3D model of a manufacturer's soda can. Consistent with disclosed embodiments, image data may be in any format, including .JPG, .BMP, .GIF, .PNG, .SVG, a 3D vector format, a Computer-Aided Design file, .FLV, .MP4, .AVI, .MPG, .MP3, .MOV, .F4V, .VR, or any other image, video, or model format. In some embodiments, winner image data include text data (e.g., text data to project on an object in a scene) and/or any other change specified by the winning client device (e.g., a change in a level of lighting of a scene or a volume level).

In some embodiments, the visual input reconstruction system may be configured to receive instructions from the winning client device. The instructions may comprise size restrictions for the object corresponding to the at least one object image identifier. For example, size restrictions may include a minimum or maximum object size, a pixel density, a font size, or any other size restriction. A size restriction may include a restriction related to scaling, rotating, or otherwise distorting an object.

Winner image data may include data relating to one or more objects and configured to be inserted into a scene, consistent with disclosed embodiments. For example, a bid may relate to an empty room, and winner image data may comprise text data to project onto a wall of a room and image object data representing a mascot (or other spokesperson) that conveys a message.

In some embodiments, the visual input reconstruction system may be configured to perform image processing on the winner image data to render the winner image data compatible with a format of a preexisting media content frame. For example, winner image data may be in a first format and a preexisting media content frame may be in a second format. The visual input reconstruction system may be configured to transform winner image data from the first format to the second format, with or without intermediate transformations or processing. A format may include a broadcast format. Image processing of winner image data may include any method of image processing, consistent with disclosed embodiments. For example, image processing may include adjusting brightness, shadows, ambient light, contrast, hue, saturation, scaling, cropping, rotating, stretching, filtering, smoothing, or otherwise transforming image data.

The visual input reconstruction system may store the winner image data in the memory. Storing in memory may include storing in a data structure, an index, a data storage, a local memory, a remote memory, or any other method of storing. Storing winner image data may include storing in any file format. Storing may include storing transformed winner image data.

In accordance with the present disclosure, the visual input reconstruction system may identify in at least one preexisting media content frame, an object insertion location for an object. A preexisting media content frame may include any image data, video data, VR data, AR data, MR data, etc. A preexisting media content frame may include a plurality of frames constituting a virtual reality field of view. A virtual reality field of view may include a view of a VR, MR, or AR environment from one or more perspectives. For example, a VR environment may comprise a virtual room with a doorway, four walls, a ceiling, a floor, and furniture. A plurality of frames constituting a virtual reality field of view may include a plurality of frames of the virtual room as seen by a person standing in the doorway. As another example, a plurality of frames constituting a virtual reality field of view may include a plurality of frames of the virtual room as seen by a person sitting on the furniture. A virtual reality field of view may change over time.

An object insertion location may include a position and/or an orientation within a computerized environment. An object insertion location may correspond to the at least one object image identifier (e.g., there an object image identifier may include the text “door handle” and an object insertion location may correspond to a location on a door representing a door handle). An object insertion location may include a location associated with an object, such as a face, a front, a side, a top, or the location of a component of the object. An object insertion location may include a location within a VR, an AR, or an MR environment. For example, an object insertion location may include data identifying a center back of a chair in a VR scene (e.g., to insert a banner advertisement). An object insertion location may include a relationship between objects in a scene. For example, an object insertion location may include information identifying a proximity to another object (e.g., “near a table in a scene”), or an orientation relative to another object (e.g., in front of a table). More generally, a 2D or 3D transformation between the advertiser object, and game-object, with/without the action of erasing the game object are all examples of object insertion location.

In some embodiments, the visual input reconstruction system may generate at least one processed media content frame by processing the at least one preexisting media content frame to insert at least a rendition of the winner image data at the object insertion location. Processing a preexisting media content frame may include inserting winner image data or a rendition of winner image data into a computerized environment. A rendition of the winner image data may include the winner image data itself. In some embodiments, a rendition of the winner image data may include image data based on winner image data. Processing may include using methods of tomography to scale or orient the winner image data. Processing may include gradient domain methods or other image processing techniques to blend winner image data into a computerized environment. Processing may include adjusting brightness, shadows, ambient light, contrast, hue, saturation, or other image processing techniques. For example, a rendition of the winner image data may include scaled, cropped, rotated, stretched, filtered, smoothed, or otherwise transformed image data based on the winner image data. Generating a processed media content frame may include using Principal Component Analysis (PCA).

Processing a preexisting media content frame may include adding content to a scene based on winner image object data, consistent with disclosed embodiments. That is, winner image object data may include additional content, such as an interactive object that may be incorporated into an immersive experience. As an example, the winner object bid may include data relating to a company mascot sitting on a chair. In this case, the presence of the mascot may alter properties of the VR scene (e.g., a first-person game player may be unable to walk through the mascot without a virtual collision).

In some embodiments, the image object data may include code, text, or other instructions related to movement of a winner image object, and processing a preexisting media content frame may include executing the instructions. For example, the instructions may include code that causes a mascot to jump from a table and sit on a chair. In some embodiments, instructions may be provided in natural language that is translated by the advertising system (e.g., the instructions may be “make mascot jump,” and the system may process the preexisting content frame accordingly). Further, as previously described, winner image object data may include instructions to change properties of the scene, such as adding lighting that focuses a user's attention on an object.

In accordance with the present disclosure, inserting at least a rendition of the winner image data may render an object from the winning object image data within a plurality of frames. For example, winning object data may be virtually displayed within a broadcast. As an example, an object may be a particular sports car, and winning object image data may comprise an image of the particular sports car, and inserting a rendition of the winner image data may render the particular sports car within a plurality of frames. Winner image data may be inserted into at least one preexisting content frame such that winner image data may be overlaid on preexisting content in at least one preexisting content frame. As an example, overlaying winner image data on preexisting content may include super-imposing, from the perspective of a viewer of a VR environment, winner image data comprising an image of a logo on preexisting content comprising an image of a billboard. Overlaying winner image data may include adding a banner to an object (e.g., adding a banner to a back of a chair or to a bottle).

Inserting winner image data may include adding elements that interact with an object (e.g., an element may include an object data related to a mascot, and the mascot may sit on a. chair in the scene). More generally, inserting winner image data may include any addition to a scene that adds content, including content that may interact with other objects in a scene, irrespective of whether the addition overlays or replaces an object.

For example, in some embodiments, winner image data may be inserted when one or more objects in the scene interact with each other. In some embodiments, physics based engines (that simulate jumping, falling, pushing objects) and semantic-based engines (e.g. objects configured to move towards other objects, which may be semantically tagged in the 3D environment) may be used to cause objects to interact with each other. An advertiser may define rules that specify that the winner image data should be inserted into the scene in response to interaction between two objects in the scene. By way of example, an advertiser may require that the scene contain a floor, a table, a laptop. Further, the advertiser may specify an interaction between objects in the scene, for example, a small creature jumping to the floor, jumping on to the chair, sitting for a while, then getting up, jumping on the table, and disappearing. An advertiser may specify that the winner image data (e.g. an advertising image) should be inserted after the interaction occurs to ensure that the viewer's attention has been captured by the interaction preceding the insertion of the winner image data.

Winner image data may be inserted into at least one preexisting content frame such that an image of an object represented by winner image data may replace preexisting content in at least one preexisting content frame. As an example, preexisting content may include a virtual sports car moving through a VR gaming environment, and winner image data comprising image data relating to a particular sports car may replace the virtual sports car so that a viewer perceives the particular sports car but not the virtual sports car. As another example, a house in an urban scene may be replaced by a fast-food restaurant. In some embodiments, winner image data may be inserted on a portion of an object corresponding to at least one object image identifier. In some embodiments inserting at least a rendition of the winner image data may be based on instructions comprising size restrictions. For example, size restrictions may include a maximum size, and inserting at least a rendition of the winner image data may include inserting a rendition of the winner image data no larger than the maximum size. Additional or alternative techniques for combining two images (e.g. first image and second image) discussed above may also be used to generate at least one processed media content frame by inserting, and/or overlaying winner image data into at least one preexisting content frame or replacing one or more objects or images in the preexisting content frame with the winner image data, consistent with the embodiments of this disclosure.

In some embodiments, the visual input reconstruction system may transmit the at least one processed media content frame to one or more user devices. A user device may include any device configured to receive and/or display media content such as a mobile device, a VR headset, a game console, a computer, a server, and/or any other user device. Transmitting may include broadcasting. As previously described, broadcasting may include transmission to a plurality of individuals over a network. In some embodiments, transmitting may include transmitting the processed media content frame to a first user device of the one or more user devices. In some embodiments, transmitting may further include transmitting the at least one preexisting media content frame to a second user device in a manner excluding the winner image data. In this way, media content frames may be targeted to particular audiences. For example, the processed media content frame may include an image of a diet soda that replaced a regular soda in the preexisting media content frame. In this case, the first user device may be a user device associated with person identified as being a health-conscious person, while the second user device may be associated with a person identified as a person that previously purchased regular soda.

It is to be understood that the aforementioned steps and methods may be performed in real-time. In some embodiments, the visual input reconstruction system may be configured to obtain at least one preexisting content frame in real-time and to insert a rendition of the winner image data in at least one preexisting content frame in real-time. As one of skill in the art will appreciate, steps may be performed in various orders, and some or all steps may be repeated to change a broadcast in real-time. For example, in some embodiments, winner image data displayed in the preexisting content frame may change after a predetermined period of time. To illustrate this example, a virtual billboard in a VR environment may display winner image data comprising a first logo for ten minutes and display a second logo at the end of the ten minutes. A predetermined time may be set by an advertising system (i.e., a visual input reconstruction system). In some embodiments, a bid may include a predetermined time (e.g., an advertiser may set an amount of time to display an image object). In some embodiments, predetermined time may be determined by a user (i.e., an audience member). As one of skill in the art will appreciate, a predetermined period of time may include a scheduled time (e.g., changing a winning image data displayed after a predetermined period of time may include changing at a set time, such as at 3:00 pm).

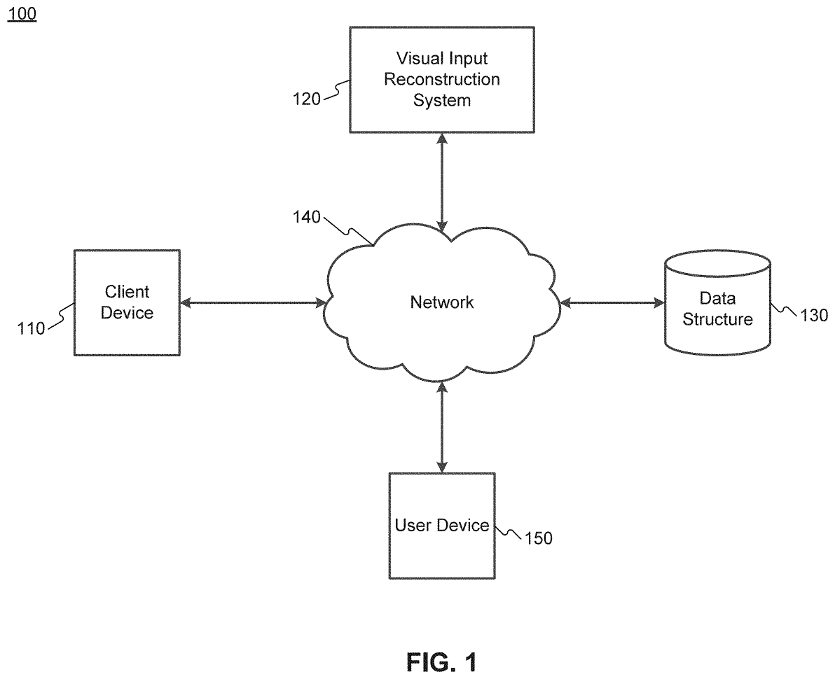

FIG. 1 depicts an exemplary system 100 for augmenting or reconstructing a 2D or 3D scene or image, consistent with embodiments of the present disclosure. As shown, system 100 may include a client device 110, a visual input reconstruction system 120, a data structure 130, and/or a user device 150. Components of system 100 may be connected to each other via a network 140. In some embodiments, aspects of system 100 may be implemented on one or more cloud services. In some embodiments, aspects of system 100 may be implemented on a computing device, including a mobile device, a computer, a server, a cluster of server, or a plurality of server clusters.

As will be appreciated by one skilled in the art, the components of system 100 may be arranged in various ways and implemented with any suitable combination of hardware, firmware, and/or software, as applicable. For example, as compared to the depiction in FIG. 1, system 100 may include a larger or smaller number client devices, visual input reconstruction systems, data structures, user devices, and/or networks. In addition, system 100 may further include other components or devices not depicted that perform or assist in the performance of one or more processes, consistent with the disclosed embodiments. The exemplary components and arrangements shown in FIG. 1 are not intended to limit the disclosed embodiments.

In some embodiments, client device 110 may be associated with an advertiser, an advertising agent, and/or any other individual or organization. For example, client device 110 may be configured to execute software to allow an advertiser to place a bid on inserting content into a preexisting media content frame, consistent with disclosed embodiments. Client device 110 may include one or more memory units and one or more processors configured to perform operations consistent with disclosed embodiments. In some embodiments, client device 110 may include hardware, software, and/or firmware modules. Client device 110 may include a mobile device, a tablet, a personal computer, a terminal, a kiosk, a server, a server cluster, a cloud service, a storage device, a specialized device configured to perform methods according to disclosed embodiments, or the like. Client device may be configured to receive user inputs (e.g., at an interface), to display information (e.g., images and/or text), to communicate with other devices, and/or to perform other functions consistent with disclosed embodiments. In some embodiments, client device is configured to implement an algorithm to place a bid based on information received from another device (e.g., from visual input reconstruction system 120).

Visual input reconstruction system 120 may include a computing device, a computer, a server, a server cluster, a plurality of server clusters, and/or a cloud service, consistent with disclosed embodiments. Visual input reconstruction system 120 may include one or more memory units and one or more processors configured to perform operations consistent with disclosed embodiments. Visual input reconstruction system 120 may be configured to receive data from, retrieve data from, and/or transmit data to other components of system 100 and/or computing components outside system 100 (e.g., via network 140).

Data structure 130 may be hosted on one or more servers, one or more clusters of servers, or one or more cloud services. In some embodiments, data structure 130 may be a component of visual input reconstruction system 120 (not shown). Data structure 130 may include one or more data structures configured to store images, video data, image object information, image object identifiers, metadata, labels, and/or any other data. Data structure 130 may be configured to provide information regarding data to another device or another system. Data structure 130 may include cloud-based data structures, cloud-based buckets, or on-premises data structures.

User device 150 may be any device configured to receive and/or display a media content frame, including VR, AR, and/or MR data. For example, user device 150 may include a mobile device, a smartphone, a tablet, a computer, a headset, a gaming console, and/or any other user device. In some embodiments, user device 150 is configured to receive and/or display a broadcast. User device 150 may include one or more memory units and one or more processors configured to perform operations consistent with disclosed embodiments. In some embodiments, User device 150 may include hardware, software, and/or firmware modules.

One or more of client device 110, visual input reconstruction system 120, data structure 130, and/or user device 150 may be connected to network 140. Network 140 may be a public network or private network and may include, for example, a wired or wireless network, including, without limitation, a Local Area Network, a Wide Area Network, a Metropolitan Area Network, an IEEE 1002.11 wireless network (e.g., “Wi-Fi”), a network of networks (e.g., the Internet), a land-line telephone network, or the like. Network 140 may be connected to other networks (not depicted in FIG. 1) to connect the various system components to each other and/or to external systems or devices. In some embodiments, network 140 may be a secure network and require a password to access the network.

FIG. 2 illustrates an exemplary computational device 200 for implementing embodiments and features of present disclosure. By way of example computational device 200 or a similar computational device may be used to implement any of the devices or systems described herein, including client device 110, visual input reconstruction system 120, and/or user device 150. The components in computational device 200 are provided for purposes of illustration. It is contemplated that additional arrangements, number of components, and/or other modifications may be made to the disclosed computational device 200, consistent with the present disclosure.

Computational device 200 may include one or more processors 202 for executing instructions. Processor 202 may comprise known computing processors, including a microprocessor. Processor 202 may constitute a single core or multiple core processor that executes parallel processes simultaneously. For example, processor 202 may be a single core processor configured with virtual processing technologies. In some embodiments, processor 202 may use logical processors to simultaneously execute and control multiple processes. Processor 202 may implement virtual machine technologies, or other known technologies to provide the ability to execute, control, run, manipulate, store, etc., multiple software processes, applications, programs, etc. In another embodiment, processor 202 may include a multiple core processor arrangement (e.g., dual core, quad core, etc.) configured to provide parallel processing functionalities to allow execution of multiple processes simultaneously. In certain embodiments, processor 202 may use logical processors to simultaneously execute and control multiple processes. One of ordinary skill in the art would understand that other types of processor arrangements could be implemented that provide for the capabilities disclosed herein. The disclosed embodiments are not limited to any type of processor. Processor 202 may execute various instructions stored in memory 430 to perform various functions of the disclosed embodiments described in greater detail below. Processor 202 may be configured to execute functions written in one or more known programming languages. In some embodiments, processor 202 may be based on the Reduced Instruction Set Computer (RISC) architecture, Complex instruction Set Computer (CISC) architecture, or any other computer instruction architecture known in the art. It is also contemplated that processor 202 may include one or more graphics or other digital signal processors.

Computational device 200 may also one or more input/output (I/O) devices 204. By way of example, I/O devices 204 may include a display (e.g., an LED display, VR display), a headset, augmented glasses (e.g., GOOGLE GLASS), a physical keyboard, a light emitting component, a haptic feedback device, a touchpad, a mouse, a microphone, a printer, a scanner, a 3D scanner, a biometric device, a sensor, a motion sensor, a position sensor, a GPS sensor, an accelerometer, a magnetometer, virtual touch screen keyboard, a joystick, a stylus, a button, a switch, a dial, a knob, and/or any other I/O device.

As further illustrated in FIG. 2, computational device 200 may include memory 206 configured to store data or one or more instructions and/or software programs that perform functions or operations when executed by the one or more processors 202. Memory 206 may include a volatile or non-volatile, magnetic, semiconductor, optical, removable, non-removable, or other type of storage device or tangible (i.e., non-transitory) computer readable medium, consistent with disclosed embodiments. Memory 206 may include encrypted data and/or unencrypted data. By way of example, memory 206 may include Random Access Memory (RAM) devices, NOR or NAND flash memory devices, Read Only Memory (ROM) devices, etc. Computational device 200 may also include storage medium 208 configured to store data or one or more instructions and/or software programs that perform functions or operations when executed by the one or more processors 202. In some exemplary embodiments, storage medium 208 may also be configured to store data or instructions. By way of example, storage medium 208 may include hard drives, solid state drives, tape drives, RAID arrays, compact discs (CDs), digital video discs (DVDs), Blu-ray discs (BD), etc. Although FIG. 2 shows only one memory 206 and one storage medium 208, computational device 200 may include any number of memories 206 and storage mediums 208. Further, although FIG. 2 shows memory 206 and storage medium 208 as part of computational device 200, memory 206 and/or storage medium 208 may be located remotely and computational device 200 may be able to access memory 206 and/or storage medium 208 via network 140.

Computational device 200 may include one or more displays 210 for displaying data and information. Display 210 may be implemented using devices or technology, such as a cathode ray tube (CRT) display, a liquid crystal display (LCD), a plasma display, a light emitting diode (LED) display, a touch screen type display, a projection system, virtual reality or augmented reality glasses or headsets, and/or any other type of display capable of displaying 2D or 3D audiovisual content as known in the art. The disclosed embodiments are not limited to any particular type of display configured in computational device 200.

Computational device 200 may also include one or more communications interfaces 212. Communications interface 212 may allow software and/or data to be transferred between computational device 200, network 140, client device 110, visual input reconstruction system 120, data structure 130, user device 150, and/or other components. Examples of communications interface 212 may include a modem, a network interface (e.g., an Ethernet card or a wireless network card), a communications port, a PCMCIA slot and card, a cellular network card, etc. Communications interface 212 may transfer software and/or data in the form of signals, which may be electronic, electromagnetic, optical, or other signals capable of being transmitted and received by communications interface 212. Communications interface 212 may transmit or receive these signals using wire, cable, fiber optics, radio frequency (“RF”) link, and/or other communications channels. Communications interface 212 may be configured to communicate via WI-FI, BLUETOOTH, nearfield, LI-FI, and/or any other wireless transmission method.

Consistent with the present disclosure, the disclosed system may include at least one processor, which may be configured to execute one or more instructions, algorithms, etc. to perform the functions of the preview system. By way of example, as illustrated in FIGS. 1 and 2, system 100 may include one or more processors 202 included in one or more of client device 110 and visual input reconstruction system 120.

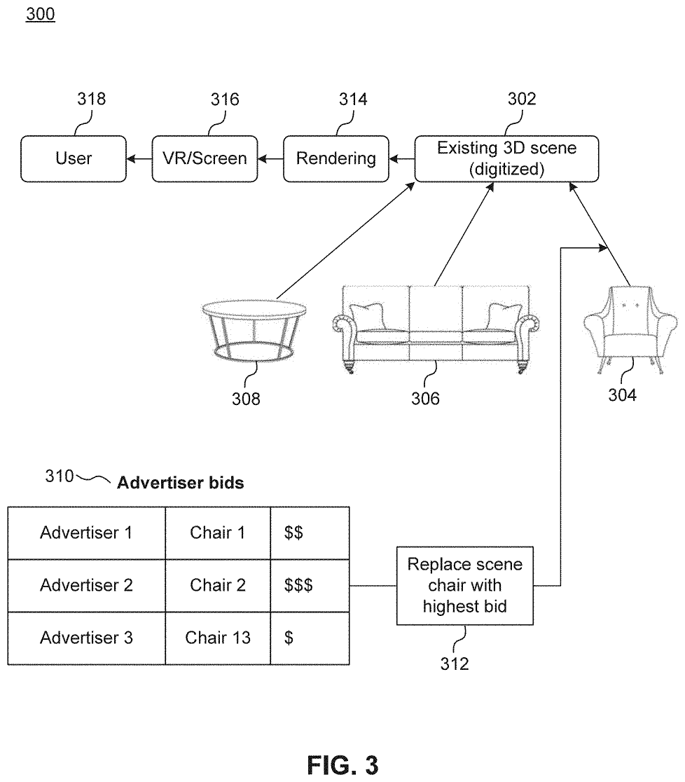

FIG. 3 depicts exemplary system 300 for selecting bids from advertisers and inserting an image corresponding to a winning bid into an existing scene from an audiovisual environment, consistent with embodiments of the present disclosure. System 300 may be an example implementation of system 100.

As shown, system 300 may include data comprising an existing scene, such as existing 3D scene 302 which may be digitized. Consistent with disclosed embodiments, scene 302 may include preexisting media content frames. Scene 302 is not limited to 3D data and may include VR data, AR data, MR data, image data, video data, and/or any other scene data. Scene 302 may include a representation of image objects, such as chair 304, sofa 306, and/or table 308. Image objects may correspond to one or more image object identifiers, as previously described.

System 300 may be configured to receive advertiser bids 310. An advertiser bid may include identifying information identifying an advertiser, an account, an individual, or other identifying information. For example, identifying information may include the labels “Advertiser 1,” “Advertiser 2,” or “Advertiser 3.” An advertiser bid may include object information. Object information may include an object identifier such as an object identifier for a product such as “Chair 1,” “Chair 2,” or “Chair 3.” An advertiser bid may be associated with a respective bid amount, represented by dollar signs in advertiser bids 310.

In some embodiments, system 300 may be configured identify a winning bid and replace an object in scene 302 with an object associated with the winning bid (e.g., winner image data). Identifying a winning bid may be based on criteria, consistent with disclosed embodiments. For example, system 300 may be configured to replace a scene chair with a chair associated with the highest bid (312) (e.g., from Advertiser 2).

System 300 may be configured to perform a rendering 314. Rendering may include processing a preexisting media content frame to insert a rendition of winner image data at the object insertion location. Rendering 314 may include any image processing technique as described herein or any other image processing technique. Rendering 314 may be formatted for display by a VR device and/or a screen (VR/Screen 316). A user 318 may view a rendered scene via VR/Screen 316.

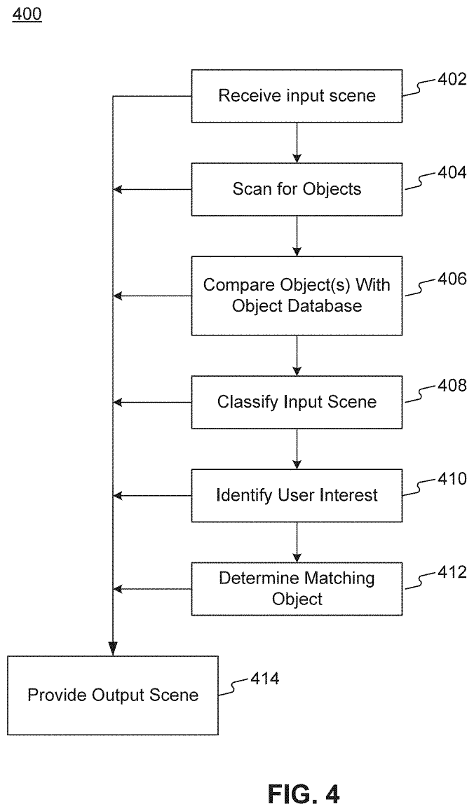

FIG. 4 depicts exemplary method 400 of selecting and inserting advertisement images into an existing scene from an audiovisual environment, consistent with embodiments of the present disclosure. The order and arrangement of steps in process 400 is provided for purposes of illustration. As will be appreciated from this disclosure, modifications may be made to process 400 by, for example, adding, combining, removing, and/or rearranging the steps for the process. Steps of method 400 may be performed by components of system 100, including, but not limited to, visual input reconstruction system 120. For example, although method 400 may be described as steps performed by visual input reconstruction system 120, it is to be understood that client device 110 and/or user device 150 may perform any or all steps of method 400. As one of skill in the art will appreciate, method 400 may be performed together with any other method described herein. For example, it is to be understood that process 400 may include steps (not shown) to transmit an object image identifier (e.g., step 504), receive a bid associated with the object image identifier (e.g., step 506), and/or any other actions, consistent with disclosed embodiments. Process 400 may be performed in real-time to alter an ongoing transmission of media content, consistent with disclosed embodiments.

At step 402, visual input reconstruction system 120 may receive or retrieve an input scene. An input scene may be received or retrieved from a data storage, consistent with disclosed embodiments. An input scene may be received from another component of system 100 and/or another computing component outside system 100 (e.g., via network 140). An input scene may be retrieved from a memory (e.g., memory 206), data structure (e.g., data structure 130), or any other computing component.

An input scene may be a VR, AR, and/or MR scene, consistent with disclosed embodiments. An input scene may be a 2D and/or 3D scene. An input scene may be in any format (e.g., F4V, .VR, etc.). An input scene may include preexisting content frames, consistent with disclosed embodiments. An input scene may include a previously modified scene, such as a scene that includes a processed media content frame that comprises winner image data, as described herein. Generally, an input scene may include any visual media.

Step 402 may include receiving or retrieving image object identifiers, consistent with disclosed embodiments. Step 402 may include receiving user data. User data may include identifying data (e.g., a user ID, an IP address, an account number), usage data, purchase data, interaction data, etc. Interaction data might include, but is not limited to, data related to gestures, voice, eye gaze, touch, etc.

At step 404, visual input reconstruction system 120 may scan an input scene for an object, consistent with disclosed embodiments. For example, visual input reconstruction system 120 may scan to detect an object such as a chair, a table, or a soda bottle. Other examples of objects are possible. Step 404 may include receiving or retrieving image object identifiers. Scanning may include object recognition algorithms (e.g., machine learning methods). Scanning may include determining or detecting an object insertion location, consistent with disclosed embodiments.

In some embodiments, input reconstruction system 120 may extract an object from scene. Extracting may include generating or copying image object data related to an object detected in a scene. The system may extract 2D or 3D shapes of objects or elements or portion of the scenes. For example, the system may generate a model of a detected game chair. In some embodiments, visual input reconstruction may transmit an extracted image object and/or an image object identifier to a client device, consistent with disclosed embodiments.

In some embodiments, scanning may include determining interaction data of a user in a VR, AR, or MR environment. For example, interaction data may be determined based on a frequency at which an object appears in a field of view, consistent with disclosed embodiments. Interaction data may be based on gestures, eye gaze, or other user actions.

At step 406, visual input reconstruction system 120 may compare detected object(s) with an objects in a data structure, such as an advertiser object data structure, consistent with disclosed embodiments. Additionally or alternatively, step 406 may include receiving an advertiser object from a client device and comparing the advertiser object to detect objects (e.g., receiving one or more bids comprising respective advertiser objects). Comparing may include implementing a classification algorithm (e.g., a machine learning model). Comparing may include generating one or more criteria such as a similarity metric, as described herein. Comparing may include segmenting an object within a scene, i.e., identifying components of an object, such as an object face, a line, a surface, or a component that is itself an object (e.g., identifying a wheel as a component object of a car object). Comparing may be based on an image object identifier. Comparing may include comparing based on text data, shape data, user data, and/or any other data.

At step 408, input reconstruction system 120 may classify an input scene, consistent with disclosed embodiments. For example, a scene may be classified as an indoor scene, an office scene, a reception hall scene, a sport venue scene, etc. Identifying or classifying a type of a scene in may be based on scene metadata describing or otherwise labeling a scene. Alternatively or additionally, scanning may include identifying or classifying a type of scene based on detected and identified objects within a scene (e.g., objects may be detected that are associated with a kitchen, and a scene may be identified as a kitchen scene accordingly).

At step 410, input reconstruction system 120 may identify a user interest, consistent with disclosed embodiments. A user interest may include data indicating a correlation between a user and other data, such as an object in a scene, an advertisement object, or other data. Identifying a user interest may be based on user data, including interaction data, as previously described. Identifying a user interest may include implementing a statistical analysis of user data, object data, and/or a classification of a scene. Identifying a user interest may include receiving or retrieving additional user data based on received user data and/or estimated interaction data.

At step 412, visual input reconstruction system 120 may determine a matching object, consistent with disclosed embodiments. Determining a matching object may be based on output of an algorithm or model (e.g., a machine learning model). Determining a match may be based on an image object identifier. A matching object may include an advertiser object (i.e., an object associated with an advertiser, a product, or the like). Determining a match may be based on a highest bid and/or other criteria to determine a winning bid, as described herein. For example, determining a matching object may be based on an external variable, such as a time of day, or a property of a user who will receive an input scene or a modified scene. In some embodiments, determining a matching object may be based on an indication of a user interest. User interest may be determined by historical user data, including interaction data, such as data indicating which portion of a scene a user interacts with. Interaction might include, but is not limited to, gestures, voice, eye gaze, touch etc.

At step 414, visual input reconstruction system 120 may provide an output scene, consistent with disclosed embodiments. In some embodiments, providing an output scene may include replacing an object with a matching object to modify an input scene and output a modified with a matching object, consistent with disclosed embodiments. That is, an output scene may be a modified scene. Replacing an object may include any image processing method, consistent with disclosed embodiments. For example, replacing an object may include inserting at least a rendition of an object in a scene

As shown, step 414 may follow any step of process 400. For example, visual input reconstruction system 120 may determine that no match is found, that an input scene is classified as one that should not include advertisements, or that a user will not be interested in a product. Accordingly, an output scene may be the same as an input scene. In this way, visual input reconstruction system 120 may provide targeted advertisements by providing a modified scene to some users while providing preexisting content to other users.

Providing an output scene at step 414 may include storing and/or transmitting an output scene, consistent with disclosed embodiments. For example, step 414 may include broadcasting an output scene and/or storing an output scene in memory (e.g., memory 206, storage medium 208, and/or data structure 130).

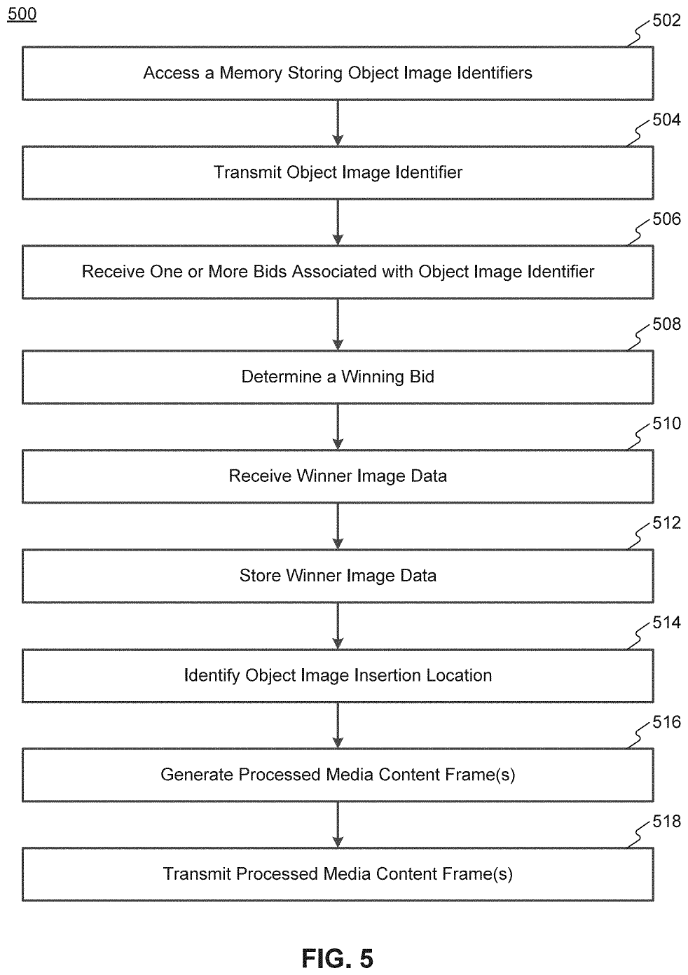

FIG. 5 depicts exemplary method 500 for enabling selective insertion of content into preexisting content frames, consistent with embodiments of the present disclosure. Although steps of process 500 may be described as performed by visual input reconstruction system 120, one of skill in the art will appreciate that other components of system 100 and/or components outside of system 100 may perform one or more steps of process 500. The order and arrangement of steps in process 500 is provided for purposes of illustration. As will be appreciated from this disclosure, modifications may be made to process 500 by, for example, adding, combining, removing, and/or rearranging the steps for the process.

At step 502, visual input reconstruction system 120 may access a memory storing a plurality of object image identifiers associated with a plurality of objects, consistent with disclosed embodiments.

At step 504, visual input reconstruction system 120 may transmit, to one or more client devices, at least one object image identifier of the plurality of object image identifiers.

At step 506, visual input reconstruction system 120 may receive from the one or more client devices, one or more bids associated with the at least one object image identifier, consistent with disclosed embodiments.

At step 508, visual input reconstruction system 120 may determine a winning bid from among the received one or more bids, consistent with disclosed embodiments. In some embodiments, the winning bid may be associated with a winning client device from among the one or more client devices.

At step 510, visual input reconstruction system 120 may receive winner mage data from the winning client device, consistent with disclosed embodiments.

At step 512, visual input reconstruction system 120 may store the winner image data in the memory, consistent with disclosed embodiments.

At step 514, visual input reconstruction system 120 may identify, in at least one preexisting media content frame, an object insertion location for an object corresponding to the at least one object image identifier, consistent with disclosed embodiments.

At step 516, visual input reconstruction system 120 may generate at least one processed media content frame by processing the at least one preexisting media content frame to insert at least a rendition of the winner image data at the object insertion location, consistent with disclosed embodiments.

At step 518, visual input reconstruction system 120 may transmit the at least one processed media content frame to one or more user devices, consistent with disclosed embodiments.

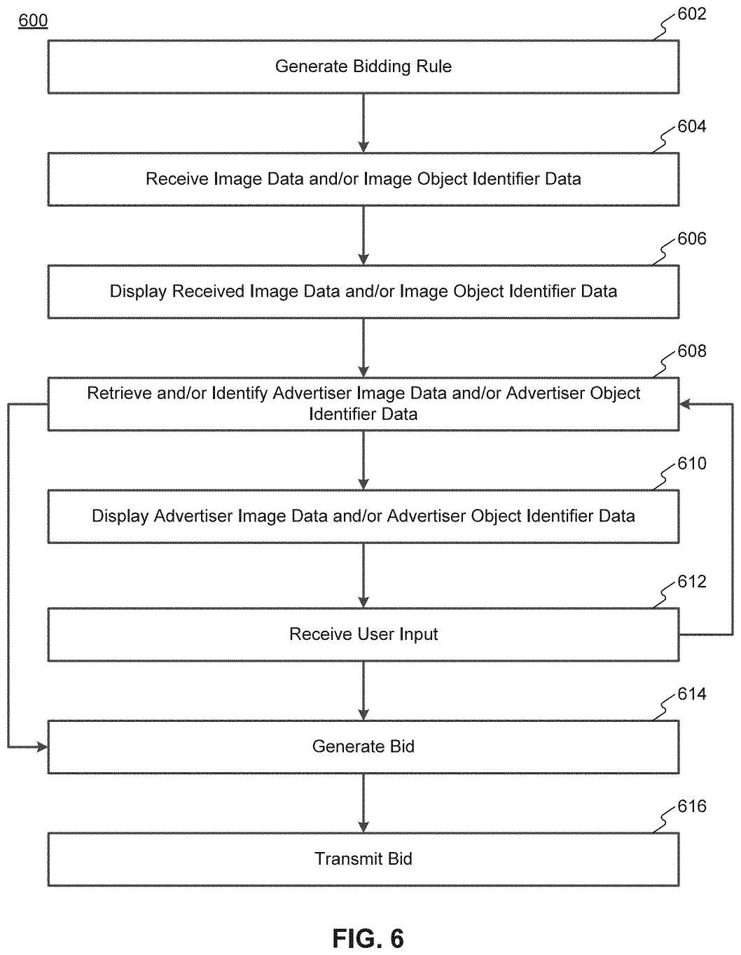

FIG. 6 depicts exemplary method 600 of placing a bid to insert content into preexisting content frames, consistent with embodiments of the present disclosure. Although steps of process 600 may be described as performed by client device 110, one of skill in the art will appreciate that other components of system 100 and/or components outside of system 100 may perform one or more steps of process 600. The order and arrangement of steps in process 600 is provided for purposes of illustration. As will be appreciated from this disclosure, modifications may be made to process 600 by, for example, adding, combining, removing, and/or rearranging the steps for the process.

At step 602, client device 110 may generate a bidding rule, consistent with disclosed embodiments. A bidding rule may be a logical rule, an algorithm, an expression, or a model (e.g., a machine learning model) that limits or otherwise defines characteristics of a bid. For example, a bidding rule may include a rule to associate an advertising image object with a target audience. A bidding rule may be based on a content media frame, an object identifier, and/or image data. For example, a bidding rule may be based on received image data, received object identifier data, advertising image data, and/or advertising object identifier data, as described herein. A bidding rule may include a maximum value of a bid, a time associated with a bid, or other property of a bid. A bidding rule may include a rule to place a bid based on a similarity metric generated by a matching algorithm or a shape-similarity engine. Generating a bidding rule may be based on data received from another computing component, from user input. A bidding rule may be based on data associated with historical bids (e.g., a click-rate on a previous advertisement associated with a previous bid). As one of skill in the art will appreciate, the examples of bidding rules presented herein are not limiting and other examples are possible, consistent with disclosed embodiments. Generating a bidding rule may include copying or modifying a previously generated bidding rule.

At step 604, client device 110 may receive image data and/or image object identifier data, consistent with disclosed embodiments. Image data may be in any format, including VR, AR, MR, 2D, 3D, and/or any other format. An image object identifier may include a label, text, a classification, and/or any other image object identifier, consistent with disclosed embodiments.

At step 606, client device 110 may display received image data and/or image object identifier data at an interface, consistent with disclosed embodiments. For example, client device 110 may generate an interface at a headset, an LED screen, a touch screen, and/or any other screen. An interface may include input and output devices capable of receiving user input and providing information to a user, as described herein or any other type of interface. Displaying may include providing visual data (e.g., via projector or screen), audio data (e.g., by playing a sound on a speaker), and/or tactile data (e.g., via a haptic feedback device). For example, the received image data may comprise an image of a blue office chair with wheels, and a received object identifier data may include “office chair,” “chair,” “blue chair,” and/or “wheeled chair.”

At step 608, client device 110 may retrieve and/or identify advertiser image data and/or advertiser object identifier data, consistent with disclosed embodiments. In some embodiments, step 608 may include accessing or searching a data storage, such as data structure 130. The data storage may include advertiser image data and/or advertiser object identifier data. Advertiser image data may include images associated with a product, a message, a campaign, or any other image data, consistent with disclosed embodiments. In some embodiments, advertiser image data may include text data, numeric data, and/or other data. Advertiser object identifier data may include any object identifier, consistent with disclosed embodiments.

Retrieving and/or identifying advertiser image and/or advertiser object identifier data at step 608 may be based on received image data and/or received object identifier data. In some embodiments, retrieving may include implementing a search algorithm and/or a matching algorithm such as a shape-similarity engine, as previously described. In some embodiments, step 608 may be supervised and be based on user inputs. In some embodiments, step 608 may follow step 610, as shown in FIG. 6.

At step 610, client device 110 may display advertiser image data and/or advertiser object identifier data, consistent with disclosed embodiments. Step 610 may include displaying advertiser image data and/or advertiser object identifier data at the same interface used in step 606, or at another interface. Step 610 may include displaying received image data, advertiser image data, image object identifier data, and/or advertiser image object identifier data.

At step 612, client device 110 may receive user inputs, consistent with disclosed embodiments. User inputs may relate to received image data, advertiser image data, image object identifier data, and/or advertiser image object identifier data. User inputs may include inputs to select at least one advertiser image object and/or advertiser object identifier. User inputs may include inputs to generate a bid.

As shown in FIG. 6, steps 608 through 612 may be repeated any number of times. For example, user inputs received at step 612 may include instructions to retrieve and/or identify advertiser image data and/or advertiser object identifier data, allowing a user to iteratively refine a search and select an advertiser image object or advertiser object identifier data.

At step 614, client device 110 may generate a bid, consistent with disclosed embodiments. A bid may include a value, a range of values, a duration to hold a bid open for acceptance, a duration to include an advertisement, information related to a target audience, a means of transmission or broadcast, and/or any other information relating to a bid. Generating a bid may be based on bidding rules limiting or otherwise defining characteristics of a bid (e.g., logical rules, algorithms, expressions, or the like). Generating a bid may be based on user inputs (e.g., user inputs of step 610). In some embodiments, as shown in FIG. 6, generating bid at step 614 may be based on results of a search process executed at step 608. For example, process 600 may be automated and bids may be generated based on a matching algorithm and received image data, received object identifier data, and/or bidding rules. A bid may include advertiser image data and/or advertiser object identifier data, consistent with disclosed embodiments.

At step 616, client device 110 may transmit a bid, consistent with disclosed embodiments. Step 616 may include transmitting a bid to input image reconstruction system 120. Transmitting a bid may include transmitting advertiser image data and/or advertiser object identifier data.

The present disclosure also relates to computer-implemented systems for processing scenes (e.g., 3D scenes based on scans) for use in virtual reality (VR), augmented reality (AR), and mixed reality (MR) technology and applications. The present disclosure provides solutions to problems in technology and applications for generating and altering objects in scenes. While the present disclosure provides examples of AR, VR, and MR technologies and applications, it should be noted that aspects of the disclosure in their broadest sense are not limited to particular examples. Rather, it is contemplated that the foregoing principles may be applied to other computerized-reality technologies and applications.

In accordance with the present disclosure, a computer-implemented system for generating a 3D scene is disclosed. FIG. 1 depicts an exemplary system 100 for generating a 3D scene, consistent with embodiments of the present disclosure. The system may comprise at least one processor. Exemplary descriptions of a processor and memory are described above, and also with reference to FIG. 2.

The processor may be configured to receive a scan of a scene. A scene may be received from another device (e.g., a client device, a user device). A scene may be retrieved from a remote or local data storage. A scene may include image data, consistent with disclosed embodiments. In some embodiments, the scene may be based on a scan, the scan including capturing image data from one or more cameras or scanners (e.g., a 3D scanner).

In some embodiments, a scan may be an incomplete scan (i.e., a scan that captures a partial representation of an object). For example, an incomplete scan may capture a portion of an object, such as the front of a chair. In some cases, an incomplete scan may result when a scan obtains less information than is necessary to represent a complete object in 3D. For example, a scan may receive data from less than all directions necessary to capture all surfaces of the 3D object, or other objects may block scanner input (e.g., another object may be between the object and a camera). An incomplete scan may obtain only two-dimensional (2D) data, in some cases. An incomplete scan may arise when a scan does not obtain a property of a real object, such as color information. An incomplete scan may result due to limitations with scan input methods or other errors (e.g., a partially transparent object may not appear in a scan). In some cases, an incomplete scan may arise when a scan misses a portion of scene data (e.g., holes in a scene) or other errors or distortions due to hardware limitations or user errors that occur during scanning.

Consistent with disclosed embodiments, a scene may be configured for display via a device, such as a headset, a computer screen, a monitor, a projection, etc. Aspects of a scene may be encoded in a known format, such as 3D vector format, a Computer-Aided Design file, .FLV, .MP4, .AVI, .MPG, .MP3, .MOV, .F4V, .VR, or any other image, video, or model format. Embodiments consistent with the present disclosure may include scenes represented by a mesh, point cloud, or any other representation that encodes a scene.

In an exemplary embodiment, a scene may include a 3D representation of a living room encoded as a mesh as discussed above. To illustrate this principle, a mesh of a scene may in include establishing points that constitute a floor, a wall, a doorway, stairs, etc. Consistent with disclosed embodiments, a mesh may include a plurality of virtual objects (i.e., components) that represent real-world or imaginary objects such as furniture items, buildings, persons, animals, mythological creatures, plants, or any other objects. A component may include another component (e.g., a table may include a leg). Generally, a component of a scene (i.e., object) may include a grouping of points or polygons in a mesh based on a relationship between the points or polygons. In a scene, an object may change a location, rotate, change size, change shape, etc.

In some embodiments, a scene may include at least one object, as described herein. The object may be, for example, a chair, a car, a painting, a person, an animal, a mythological creature, and/or any other object.

In some embodiments, the system may generate image elements based on received scan and/or the scene may include image elements, consistent with disclosed embodiments. More generally, a scene may include a plurality of image elements, such as image elements or basic 2D elements. For example, image elements may comprise at least one of a pixel, a voxel, a point, or a polygon. In some embodiments, the system may generate a set of polygons or voxels, the individual polygons or voxels being basic elements.

Image elements may be further subdivided in some cases. For example, the system may generate a mesh comprised of a plurality of n-sided polygons as image elements, and one or more polygons may be subdivided into additional polygons to improve resolution or for other reasons. In some embodiments, a scene may include a plurality of preexisting image elements. Preexisting image elements may be received together with or separately from receiving a scene.

In some embodiments, the system may process image elements in a scene to segment the scene into scene-components consistent with the segmenting techniques discussed above. Consistent with embodiments of this disclosure, segmenting may additionally or alternatively be performed using techniques for segmenting discussed above. For example, the system may segment the scene into scene-components of objects representing living room furniture, such as chairs, cups, tables, or other objects, consistent with disclosed embodiments. An object may have one or more scene-components that may be objects themselves. For example, the armrests of an office chair may be separate independent scene-components, or they can be part of a scene-component representing a whole chair. Accordingly, segmenting may include identify armrests as scene-components and/or a whole chair as a scene-component. Segmenting may include identifying scene-components that correspond to a known classification (e.g., identifying a scene-component and classifying it as an “armrest”) and/or to an unknown classification (e.g., identifying a scene-component and classifying it as “unknown component”), as discussed below.

As discussed above, segmenting may include partitioning (i.e., classifying) image elements of a scene into scene-components. A classification may include a type of scene-component. For example, “furniture,” “chair,” “office chair” may all be classes of an object, including classes of the same object. As will be apparent to one of skill in the art, classes may be defined in a hierarchy of classes that are broader or narrower relative to each other. For example, a “furniture” class may be broader than a “chair” class, which may be broader than an “office chair” class.

For example, a scene-component may include points, voxels, or polygons associated with an unknown object a known object such as a table, a surface of a table, a leg of a table, etc. The system may segment the scene comprising a scan of a living room into a plurality of scene-components, such as a chair, a doorknob, a handle, a cup, a utensil, a shoe, a wall, a leaf of a plant, a carpet, a television, etc. The system may segment image elements as belonging to a scene-component and classifying the scene-component with a known classification or an unknown classification. For example, during segmenting, scene-components may be labeled as a specific type of object (e.g., a chair), as an unknown type of object, and/or as a possible known object (e.g., a “likely” chair) based on some measure of confidence or likelihood associated with a segmenting algorithm output. One or more image elements may remain unmapped following segmenting (i.e., unassigned to an object or component of an object). Segmenting may include mapping (i.e., assigning) 3D elements to one object or more than one object (e.g., a same 3D element may be assigned to “armrest” and to “chair”).

In an exemplary embodiment, segmentation may include implementing a classification model and identifying a scene-component based on classification model output, the output comprising a label such as “unknown scene-component.” For example, an “unknown scene-component” may correspond to an armrest of a chair, but the classification model output may not recognize the scene-component as an armrest. Other parts of the chair may be separately identified during segmentation and corresponding scene-components may be labeled as “unknown,” “headrest,” “chair leg,” etc.

The system may identify, based on a comparison of the scene-components with stored image data, a matched-component from among the scene-components, the matched-component corresponding to a component of the at least one object. Consistent with embodiments of this disclosure, the system may additionally or alternatively compare the scene-components with stored image data using one or more of the techniques for comparing objects and/or image data discussed above. A matched-component may be an improved classification of a scene-component and/or may include additional information associated with a scene-component. For example, a scene-component may be classified as “unknown” and, based on a comparison of the scene-component with stored image data, the scene-component may be identified as a matched-component labeled as an “armrest.” A matched-component may include a model of the at least one object and/or an image object identifier, consistent with disclosed embodiments. In some embodiments, a matched-component may be a component that is similar to but not the same as a scene-component. For example, a scene-component may be a black chair on a pedestal with wheels and armrests, and matched-components may include office chairs with pedestals in various colors, with or without armrests.

In some embodiments, identifying a matched-component from among scene components may include mapping a 3D shape to a feature vector (i.e., generating a feature vector). In some embodiments, the system may compute a feature vector of a scene component and/or feature vector of a matched-component. A feature vector may include a sequence of real numbers or other data. A feature vector may include information relating to a rotation and/or a location change of a scene-component or matched-component. Generating a feature vector may include using a machine learning model such as a multi-view convolutional neural network. For example, a multi-view convolutional neural network may accept a plurality of 2D representations of a 3D shape (i.e., snapshots), the 2D representations including projections of the 3D shape onto 2D from various angles (e.g., photos of an object).

Comparing components may include determining a similarity metric indicating a degree of similarity between the matched-component and stored image data. A similarity metric may be based on shape data, color data, and/or any other data. A similarity metric may be based on a statistical similarity such as a covariance, a least-squares distance, a distance between vectors associated with image elements (e.g., feature vectors), or a Hausdorff distance between aligned objects. A similarity metric may be based on a feature vector. In some embodiments, a model may generate a similarity metric, such as a machine learning model. In some embodiments, comparing may include implementing a classification model (e.g., a random forest model) to classify components of an object. Identifying a component corresponding to the at least one object is based on a similarity metric. As an example, an object may be a chair, and the system may determine that a certain scene-component is similar to a matched-component that is an armrest of a chair based on a similarity metric between the certain scene-component and image data in a data structure comprising 3D models of chairs and armrests. Exemplary data structures, consistent with the embodiments of this disclosure, are described above.

Comparing a scene-component with stored image data may include searching a data structure of objects based on a scene-component and generating one or more search results (i.e., matches) corresponding to objects in the data structure. A search result may include a percent match, a likelihood, or another metric representing a degree of similarity between the detected object and an object in a data structure or an object corresponding to an image object identifier in the data structure. A highest-ranking search result may define, for example, the narrowest class of an object or component in a data structure that matches a detected object, for example. In some embodiments, the system may identify a similar object based on a previously-conducted search of a data structure.

Consistent with the present disclosure, a data structure may include stored image data. Image data of the data structure may include 2D or 3D models of objects. Image data may include scene data with tagged objects. A data structure consistent with the present disclosure may include one or more Computer Aided Design (CAD) models corresponding to one or more objects. A CAD model may be stored in one or more formats, such as a mesh, a point cloud, a voxel-mapping of a 3D space, and/or any other mapping that may be configured to present a graphical depiction of an object. A CAD model may represent an object and/or a component of an object (e.g., a chair and/or an armrest of a chair).

Matched-components in a data structure may correspond to one or more object image identifiers. An object image identifier may include text representing an object image (i.e., a label or tag, such as a name of an object). For example, an object image identifier of an office chair may include the label “office chair.” In some embodiments, an object image identifier may comprise at least one of a shape, a descriptor of a shape (e.g., a label or a text description of a shape comprising sentences), a product, or a descriptor of a product. A shape may include shape data, the shape data comprising coordinates, vectors, a mesh or grid, a representation of a shape (e.g., a 2D or 3D model), or any other data relating to a shape. A descriptor of a shape may include text data, a label, a classification, a tag, and/or any other data describing or identifying a shape. A product may include shape data (e.g., shape data providing a representation of a physical surface of a product, such as a surface of a sports car). A descriptor of a product may include text data, a label, a classification, a tag, and/or any other data describing or identifying a product.

In an exemplary embodiment, based on a comparison of the scene-component labeled as “unknown scene-component” with stored image data, the system may label a matched-component as an “armrest.” In some cases, based on a comparison of the scene-component labeled as “unknown scene-component” with stored image data, the system may associate a scene-component with a 3D model (e.g., a model of an armrest). Alternatively or additionally, based on a comparison of the scene-component labeled as “unknown scene-component” with stored image data, the system may identify a “chair” (i.e., the complete chair) and/or associate one or more scene-components with a 3D model of a chair.

In some embodiments, the system may transmit a scene to a client device or display a scene at an interface of the system. Transmitting may include transmitting over any network, such as a TCP/IP network, a broadband connection, a cellular data connection, and/or any other method of transmitting. A client device and/or an interface of the system may include, but is not limited to, a mobile device, a headset, a computer, a display, an interface, and/or any other client device. In some embodiments, transmitting or displaying a scene may include transmitting or displaying a scene-component as a highlighted scene-component. For example, the highlighted scene-component may be presented with an outline, a change of brightness, a change of a color, or the like. The system may transmit or display a scene such that a detected scene-component becomes highlighted when a client device performs an action (e.g., a mouse-over hover, an eye-gaze, etc.).

In some embodiments, using an interface, a client (e.g., a video game designer or an advertiser) may select a detected object in a scene, such as an office chair. As one of skill in the art will appreciate, selecting may include performing one or more actions, such as clicking on an object, entering an identifier into a text box, making a gesture that selects an object, or the like. The system may receive the selection from the interface or via a transmission from a client device. In some embodiments, the system may transmit data to a client device or display data at an interface, the data being related to one or more matched-components. For example, the system may transmit image data associated with a matched-component, a 3D model associated with the matched-component, or an image object identifier associated with a matched-component, consistent with disclosed embodiments. In some embodiments, a client may select data related to a matched-component. For example, the client may select an image of a blue office chair with a pedestal and no armrests.

Consistent with the present embodiments, the system may identify, based on a matched-component, image elements corresponding to at least one object. For example, in some embodiments, an object may comprise the matched-component (e.g., the matched-component may be an armrest and the at least one object may be a chair comprising the armrest). In some embodiments, the at least one object may be the same as the matched-component (e.g., the matched-component is a soda bottle and the at least one object is the same soda bottle). Identifying image elements may include determining that 3D elements not included in the matched-component correspond to an object, such as an object within a predetermined distance. For example, the matched-component may be a beach umbrella and the at least one object may be a beach towel adjacent to the beach umbrella or a sandcastle within a predetermined distance of the beach umbrella. Consistent with disclosed embodiments, identifying image elements corresponding to the at least one object may be based on image data in a data structure, such as a CAD model, an image object identifier, or other data.

In some embodiments, the system may obtain a CAD model from a storage location based on the image elements corresponding to the at least one object. The CAD model may include a script describing a movement property or material property (i.e., texture characteristic) of the at least one object. The CAD model may comprise image elements, consistent with disclosed embodiments. As previously disclosed, a CAD model may represent an object and/or a component of an object (e.g., a chair and/or an armrest of a chair). A CAD model may be stored in one or more formats, such as a mesh, a point cloud, a voxel-mapping of a 3D space, and/or any other mapping that may be configured to present a graphical depiction of an object.

In some embodiments, the system may access semantics associated with the CAD model, the semantics including a script representing movability characteristics of the at least one object. Accessing semantics may include retrieving or receiving semantics from a data storage (e.g., a data structure), consistent with disclosed embodiments. In some embodiments, accessing semantics may be based on an image object identifier associated with a 3D model and with semantics of the 3D model.

In embodiments consistent with the present disclosure, semantics associated with a CAD model may include properties of an object, such as movement or material properties. For example, a chair may be capable of swiveling, reclining, adjusting an armrest height, or have other movement properties associated with motion. Generally, movement properties may include any property associated with a freedom of motion of an object or a component of an object. As an example of a material property (i.e., a texture characteristic), a chair seat may be firm and not deform when another object is placed on it (e.g., when a person sits on a wooden chair). Alternatively, a texture characteristic of a chair seat may be plush and deform when another object is placed on it (e.g., when a person sits on a padded chair). Material properties include, but are not limited to, elasticity, hardness, roughness, smoothness, reflectivity, color, shape, deformability, or other material properties. Generally, semantics associated with a CAD model may include movement properties or material properties of the CAD model.

Semantics may include scripts that represent or govern movement properties or material properties, and such scripts may be configurable by a designer or other client. For example, during an animation of a scene a client may modify a degree of freedom of a chair such as an ability to swivel. A script may include, for example, a programmatic description of the reaction of an object with degrees of freedom to external forces. For example, for a swivel chair, the program will provide a rotation of the CAD model of upper part of the chair with respect to the legs of the chair, given a rotation force on the upper part. This change of the object may be rendered in a scene. As another example, a CAD model may replace a curtain, and a script may describe the reaction of the curtain to wind, and we can make a replaced curtain react accordingly in the scene. The script may be written in any code capable of animating an object (e.g., AUTOCAD, BLENDER, CINEMA 4D, and/or AUTODESK MAYA).

A CAD model may have scripts associated with a whole object (e.g., an elasticity of a ball when bouncing), or associated with a part of an object (e.g., a motion of a rotor on a helicopter). Degrees of freedom may be complex, representing interactions between several objects such as a lever that raises a chair seat up, a handle that opens a door, etc. Accordingly, a script may represent an interaction between one object and at least one other object in the scene. Although a scanned scene may be static or otherwise fail to include scripts encoding certain dynamical movement or material properties, a CAD model may encode semantics and a replaced scene may include a programmatic description of such movement and material properties.

In some embodiments, the system may generate a modified scene by combining a CAD model of the object and the scene. Consistent with disclosed embodiments, combining may include replacing an object, replacing part of an object, changing a movement or material property of an object, etc. For example, generating a modified scene may include applying a texture characteristic (e.g., a reflectivity or color) of a CAD model of an object to a scene-component.

Consistent with the present disclosure, generating a modified scene may include combining object data with scene data. For example, the system may replace the original object (e.g., black office chair) from the scene with another object (e.g., blue office chair) as selected by the client. Replacing an object may include positioning the selected object in the same orientation (i.e., aligning an object) and similar size as the original object (i.e., scaling an object). Aligning an object and/or scaling an object may include using Principal Component Analysis (PCA). Replacing an object may include allowing a client to position, scale, or otherwise manipulate the selected object within the scene. Replacing an object may include using image processing techniques (e.g., adjusting brightness, adjusting lighting, implementing a gradient domain method, etc.), consistent with disclosed embodiments. As one of skill in the art will appreciate, a gradient domain method may include constructing a new image by integrating the gradient of image elements. Replacement may include rendering the mesh, points, or any other digitized representation of an object based on lighting, scene resolution, a perspective, etc.

Following replacement of an object, the resulting scene may be an example of a modified scene by combining information obtained from a CAD model of the object and the original scene.

Consistent with disclosed embodiments, a modified scene may include a hybrid scene comprising at least a portion of the CAD model and at least a portion of the at least one object. A hybrid scene may refer to a modified scene in which only a part of an object (e.g., armrests of an office chair) or a property of an object (e.g., texture or color) is replaced with object data from a data structure. A scene with at least one object having properties derived by both the original object and an object from another source (e.g., a data structure) is an example of a hybrid scene. A portion of a CAD model may include image elements corresponding to a component of a CAD model (e.g., an armrest of a chair). A portion of the at least one object may include image elements corresponding to a component of the object (e.g., the leg of a chair). In some embodiments, the portions of the CAD model and portions of the at least one object may be blended at the boundary using image processing techniques to create a realistic appearance. For example, an image processing technique may include a gradient domain method or other image merging method.

In some embodiments, a modified scene may comprise a refinement of a scene based on the semantics of a CAD model. In some embodiments, if a scanned scene is an incomplete scan, replacing may include scene refinement, i.e., a process of replacing partial information with additional information. Refinement may include replacing a part of an object with a full 3D object from a data structure. For example, a scan may include only a part of an object (e.g., the front of a chair), and replacing the object may include replacing the part of the object with a full 3D object from a data structure. Another example of scene refinement from semantics of a CAD model include adding color or texture from an object in a data structure to a scanned object that has shape but not color or texture. As another example of scene refinement, a system may determine that a scanned chair is a metal chair, and a data structure may include material properties of metal or metal chairs, such as a surface reflectivity property. The system may add lighting to the chair based on the surface reflectivity property to enhance the realism of the chair. Scene refinement may be based on semantics of a CAD model, as described in greater detail, below, including movement properties or material properties of the CAD model. Additional or alternative techniques for combining two images (e.g. first image and second image) discussed above may also be used to generate the modified or hybrid scene.

In some embodiments, the system may extract material properties from a matched-component and apply the extracted material properties to the CAD model, consistent with disclosed embodiments. For example, a scan may extract properties of an object such as texture characteristics or color. In an exemplary embodiment, a scanned chair may include metal surfaces, and a matching CAD chair in a data structure may have a different material or no specified material on its surfaces. Accordingly, replacing the object may include rendering the CAD chair as a metal chair. For example, a matched-component may be a seat chair and have a material property related to a color, a texture, a firmness, etc. The system may extract the material property from the matched-component and apply it to a CAD model of a chair. Additional or alternative techniques for combining two images (e.g. first image and second image) as discussed above may also be used to generate the modified or hybrid scene, consistent with the embodiments of this disclosure.

In some embodiments, the system may apply a script to the CAD model in a hybrid scene, the script being configured to be executed to render the object movable in the hybrid scene. For example, the script may be configured to allow an object to translate, rotate, hinge, bend, or otherwise animate an object. The script may be written in any code capable of animating an object (e.g., AUTOCAD, BLENDER, CINEMA 4D, and/or AUTODESK MAYA). In some embodiments, the hybrid scene including the script is outputted for 3D display. For example, the hybrid scene with the script may be formatted for a VR helmet or any other 3D display and transmitted to the display. Outputting a scene is described in greater detail, below.

In some embodiments, the system may select another script associated with the object, the another script representing an interaction between the object and at least one other object in the scene. Selecting another script may be based on an image object identifier associated with the at least one object and another object. For example, a first script may be associated with a first image object identifier corresponding to a ball, and a second script may be associated with the first image object identifier corresponding to the ball and a second image object identifier corresponding to a bat. The first script may include a script allowing a movement of the ball under gravity, and the second script may include a script allowing the bat to interact with the ball (e.g., a bat striking a ball). In some embodiments, the system may apply the script to the CAD model in the hybrid scene.

Consistent with disclosed embodiments, the system may output the modified scene for 3D display. Outputting the modified scene may include storing and/or transmitting a modified scene, consistent with disclosed embodiments. Transmitting may include transmitting over a network by any known method, consistent with disclosed embodiments. For example, the system may broadcast a modified scene (i.e., transmit to a plurality of user devices via a network), transmit a modified scene to a user device, and/or store a modified scene in memory.

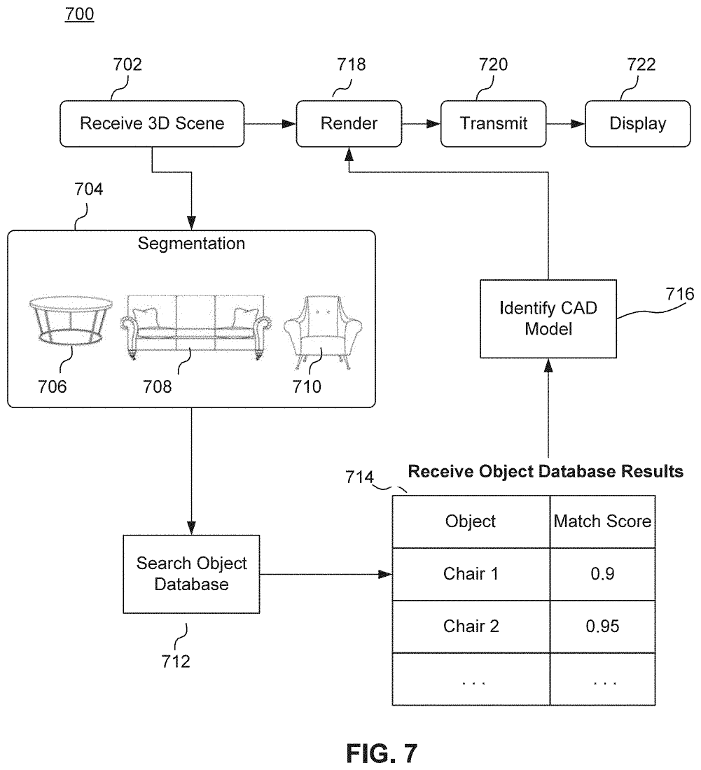

FIG. 7 depicts exemplary method 700 of selecting a 3D model for replacing a CAD object in a scene, consistent with embodiments of the present disclosure. The order and arrangement of steps in process 700 is provided for purposes of illustration. As will be appreciated from this disclosure, modifications may be made to process 700 by, for example, adding, combining, removing, and/or rearranging the steps for the process. Steps of method 700 may be performed by components of system 100, including, but not limited to, 3D generator 120. For example, although method 700 may be described as steps performed by 3D generator 120, it is to be understood that client device 110 and/or user device 150 may perform any or all steps of method 700. As one of skill in the art will appreciate, method 700 may be performed together with any other method described herein. In some embodiments, process 700 may be performed together with steps of process 800 and/or 900. Process 700 may be performed in real-time to alter an ongoing transmission of media content (e.g., a broadcast of a scene), consistent with disclosed embodiments.

At step 702, 3D generator 120 may receive a 3D scene, consistent with disclosed embodiments. A scene may be received or retrieved from a data storage, consistent with disclosed embodiments. A scene may be received from another component of system 100 and/or another computing component outside system 100 (e.g., via network 140). A scene may be retrieved from a memory (e.g., memory 206), data structure (e.g., data structure 130), or any other computing component. A scene may be based on image captured by one or more cameras (i.e., a scan), consistent with disclosed embodiments.

At step 704, 3D generator 120 may segment a 3D scene, consistent with disclosed embodiments. As described herein, segmenting may include partitioning (i.e., classifying) image elements of a scene into scene-components or objects such as table 706, sofa 708, chair 710, and/or other components or objects. In some embodiments, step 704 may include generating a mesh, point cloud, or other representation of a scene.

At step 712, 3D generator 120 may search an object data structure to identify one or more matched-components, consistent with disclosed embodiments. Searching an object data structure may be based on scene-components. An object data structure may include 3D models, image data, CAD models, image object identifiers, and/or any other data related to components and/or objects.

At step 714, 3D generator 120 may receive object data structure results based on the search, consistent with disclosed embodiments. Although only two objects from the data structure are depicted at step 714 as results of the search, more generally, object data structure results may include any number of results. Results of the search from the data structure may include a 3D model, a matched-component, an image object identifier, and/or a similarity metric, consistent with disclosed embodiments. A similarity metric may include a “match score” or any other similarity metric, consistent with disclosed embodiments. A match score may represent a probability that a component of a scene is a data structure component or object. A match score may represent a degree of similarity between a component of a scene and a data structure component. A match score may be based on a shape of a component and a shape of a data structure component. As shown in FIG. 7, a “Chair 1” is an object in the data structure and is associated with a match score of 0.9, and a “Chair 2” is an object in the data structure and is associated with a match score of 0.95. In the example of FIG. 7, the match score may represent a degree similarity between chair 710 and chairs in the data structure.

At step 716, 3D generator 120 may identify a CAD model based on object data structure results, consistent with disclosed embodiments. For example, 3D generator 120 may identify a CAD model associated with the highest match score (e.g., “Chair 2”).

At step 718, 3D generator 120 may render a modified scene, consistent with disclosed embodiments. Rendering a modified scene may include rendering an object based on a CAD model, replacing a scene-component with a CAD model, combining a scene with a CAD model, and or any other method of rendering as disclosed herein. A modified scene may be rendered to create a scene in which aspects of a CAD model appear natural to a viewer as compared to the other components of a scene (e.g., a CAD model of a chair inserted into a scene appears to be part of the scene itself and has orientation, size, shadowing, highlighting, etc., which look like other aspects of the scene). Rendering may include implementing any image processing technique, consistent with disclosed embodiments.

At step 720, 3D generator 120 may transmit a modified scene, consistent with disclosed embodiments. In some embodiments, 3D generator 120 transmits a modified scene to a user device (e.g., user device 150). In some embodiments, step 720 includes broadcasting a modified scene. Transmitting at step 720 may include transmitting over a network by any known method, consistent with disclosed embodiments.

At step 722, a device may display a modified scene, consistent with disclosed embodiments. In some embodiments, user device 150 or other device displays the modified scene, consistent with disclosed embodiments. In this way, the end user experiences a modified scene.

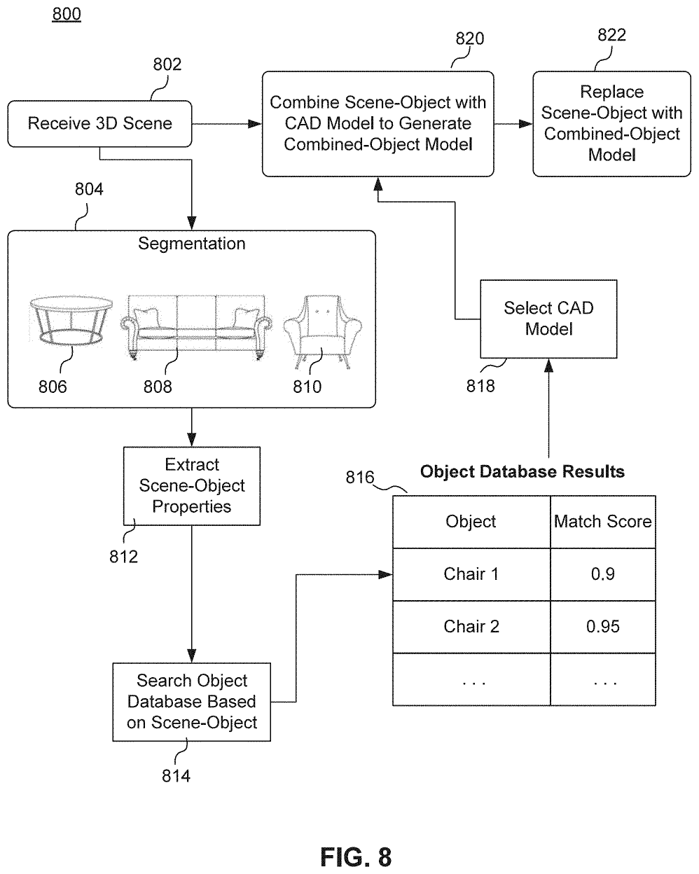

FIG. 8 depicts an exemplary method 800 of selecting a 3D model and replacing a CAD object an existing scene with the selected 3D model, consistent with embodiments of the present disclosure. The order and arrangement of steps in process 800 is provided for purposes of illustration. As will be appreciated from this disclosure, modifications may be made to process 800 by, for example, adding, combining, removing, and/or rearranging the steps for the process. Steps of method 800 may be performed by components of system 100, including, but not limited to, 3D generator 120. For example, although method 800 may be described as steps performed by 3D generator 120, it is to be understood that client device 110 and/or user device 150 may perform any or all steps of method 800. As one of skill in the art will appreciate, method 800 may be performed together with any other method described herein. In some embodiments, process 800 may be performed together with steps of process 700 and/or 900. Process 800 may be performed in real-time to alter an ongoing transmission of media content (e.g., a broadcast of a scene), consistent with disclosed embodiments.

At step 802, 3D generator system may receive a scene, consistent with disclosed embodiments. The scene may be a 2D or 3D scene. The scene may be incomplete (i.e., based on a scan that captures a partial representation of an object), consistent with disclosed embodiments. The scene may be received from a client device, a data structure, a memory, a user device, or any other computing component.

At step 804, 3D generator system may segment a scene, consistent with disclosed embodiments. As described herein, segmenting may include partitioning (i.e., classifying) image elements of a scene into scene-components or objects such as table 806, sofa 808, chair 810, and/or other components or objects. In some embodiments, step 804 may include generating a mesh, point cloud, or other representation of a scene. A scene-component may include a complete object (e.g., a cup), a part of an object (e.g., a handle of a cup), or a partial representation of an object (e.g., a cup as-viewed from one side).

At step 812, 3D generator system may extract scene-component properties, consistent with disclosed embodiments. For example, a scan may extract movement properties and/or material properties (i.e., texture characteristics) or any other properties, as previously described.

At step 814, 3D generator system may search an object data structure based on the scene-component, consistent with disclosed embodiments. Searching an object data structure may be based on segmented components. An object data structure may include 3D models, image data, CAD models, image object identifiers, and/or any other data related to components and/or objects.

At step 816, 3D generator system may receive object data structure results, consistent with disclosed embodiments. As previously described, object data structure results may include a match score or other similarity metric.

At step 818, 3D generator system may select a CAD model, consistent with disclosed embodiments. Selecting a CAD model may be based on input from a client. For example, step 818 may include displaying object data structure results and/or representations of data structure objects (e.g., CAD models) at an interface and receiving input from a client. In some embodiments, step 818 may include transmitting object data structure results and/or representations of data structure objects (e.g., CAD models) to a client device and receiving information from the client device. The 3D generator system may select a CAD model based on the received information. In some embodiments, selecting a CAD model is based on a similarity metric, a match score, or the like (e.g., selecting the highest match score).

At step 820, 3D generator system may combine a scene-component with a selected CAD model to generate a combined-object model, consistent with disclosed embodiments. In some embodiments, combining a scene-component with a selected CAD model may include merging aspects of the scene-component with aspects of the CAD model. For example, the combined-object model may include a texture of the scene-component as applied to the CAD model, or a texture of the CAD model as applied to the scene-component. As another example, the combined-object model may include a texture of the CAD model as-applied to the scene-component. In some embodiments, merging aspects of the scene-component may include adding a component of a CAD model to a scene-component or adding a component of a scene-component to a CAD model (e.g., adding an armrest to a chair). In some embodiments, combining a scene-component with a selected CAD model may include replacing the scene-component with the CAD model (i.e., the combined model is the CAD model). Step 820 may include implementing any image processing technique, consistent with disclosed embodiments.

At step 822, 3D generator system may replace a scene-component with the combined-object model, consistent with disclosed embodiments. Step 822 comprises generating a modified scene, including a hybrid scene, consistent with disclosed embodiments. Step 822 may include implementing any image processing technique, consistent with disclosed embodiments.

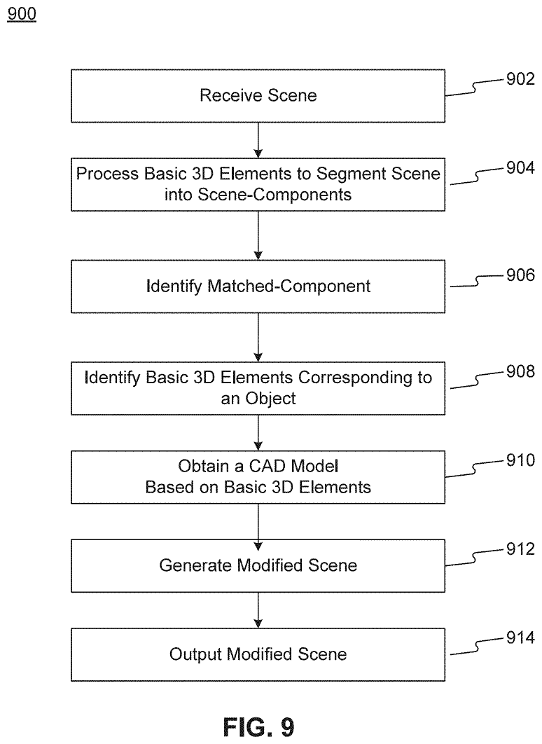

FIG. 9 depicts an exemplary method 900 of generating a 3D scene, consistent with embodiments of the present disclosure. The order and arrangement of steps in process 900 is provided for purposes of illustration. As will be appreciated from this disclosure, modifications may be made to process 900 by, for example, adding, combining, removing, and/or rearranging the steps for the process. Steps of method 900 may be performed by components of system 100, including, but not limited to, 3D generator 120. For example, although method 900 may be described as steps performed by 3D generator 120, it is to be understood that client device 110 and/or user device 150 may perform any or all steps of method 900. As one of skill in the art will appreciate, method 900 may be performed together with any other method described herein. In some embodiments, process 900 may be performed together with steps of process 700 and/or 800. Process 900 may be performed in real-time to alter an ongoing transmission of media content (e.g., a broadcast of a scene), consistent with disclosed embodiments.

At step 902, 3D generator may receive a scan of a scene, consistent with disclosed embodiments. A scan may include at least one object. As disclosed herein, a scan may be received from a memory, another computing component, etc. Receiving a scan may include receiving a mesh, a point cloud, or other representation of a scene.

At step 904, 3D generator may process image elements in the scan to segment the scene into scene-components, consistent with disclosed embodiments. As previously described, image elements may include at least one of a voxel, a point, a polygon, or other image element. Segmenting may include generating a mesh, a point cloud, or other representation of a scene.

At step 906, 3D generator may identify one or more matched-components, consistent with disclosed embodiments. A matched-component may correspond to at least one scene-component. A matched-component may include any component or object as described herein.

At step 908, 3D generator may identify image elements corresponding to an object, consistent with disclosed embodiments. As disclosed, identifying image elements may include classifying image elements. Identifying image elements may include searching an object data structure and generating or receiving object data structure results, consistent with disclosed embodiments.

At step 910, 3D generator may obtain a CAD model based on image elements corresponding to an object, consistent with disclosed embodiments. Obtaining a CAD model may include may searching an object data structure and generating or receiving object data structure results, consistent with disclosed embodiments. Obtaining a CAD model may be based on inputs from a client device, consistent with disclosed embodiments. Obtaining a CAD model may include selecting a CAD model based on a similarity metric, consistent with disclosed embodiments.

At step 912, 3D generator may generate a modified scene, consistent with disclosed embodiments. Generating a modified scene may include combining and/or replacing a scene-component with a CAD model.

At step 914, 3D generator may output a modified scene, consistent with disclosed embodiments. Outputting a modified scene may include transmitting and/or storing a modified scene, consistent with disclosed embodiments. Step 914 may include transmitting a modified scene to a user device.

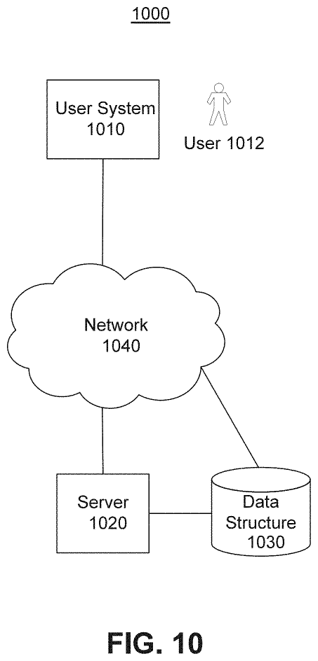

The present disclosure also relates to computer-implemented systems for animating portions of still images. In accordance with the present disclosure, the system for augmenting or reconstructing a 2D or 3D scene or image, may include several components that may interact and cooperate with each other. By way of example, FIG. 10 illustrates an exemplary system 1000 consistent with the present disclosure. As illustrated in FIG. 10, system 1000 may include, for example, user system 1010, user 1012, server 1020, data structure 1030, and network 1040. Components of system 1000 may be connected to each other via a network 1040. In some embodiments, aspects of system 1000 may be implemented on one or more cloud services. In some embodiments, aspects of system 1000 may be implemented on a computing device, including a mobile device, a computer, a server, a cluster of server, or a plurality of server clusters.

User system 1010 may include one or more computational devices that may be used by user 1012 for creating, augmenting, or reconstructing audiovisual content. By way of example, user system 1010 may include computational devices such as personal computers, laptop computers, desktop computers, tablet computers, notebooks, mobile phones, a terminal, a kiosk, a specialized device configured to perform methods according to disclosed embodiments etc. User system 1010 may be configured to execute an application or a set of instructions to generate, augment, or reconstruct audiovisual content, for example, a 2D or 3D scene or an image. User system 1010 may be configured to be operated by one or more users 1012.

Server 1020 may include one or more computational devices that may be used to generate, augment, or reconstruct audiovisual content. By way of example, server 1020 may be a general-purpose computer, a mainframe computer, or any combination of these components. In certain embodiments, server 1020 may be standalone, or it may be part of a subsystem, which may be part of a larger system. For example, server 1020 may represent distributed servers that are remotely located and communicate over a network (e.g., network 1040) or over a dedicated network, such as a local area network (LAN). In addition, consistent with the disclosed embodiments, server 1020 may be implemented as a server, a server system comprising a plurality of servers, or a server farm comprising a load balancing system and a plurality of servers.

Server 1020 may also be configured to interact with data structure 1030 to store and/or retrieve 3D model content data in/from data structure 1030. Server 1020 may communicate with data structure 1030 directly or via network 1040. User system 1010 and/or server 1020 may be implemented using computational device 200 as discussed above with respect to FIG. 2. Consistent with the embodiments of the present disclosure, data structure 1030 may have characteristics similar to those of data structures described above.

Network 1040 may facilitate electronic communication and exchange of data and/or information between user system 1010, server 1020, and/or data structure 1030. Network 140 may include any combination of communication networks. For example, network 1040 may include the Internet and/or another type of wide area network, an intranet, a metropolitan area network, a local area network, a wireless network, a cellular communications network, etc. Although only one user system 1010, one server 1020, and one data structure 1030 are illustrated in FIG. 10, it is contemplated that content preview system 100 may include any number of user systems 1010, servers 1020, and/or data structure 1030.

In accordance with the present disclosure, a computer-implemented system for animating portions of a still image is disclosed. The system of the present disclosure may be used in an automated process for achieving photogrammetry, by adding animation to still images including frames capture from video. The system may be used to provide movable features to any type of still image, and to provide perceived articulation, movement or motion to all or a portion of the still image. For example, in images that includes trees, bodies of water, or human heads, leaves, waves, and hair may be rendered movable while other portions of the images remain motionless.

The disclosed system may be a computer-implemented system including one or more computing devices, such as a mobile device, a computer, a server, a cluster of servers, a plurality of server clusters, a personal computer, a smart device, a tablet, a personal computer, a terminal, a kiosk, a cloud service, a storage device, a specialized device configured to perform methods according to disclosed embodiments, or the like. While the present disclosure provides examples of systems, devices and methods, it should be noted that these disclosures are exemplary only and are not intended to be restrictive of the language of the claims.

The disclosed system and process may allow for the partial or complete animation of still images. A still image may include static 2D or 3D images, frame shots of moving images, portions of video, or any image that may be rendered motionless by data capture. A still image may be provided in any format, including .JPG, .BMP, .GIF, .PNG, .SVG, a 3D vector format, a Computer-Aided Design file, or any other still image, or model format. A still image may include a 3D mesh representation or a 3D point cloud representation. In some embodiments, an image may be referred to as a scene. In a 2D nature scene, a tree may be an example of a still image. A 3D mesh representing a fan may be a still image. A 3D point cloud representation of an object may be a still image. While the present disclosure provides examples of a few file formats, it should be noted that aspects of the disclosure in their broadest sense are not limited to the particular disclosed file formats. Any format in which an image or a portion of an image is rendered completely or partially motionless may underly a still image in accordance with this disclosure.

In some embodiments, the system for animating still images may include at least one processor. Exemplary descriptions of a processor and memory are described above, and also with reference to FIG. 2.

In some embodiments, the processor may be configured to receive a still image of an object. An object may be any real-world, imaginary or virtual element or feature, combination of elements or features, or portion of an element or feature which exists within an image. For example, in a still image of an apple, the apple, together with the stem and leaves may be considered an object; the apple and stem may be considered an object, and the leaves may be considered a second separate object; or the apple may be considered a first object, the stem may be considered a second object, and the leaves may be considered a third separate object. An object may include a group of points or polygons in a mesh based on a relationship between the points or polygons. While the present disclosure provides examples of an object, it should be noted that aspects of the disclosure in their broadest sense, are not limited to the disclosed examples.

In some embodiments, the processor may be configured to perform a look up to identify at least one image of a similar object stored in memory. A similar object may have at least a partial similar appearance, characteristic, trait, shape or feature. A similar object may be based on a similarity metric, based, for example, on shape data, color data, and/or any other object-characterizing data. A similarity metric may be based, for example, on a statistical similarity such as a covariance, a least-squares distance, a distance between vectors associated with image elements (e.g., feature vectors), or a Hausdorff distance between aligned objects. A similarity metric may also be based on a feature vector. In some embodiments, a model such as a machine learning model may generate a similarity metric. In some embodiments, comparing may include implementing a classification model (e.g., a random forest model) to classify components of an object. Identifying an object corresponding to the at least one object may be based on a similarity metric. For example, if an object is a chair, the system may determine that an object in the memory is similar to the chair based on a similarity metric between the chair in the scene and image data in a data structure including 3D models of a plurality of objects. Exemplary data structures, consistent with the embodiments of this disclosure, are described above. Performing a lookup may include searching a memory, data structure, or other data retrieval system. Searching a data structure for similar objects may, for example, involve performing a lookup. Performing a lookup may be performed locally or remotely over a network. While the present disclosure provides examples of a method of performing a lookup, it should be noted that aspects of the disclosure in their broadest sense, are not limited to the disclosed examples.

In some embodiments, the memory may include segmentation data. Segmentation data includes related data that is divided into groups for different treatment. For example, segmentation data associated with a similar object may differentiate a movable portion of the object from an immovable portion of the object. An immovable portion of an object may remain in a fixed or static position or location, and may include no perceived motion, while the movable portion allows for motion or perceived motion relative to the immovable portion. Segmentation data may be associated with all or a portion of an object or similar object. A movable portion may be any portion, part or all, of an object which is capable of movement, motion, translation, rotation, including a change in speed, velocity, acceleration, or including any type of change in position. This may be actual movement or motion, or merely the perception of movement or motion. An immovable portion may be any portion, part or all, of an object which remains substantially motionless, static, or fails to change position, speed, velocity, acceleration or include any change in position. This may include a perceived immobility.

By way of example, an image of a person's head may include a movable portion (e.g. hair movable due to wind) and an immovable portion (e.g. other portions of the head different from the hair). As an example, an image of a tree may include movable portions (e.g. leaves that may move due to wind) and an immovable portion (e.g. bark of the tree). Segmentation data may include identification of one or more image elements (e.g. mesh points, polygons, pixels, voxels, etc.) that may be associated with a movable portion as opposed to an immovable portion. Segmentation data may include labels or flags that may indicate that a particular basic image element (e.g. mesh points, polygons, pixels, voxels, etc.) belongs to a movable or an immovable portion. In some embodiments segmentation data may identify (label or flag) basic image elements that define a boundary between a movable portion and an immovable portion of an image. While the present disclosure provides examples of segmentation data, it should be noted that aspects of the disclosure in their broadest sense, are not limited to the disclosed examples.

In some embodiments, the memory may include movement data associated with a movable portion. Movement data may include any data related to the motion or perceived motion of an object. For example, movement data may include any data associated with a freedom of motion of an object, or freedom of motion of a component or portion of an object. Movement data may include data related to rotational motion about one or more axes, translational motion about one or more axes or along a line or plane, random motion, any change of direction or perceived change of direction for an object, velocity data, speed data, or acceleration data. Movement data may be associated with an entire object, or only a portion of an object. For example, movement data related to a chair may include data related to swiveling about a first axis, reclining along a second axis, adjusting height of the seat, adjusting the height of an arm rest, or other motion parameters.

Movement data may also be based on physical laws. For example, a mechanical model of the leaves of a tree may describe their response to wind. When a specific wind model (e.g. including a direction, velocity, etc.) is applied to a scene, a simulation may be performed to compute the location of the leaves at multiple points in time. Here the movable portion may include the leaves, starting from the stem that connects them to the base.

The movement data may include a parametrization of the possible movement modes. For example, for a door versus its hinges, there may be a rotation operator that acts on the door, encoded by a single angle, where the angle may vary from zero (door closed) to 90 degrees (door open all the way to the near wall). Movement data may include a script that defines the location of the object as a function of time, for example the minutes or seconds arrow of a manual clock, or a script that defines the response of the object to an external force, for example the movement of a swivel chair when pushed from a certain point with a certain force. Such scripts may be configurable by a designer, user or client of the system. In some aspects, the scripts may define the direction, speed, acceleration, rotation, etc. of one or more basic image elements associated with a movable portion relative to one or more basic image elements of an immovable portion, or relative to a predetermined frame of reference. For example, the system may allow for a change in direction, speed, or degree of freedom of an object or portions of an object during an animation by a designer, user or client. The script may be written in any code capable of animating an object (e.g. AUTOCAD, BLENDER, CINEMA 4D, and/or AUTODESK MAYA). While the present disclosure provides examples of movement data, it should be noted that aspects of the disclosure in their broadest sense, are not limited to the disclosed examples.

In some embodiments, the processor may be configured to perform an analysis of image elements in a received still image of an object to segment the still image into discrete components. Consistent with embodiments of this disclosure, segmenting may additionally or alternatively be performed using techniques for segmenting discussed above. For example, the system may segment an image of a room into discrete components such as a chair, a doorknob, a handle, a cup, a utensil, a shoe, a wall, a leaf of a plant, a carpet, a television, a fan, etc. The system may segment image elements as belonging to a discrete component and classify the component with a known classification or an unknown classification. For example, during segmenting, a discrete component may be labeled as a specific type of object (e.g., a chair), as an unknown type of object, and/or as a possible known object (e.g., a “likely” chair) based on some measure of confidence or likelihood associated with a segmenting algorithm output.

Examples of segmentation data differentiating in the stored image of the similar object a movable portion from an immovable portion are: a 3D-model of a tree, partitioned to an immobile trunk and mobile leaves, along with a physical model on how the tree leaves react to wind; and a 2D image of a human head, partitioned into difference face parts such as mouth, eyes, hear, together with animation of eyelids opening and closing, and an animation of the hair reacting to wind. While the present disclosure provides examples of methods of segmenting an image, it should be noted that aspects of the disclosure in their broadest sense, are not limited to the disclosed examples.

In some embodiments, the processor may be configured to compare discrete components with a movable portion of a similar object, to identify in the received image at least one still rendering of a movable discrete component, different from immovable components of the still image. Comparing discrete components with a movable portion of a similar object may include any method that permits discrete components to be compared, including, for example, one or more of the techniques for comparing objects and/or image data discussed above. Such comparison may involve by way of example only, statistical analysis of similarities or artificial intelligence based approaches that identify similarities. In one example, comparing may involve determining a similarity metric indicating a degree of similarity between the discrete component and a corresponding discrete component of a stored image. For example, the disclosed system may generate or retrieve a feature vector corresponding to the discrete component and compare the feature vector to a feature vector associated with a corresponding discrete component of a stored image or with a feature vector corresponding to the entire stored image. The disclosed system may determine similarity between the discrete component of a still image and a discrete component of a stored image based on a similarity metric. The similarity metric may be based on a statistical similarity such as a covariance, a least-squares distance, or a Hausdorff distance between the discrete component of the still image and a discrete component of a stored image.

Comparing components may include searching a data structure of objects based on a discrete component identified in the still image and generating one or more search results (i.e., matches) of objects in the data structure that may include a. similar discrete component. In some aspects, a search result may include a percent match, a likelihood, or another metric representing a degree of similarity between the discrete component of the still image and a discrete component of a stored image in a data structure. In some embodiments, the system may identify a similar object based on a previously-conducted search of a data structure. While the present disclosure provides examples of methods of comparing the discrete components, it should be noted that aspects of the disclosure in their broadest sense, are not limited to the disclosed examples.

In some embodiments, the processor may be configured to extract the still rendering of the movable discrete component from the still image. As used herein, extracting a still rending of the movable discrete image can involve extracting the movable from the still, or extracting the still from the movable. Once a portion of an image is identified as movable, any known mechanism may be used to perform such extraction. For example, the processor may extract or segregate image elements (e.g. mesh points, polygons, pixels, voxels, etc.) in the still image associated with the discrete component that has been determined to be movable. Extracting may include storing the basic image elements associated with the discrete component in a separate storage location. Additionally, or alternatively, extracting may include labeling or identifying the basic image elements associated with the discrete component to distinguish them from basic image elements associated with other portions of the still image. While the present disclosure provides examples of methods of extracting the still rendering of the movable discrete component, it should be noted that aspects of the disclosure in their broadest sense, are not limited to the disclosed examples.

In some embodiments, the processor may be configured to construct using the still rendering and the movement data, a movable version of the still rendering of the movable component. The processor may construct a movable version of the still rendering using movement data. As discussed above, in some embodiments, the movement data may include scripts associated with a movable discrete component. The movement data may include scripts encoding certain dynamical movement or material properties, and/or a programmatic description of such movement and material properties. The processor may apply the scripts to the extracted basic image elements associated with a movable discrete component. For example, the processor may associate the scripts or programmatic descriptions of movement with one or more of the basic image elements associated with the still rendering of the movable discrete component, the programmatic description may specify changes in color, lighting, orientation, scaling, texture, and/or other material properties over time for the basic image elements (e.g. mesh points, polygons, pixels, voxels, etc.) associated with the movable discrete component that may give the appearance of movement when viewed by a user. While the present disclosure provides examples of methods of constructing a movable version of a discrete component, it should be noted that aspects of the disclosure in their broadest sense, are not limited to the disclosed examples.

In objects with a movable part, the processor may identify a connecting element between an immovable portion of the object and a movable portion. For example, in a fan, the processor may identify a cylindrical element (e.g. connecting rod) between the stationary portion of the fan and the movable portion of the fan. The connecting element may have a distinct shape, which, together with its position relative to the whole object, may enable the processor to identify it in the image of the fan stored in the data structure as well as in the still image. The connecting element may be matched between the scene fan and the database fan. Furthermore, using methods such as principal component analysis (PCA) the processor may align the connecting element from the image in the data structure with the connecting element in the still image.

In some embodiments, the processor may construct a hybrid image by combining the immovable components of the still image with the constructed movable version of the still rendering of the movable component to thereby enable the movable version of the movable discrete component to move in the hybrid image while the immovable components from the still image remain motionless. The disclosed system and process may rely on alignment of critical connecting elements in the still image. For example, a rotatable fan may include a connecting member (e.g. rod or tube) connecting the non-movable part of the fan to the rotatable part of the fan. During generation of the hybrid image, the disclosed system and process may help ensure that the critical connecting elements in the constructed movable version of the still rendering of the movable component may align as closely as possible with corresponding critical connecting elements in the still image. Such close alignment will help ensure that the inserted image of the movable component looks natural in the resulting hybrid image.

Consistent with disclosed embodiments, generating the hybrid image may include inserting the movable version of the still rendering of the movable component into the still image. Thus, for example, the processor may combine the basic image elements (including the associated movement data) associated with the movable version of the still rendering of the movable component with the basic image elements associated with the immovable portions of the still image. Generating the hybrid image may include positioning the movable version in the same orientation (i.e., aligning an object) and similar size (i.e., scaling an object) as the still rendering of the discrete component in the still image received by the processor. By way of example, an alignment of the movable version with the immovable portions of the still image may include an Affine transformation that transforms the (x, y, z) coordinates of the basic elements of the movable version of the image to T(x, y, z) which is the desired location of this element in the still image coordinates. In other embodiments, generating the hybrid image may include combining the movable version of the image with the immovable portions of the still image by taking the union of the two families of image elements.

In yet other embodiments, generating a hybrid image may include combining properties of image elements of the movable version and image elements of the immovable portions of the still image to obtain a fused element. For example, suppose the movable version of the discrete component and the still image include a family of polygons. Each polygon may be associated with a texture. A texture may be a 2D-mapping from an image to the polygon representing how this polygon appears to a viewer (different parts of the polygon may have different colors for example). The alignment T of the movable version and the immovable portions of the still image may be used to determine a matching of the corresponding polygon families. For example, a polygon from the movable version of the discrete component may be mapped to a polygon in the still image using the transformation T to locate the closest movable version polygon relative to a polygon in the still image. Using the matching, the system may match vertices of the polygons of the movable version image data and the still image. The disclosed system may also transfer a color, a texture, material properties, etc., from the polygon of the movable version image data to the polygon of the still image. In some embodiments, aligning an object and/or scaling an object may include using Principal Component Analysis (PCA).

Generating the hybrid image may also include using image processing techniques (e.g., adjusting brightness, adjusting lighting, implementing a gradient domain method, etc.), consistent with disclosed embodiments. As one of skill in the art will appreciate, a gradient domain method may include constructing the hybrid image by integrating the gradient of basic image elements of the movable version of the discrete component with the gradients of the image elements of the immovable portions of the still image. In the hybrid image, the movable version of the discrete component may move according to the associated movement data whereas the immovable portions of the still image included in the hybrid image may remain motionless. Additional or alternative techniques for combining two images (e.g. first image and second image) discussed above may also be used to construct a movable version of the still rendering of the movable component and/or generate the hybrid image, consistent with the embodiments of this disclosure.

In some embodiments, the processor may be configured to output the hybrid image. Outputting the hybrid image may include displaying the image, storing and/or transmitting the image, consistent with disclosed embodiments. Transmitting may include transmitting over a network by any known method, consistent with disclosed embodiments. For example, the system may broadcast a hybrid image (i.e., transmit to a plurality of user devices via a network), transmit a hybrid image to a user device, and/or store a hybrid image in memory.

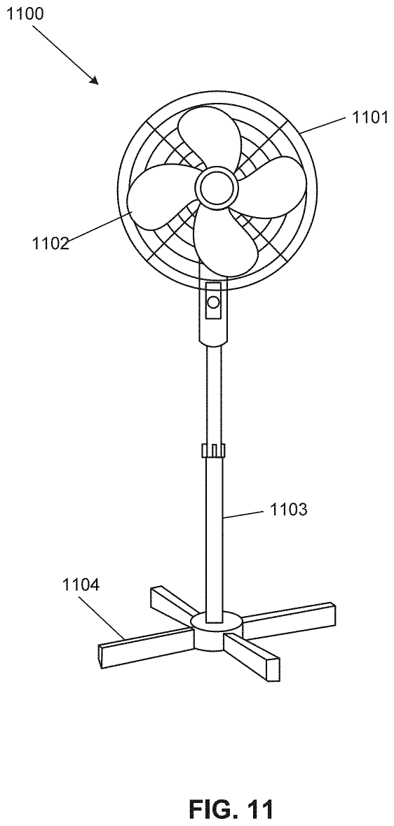

FIG. 11 illustrates an exemplary object (e.g., fan 1100) in an input 3D scene being viewed by a user, consistent with embodiments of the present disclosure. The fan may include four legs 1104, a pole 1103, the head of the fan which includes movable fan element 1102, enclosed in a safety cage 1101. The disclosed system may be configured to segment the image of fan 300 into discrete components such as four legs 1104, pole 1103, fan element 1102, and safety cage 1101.

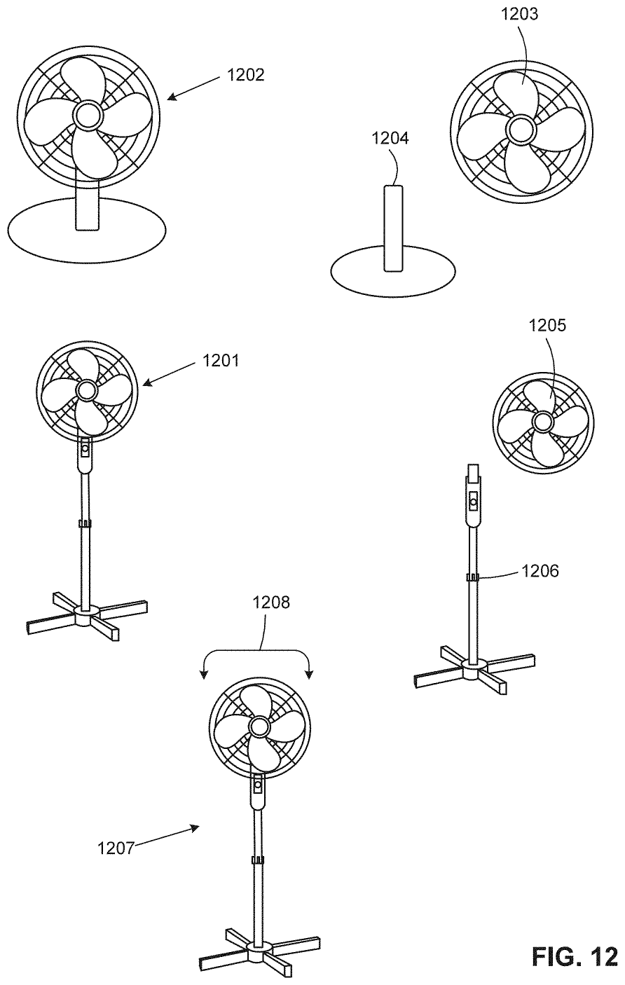

FIG. 12 illustrates examples of fans 1201 and 1202 in data structure 1030. Fans 1201 and 1202 may include discrete components 1203, 1205, respectively, which may be movable and discrete components 1204, 1206, respectively, which may be immovable. The disclosed system may compare discrete component 1102 of fan 1100 with images stored in the data structure. The disclosed system may identify one or more fans (e.g. 1201, 1202) in the data structure, having a movable discrete component 1203, 1205 similar to discrete component 1102. For example, the disclosed system may compare each segmented part 1101, 1102, 1103, 1104 with the segmented parts 1203, 1204 of the fan 1202 or other fans identified in the data structure. The system may identify a matching of each input-fan component 1101, 1102, 1103, 1104 to the fan components stored in the data structure (e.g., legs to legs, pole to pole and so on).

In the data structure, each fan segment may be described as mobile or immobile, and the modes of motion of the mobile elements may also be described. Thus, for example, in the fan 1202 illustrated in FIG. 12, leg 1204 may be immobile whereas discrete fan component 1203 may be mobile. As discussed above, the disclosed system may extract from the image of fan 1100 (FIG. 11), the still rendering of discrete fan component 1102. The disclosed system may combine the extracted still rendering of fan component 1102 with movement data (e.g. scripts) associated with matching discrete component 1203 of fan 1202 stored in the data structure or matching discrete component 1205 of fan 1201 stored in the data structure to create a movable version of the still rendering of fan component 1101. As discussed above, the disclosed system may generate a hybrid image by combining the movable version of the still rendering of fan component 1101 (including movement data of fan component 1203 or 1205) with the still rendering of the immovable portions (e.g. 1103, 1104) of fan 1100. The resulting hybrid image of fan 1100 would show fan component 1101 as movable according to the movement data of fan component 1203 or 1205, whereas other components 1103, 1104 may remain immovable.

The comparison of each segment in the segmented input fan/tree to each of the mobile segments in the pre-segmented data structure fan/tree may be an example of a way to compare the discrete components with the movable portion, where the discrete components are the segmentation of the input fan to parts, and the comparison may include checking for 2D or 3D object similarity. The system may determine that the image includes an input fan and may further determine that an “upper part” of the fan (e.g., the fan cage, blade control unit) may be a unified segment. The system may identify a similar unified segment in a fan stored in the data structure. The system may also determine from the data structure that the identified unified segment is mobile. The extraction of the upper part of the input fan, along with determining that it is mobile may be an example of a still rendering of the movable discrete component from the still image.

In some embodiments, the system may determine that the upper part of the input fan/leaves of tree are mobile. The system may determine the modes of motion. In some exemplary embodiments, the system may determine additional information, for example, a point-to-point matching between the upper part of the input fan with the upper part of the data structure fan (similarly for trees). The system may import the modes of motion from the data structure upper-part to the input upper-part, simply by combining the modes of motion of the data structure fan with the point-to-point matching on the input-fan. The input-fan upper part is now mobile, with a known mode of motion. This may be an example of constructing, using the still rendering and the movement data, a movable version of the still rendering of the movable component.

In some embodiments, the system may not be able to determine a point-to-point matching of the input upper-fan and the data structure upper-fan. The system may, however, replace the input upper-fan with the data structure upper-fan, by splicing the existing upper-fan out of the scene and inserting in the same location and orientation the data structure upper-fan using, for example, the exemplary methods of generating a hybrid image discussed above. The system may replace the input upper-fan with the data structure upper-fan. This case of splicing and insertion may be an example of constructing a hybrid image by combining the immovable components of the still image with the constructed movable version of the still rendering of the movable component.

In both cases above, the resulting object may be partially-animated by applying the motion script on the upper fan, keeping the lower-fan fixed (where the script is either the imported one or the original one in the case of splicing). This is an example of enabling the movable version of the movable discrete component to move in the hybrid image while the immovable components from the still image remain motionless.

In some embodiments, the still image may include a head of a person, the discrete components may include a head and hair of the person, and the at least one processor may be configured to cause in the hybrid image the head to remain motionless and the hair to move. For example, the processor may receive a still image of the head or face of a person. The processor may segment the still image into discrete components representing, for example, hair portion and a remaining immovable portion of the head. The processor may compare the discrete components (e.g. hair and immovable head portion) with objects in a data structure. The processor may identify several images of a head in which the hair may be moving (e.g. due to wind). The processor may identify a best match between the received still image and an image in the data structure. The processor may extract portions of the received still image associated with the hair and apply movement data (e.g. scripts or other programmatic description) to the extracted portion to create a rendering of a movable hair portion. The processor may combine the rendering of the movable hair portion with the immovable head portion in the received still image to create a hybrid image. In the hybrid image the hair portion may exhibit movement according to the movement data retrieved from the data structure.

In some embodiments, the still image may include a body of water, the discrete components may include waves and a shore, and the at least one processor may be configured to cause in the hybrid image the shore to remain motionless and the waves to move. For example, the processor may receive a still image of an ocean, lake, sea, or other body of water. The processor may segment the still image into discrete components representing, for example, waves and an immovable portion of a shore. The processor may compare the discrete components (e.g. waves and immovable shore) with objects in a data structure. The processor may identify several images of a body of water in which waves may be moving. The processor may identify a best match between the received still image and an image in the data structure. The processor may extract portions of the received still image associated with the waves and apply movement data (e.g. scripts or other programmatic description) to the extracted portion to create a rendering of movable waves. The processor may combine the rendering of the movable waves with the immovable shore portion in the received still image to create a hybrid image. In the hybrid image the waves may exhibit movement according to the movement data retrieved from the data structure. In this example, a critical connecting component may include the ocean floor (or an abstract floor that may be deep enough that water below that level does not affect the animation). The disclosed system may simulate the movement of each image element in the object in the data structure corresponding to the waves and apply it to corresponding image elements of the still image.

In some embodiments, the still image may include a tree, the discrete components may include a trunk and leaves, and the at least one processor may be configured to cause in the hybrid image the trunk to remain motionless and the leaves to move. For example, the processor may receive a still image of the tree. The processor may segment the still image into discrete components representing, for example, leaves and a remaining immovable trunk portion. The processor may compare the discrete components (e.g. leaves and immovable trunk portion) with objects in a data structure. The processor may identify several images of a tree in which the leaves may be moving (e.g. due to wind). The processor may identify a best match between the received still image and an image in the data structure. The processor may extract portions of the received still image associated with the leaves and apply movement data (e.g. scripts or other programmatic description) to the extracted portion to create a rendering of movable leaves. The processor may combine the rendering of the movable leaves with the immovable trunk portion in the received still image to create a hybrid image. In the hybrid image the leaves may exhibit movement according to the movement data retrieved from the data structure. In another embodiment, a scene being viewed by a user may be 2-dimensional, and may contain, for example, a landscape nature image containing a tree. The disclosed system may recognize the tree inside the scene as a separate object. The system may segment it into its trunk, branches and leaves (for example by color). The system may search for images of similar trees in a data structure. The system may be able to match the leaves of the input tree with the leaves-segments of an image of a tree from the data structure (referred to as data structure-tree below). The system may determine that the data structure-tree includes an animation of leaves. The system may import this animation to the leaves of the input tree, thus creating a new, “live” tree from the still tree.

In some embodiments, the still image may include a person, the discrete components may include a body of the person and an article of clothing, and the at least one processor may be configured to cause in the hybrid image the body to remain motionless and the article of clothing move. For example, the processor may receive a still image of a person. The processor may segment the still image into discrete components representing, for example, an article of clothing and a remaining immovable body of the person. The processor may compare the discrete components (e.g. article of clothing immovable body portion) with objects in a data structure. The processor may identify several images of body in which an article of clothing may be moving (e.g. due to wind or motion of a person). The processor may identify a best match between the received still image and an image in the data structure. The processor may extract portions of the received still image associated with the article of clothing and apply movement data (e.g. scripts or other programmatic description) to the extracted portion to create a rendering of a movable article of clothing. The processor may combine the rendering of the movable article of clothing with the immovable body portion in the received still image to create a hybrid image. In the hybrid image the article of clothing may exhibit movement according to the movement data retrieved from the data structure. An article of clothing may be a head covering, a shirt, a jacket, a scarf, pants, jeans, a dress, a skirt or any other article of clothing.

In some embodiments, the still image may include a timepiece, the discrete components may include a face of the timepiece and hands, and the at least one processor may be configured to cause in the hybrid image the timepiece to display a different time. For example, the processor may receive a still image of a timepiece. The processor may segment the still image into discrete components representing, for example, the hands and a remaining immovable face portion. The processor may compare the discrete components (e.g. hands and immovable face portion) with objects in a data structure. The processor may identify several images of a timepiece in which the leaves may be moving. The processor may identify a best match between the received still image and an image in the data structure. The processor may extract portions of the received still image associated with the hands and apply movement data (e.g. scripts or other programmatic description) to the extracted portion to create a rendering of movable hands. The processor may combine the rendering of the movable hands with the immovable face portion in the received still image to create a hybrid image. In the hybrid image the hands may exhibit movement according to the movement data retrieved from the data structure, and display a different time. In this example, a critical connecting component may be a point in the center of the hands around which they rotate. The coordinate system may include this center point together with a vector perpendicular to the plane of the timepiece going through this center point. The movability elements may include Affine transformations associated with rotations around this perpendicular vector. The disclosed system may match the timepiece planes and the centers to transfer the transformation from the timepiece image in the data structure to the still image of the timepiece.

In some embodiments, the still image may include a pet, the discrete components may include a body and fur, and the at least one processor may be configured to cause in the hybrid image the body to remain motionless and the fur to move. For example, the processor may receive a still image of a pet. A pet may include a dog, a cat, a horse, a mouse, or any other pet. The processor may segment the still image into discrete components representing, for example, the fur and an immovable body portion. The processor may compare the discrete components (e.g. fur an immovable body portion) with objects in a data structure. The processor may identify several images of a pet in which the fur may be moving. The processor may identify a best match between the received still image and an image in the data structure. The processor may extract portions of the received still image associated with the fur and apply movement data (e.g. scripts or other programmatic description) to the extracted portion to create a rendering of movable fur. The processor may combine the rendering of the movable fur with the immovable body portion in the received still image to create a hybrid image. In the hybrid image the fur may exhibit movement according to the movement data retrieved from the data structure.

In some embodiments, the still image may include an animal, the discrete components may include a body and a tail, and the at least one processor may be configured to cause in the hybrid image the body to remain motionless and the tail to move. For example, the processor may receive a still image of an animal. The animal may be a cat, a dog, a mouse, a horse, or any other animal. The processor may segment the still image into discrete components representing, for example, the tail and an immovable body portion. The processor may compare the discrete components (e.g. tail and immovable body portion) with objects in a data structure. The processor may identify several images of an animal in which a tail may be moving. The processor may identify a best match between the received still image and an image in the data structure. The processor may extract portions of the received still image associated with the tail and apply movement data (e.g. scripts or other programmatic description) to the extracted portion to create a rendering of a movable tail. The processor may combine the rendering of the movable tail with the immovable body portion in the received still image to create a hybrid image. In the hybrid image the tail may exhibit movement according to the movement data retrieved from the data structure.

In another embodiment, the system may allow a user to select an object, parse the object into discrete components directed by the user, and configure movement data for each discrete component. Such user defined discrete components would allow a user to separate an image into any combination of immovable and movable discrete components. The system may include features to allow a user to customize movement data in order to create a desired scene or image. A user may take the still image of an analog clock, parse the face of the clock into one discrete component, parse the hour hand of the clock into a second discrete component, and parse the minute hand of the clock into a third discrete component. The user may then customize the movement data by configuring the movement data for each discrete component. Such customization may include specifying an axis of rotation, a path of translation, a direction of rotation or translation, speed, velocity, acceleration of the component, or any parameter associated with motion or perceived motion. This may allow the user to animate the clock to have a face rotating in a first direction at a desired velocity, a minute hand rotating in a second direction at a desired velocity, and an hour hand rotating in a desired direction at a third velocity.

In some embodiments, the system may allow a user to select whether to animate objects. The system may allow a user to adjust features associated with the movement data. For instance, the system may prompt the user to select or adjust a desired rotational speed, direction, range, or other parameter associated with motion or perceived motion of a discrete component. For instance, in the example above of a fan including a movable fan element 302 and a movable cage 301, the system may prompt a user to select or adjust the direction of the fan element 302 and the speed of oscillation 408 of the movable cage 301. It is noted that the system may prompt a user to select or adjust more than two features associated with movement data. The disclosed system may render a new, 3D animation 407 with a fan rotating in the selected rotation modes based on the user selection.

In another embodiment, the system may allow a user to select an object in the image from a plurality of objects. In some embodiments, the processor may be configured to detect a plurality of objects in a scene or image, and prompt the user for a selection of which objects to animate. The system may search for object images in a data structure based on selection by a user. The object images in the data structure may be similar to or substantially different from the user selected object. A user may select at least one desired object in the data structure. The data structure includes segmentation data related to movable portions of the selected object and immovable portions of the selected object. The system may allow a user to select a desired image, and create a hybrid image based on the selection made by the user. For example, a user may select in a still image, a shark. The system may allow the user to look up images of objects in the data structure, where the user selects a clown. Segmentation data related to the clown may include movable arms and head. The system may create a hybrid image of an animated clown-shark, the body of the shark remaining still while the head and arms move. The system may further allow the user to customize which portions of the objects move in the hybrid image, and to define variables related to the movement.

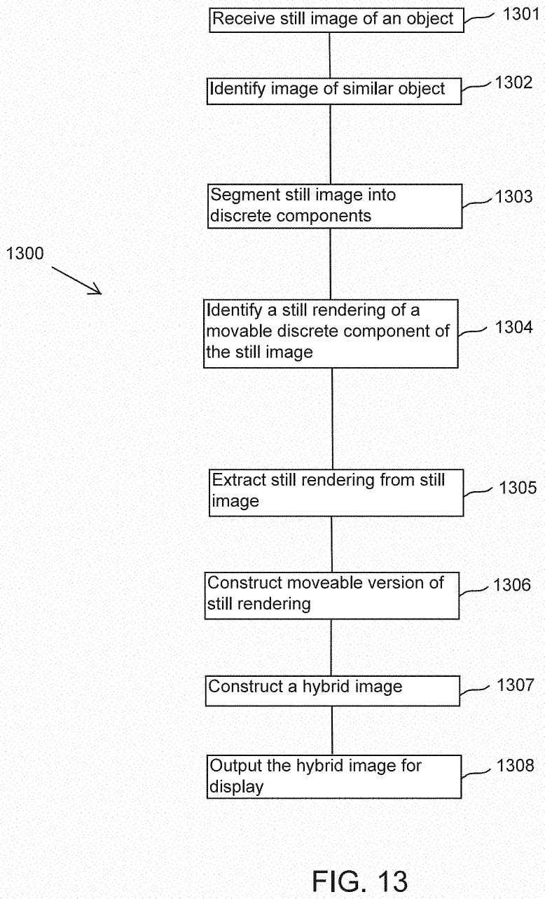

FIG. 13 illustrates an exemplary method 1300 of animating portions of a still image consistent with embodiments of the present disclosure. Steps of method 1300 may be performed by the components of system 1000 (e.g. user system 1010 or sever 1020), consistent with the methods described above. At step 1301, the system 1000 may receive a still image of an object. At step 1302, the system 1000 may perform a look up to identify at least one image of a similar object stored in memory. The memory may include segmentation data differentiating in the stored image of the similar object a movable portion from an immovable portion, and may include movement data associated with the movable portion. At step 1303, system 1000 may perform an analysis of voxels in the received still image of the object to segment the still image into discrete components. At step 1304, system 1000 may compare the discrete components with the movable portion of the at least one similar object, to identify in the received image at least one still rendering of a movable discrete component, different from immovable components of the still image. In step 1305, system 1000 may extract the still rendering of the movable discrete component from the still image. In step 1306, system 1000 may construct using the still rendering and the movement data, a movable version of the still rendering of the movable component. At step 1307, system 1000 may construct a hybrid image by combining the immovable components of the still image with the constructed movable version of the still rendering of the movable component to thereby enable the movable version of the movable discrete component to move in the hybrid image while the immovable components from the still image remain motionless. At step 1308, system 1000 may output the hybrid image.

The present disclosure also relates to computer-implemented systems for generating full 3D models of one or more objects based on partial images of the objects. In accordance with the present disclosure, a system for augmenting or reconstructing a 2D or 3D scene or image may include several components that may interact and cooperate with each other. By way of example, FIG. 10 illustrates an exemplary system 1000 consistent with the present disclosure. FIG. 2 illustrates an exemplary computational device 200 for implementing embodiments and features of present disclosure.

In accordance with the present disclosure, a computer-implemented system for simulating a complete 3D model of an object from incomplete 3D data is disclosed. The disclosed system may be a computer-implemented system including one or more computing device, such as a mobile device, a computer, a server, a cluster of servers, a plurality of server clusters, a personal computer, a smart device, a tablet, a terminal, a kiosk, a cloud service, a storage device, a specialized device configured to perform methods according to disclosed embodiments, or the like. The system of the present disclosure may be used in a process for simulating or creating a complete 3D model of an object from incomplete data, such as a partial image or scene. While the present disclosure provides examples of a system or device, it should be noted that aspects of the disclosure in their broadest sense, are not limited to the disclosed examples.

The disclosed embodiments include computer-implemented systems for processing images or scenes (e.g., 3D scenes based on scans) for use in virtual reality (VR), augmented reality (AR), and mixed reality (MR) technology and applications. In some embodiments, the system may include at least one processor. Exemplary descriptions of a processor and memory are described above, and also with reference to FIG. 2. By way of example, as illustrated in FIGS. 2 and 10, system 1000 may include one or more processors 202 included in one or more of user systems 1010 and servers 1020. As used in this disclosure, the term “processor” is used as a shorthand to refer to “at least one processor.” The processor may be configured to access a memory. Alternative and additional descriptions of a processor and memory are also described above, with reference to FIG. 2.

In some embodiments, the processor may be configured to receive a partial image of an object, wherein the partial image is at least one of a 2D image or an incomplete 3D image. For example, the processor may receive the partial image from an image sensor, a memory, a data structure, a lookup table, by an upload from a user, etc. Additionally, the processor may receive the partial image over any data communication channel and may utilize any data transfer protocol. The image may be acquired by any type of camera or imager, whether 2D or 3D. Non-exhaustive examples of 3D imagers include stereo cameras, range cameras, 3D scanners, laser rangefinders, lenticular devices, time of flight cameras, structured light cameras, and vectographic cameras. 2D images may be captured by a CCD array or other digital camera technology. As broadly used herein, images captured by any of the foregoing or other image capture devices may be considered a “scan.”

An object may be any real-world, imaginary or virtual element or feature, combination of elements or features, or portion of an element or feature which exists within an image. For example, in a still image of an apple, the apple, together with the stem and leaves may be an object, the apple and stem may be one object, while the leaves may be a second separate object, or the apple may be a first object, the stem may be a second object, and the leaves may be a third separate object.

A partial image may include only a portion of an object. A partial image may include any amount less than an entire image or scene of an object. A partial image, for example, may be the result of an incomplete picture or scan, loss of data through data transfer, noise in an image, an object being hidden by another object, or any other reason that prevents a complete image of an object from being captured. For example, an incomplete scan may capture a portion of an object, such as the front of a chair but not the back of the chair. A front-only scan of a chair is an example of incomplete 3D data. In some cases, an incomplete scan may result when a scan obtains less information than is necessary to represent a complete object in 3D. This partial scan of the chair is also an example of a partial image of the object. Other examples of processes that can lead to partial images of objects may include an object being scanned by a 3D scanner, but not scanned from all directions. Another example relates to an object occluded by other objects, or parts of the object occluded by other parts. In this example, a chair may be situated behind a table during the scan. In another example, a segmentation algorithm may not separate an object exactly, and some parts of the object may be missing, or there may be redundant parts. In another example, an object may be inaccurately scanned due to low scanner resolution or inadequate lighting conditions. An incomplete scan may arise when a scan does not obtain a property of a real object, such as color information or due to limitations with scan input methods or other errors (e.g., a partially transparent object may not appear in a scan). In some cases, an incomplete scan may arise when a scan misses a portion of scene data (e.g., holes in a scene or obscured portions of a scene) or other errors or distortions due to hardware limitations or user errors that occur during scanning. While the present disclosure provides examples of a partial image of an object, it should be noted that aspects of the disclosure in their broadest sense, are not limited to the disclosed examples.

A full or partial image of an object may be represented by a mesh, point cloud, or any other representation that encodes an image or scene. In an exemplary embodiment, an image or scene may include a 3D representation encoded as a mesh as discussed above. In some embodiments, a scene or image may include a plurality of preexisting image elements. In some embodiments, the system may generate image elements of an image based on a received scan, consistent with disclosed embodiments. More generally, an image or scene may include a plurality of image elements, such as image elements (2D or 3D). For example, image elements may include at least one of a pixel, a voxel, a point, a polygon, etc. In some embodiments, the system may generate a set of polygons, the individual polygons being image elements. As another example, if the system generates a point cloud, then individual points may be image elements. For example, the system may generate a mesh comprised of a plurality of n-sided polygons or voxels as image elements, and one or more polygons may be subdivided into additional polygons to improve resolution or for other reasons.

In some embodiments, the processor may use the partial image to search at least one data structure for additional information corresponding to the partial image. Exemplary data structures, consistent with the embodiments of this disclosure, are described above. The data structure may be a component of the disclosed system or a remote computing component (e.g., a cloud-based data structure). In some embodiments, the at least one data structure may include 3D objects and/or additional information corresponding to a plurality of 3D objects. Image data, including additional information and/or additional data, of the data structure may include 2D or 3D models of objects. A data structure consistent with the present disclosure may include one or more Computer Aided Design (CAD) models corresponding to one or more objects. A CAD model may be stored in one or more formats, such as a mesh, a point cloud, a voxel-mapping of a 3D space, and/or any other mapping that may be configured to present a graphical depiction of an object. A CAD model may represent an object and/or a component of an object (e.g., a chair and/or an armrest of a chair).

In some embodiments, additional information and/or additional data may include any information or data related to inherent, extrinsic or intrinsic features of an object, real or imaginary. For instance, the additional information or data may include information or data related to color, texture, shape, contour, material, flexibility properties, mass properties, orientation, physical characteristics, or any other feature. Additional information or data may be accumulated by the system over time as part of a repository of information, through a neural network or self-learning system, input into the system by a user, or by any other method allowing for the collection of data. In some embodiments, the additional information or data may be object specific, group specific, category specific, and may additionally be specified and defined by a user, Additional information or data may be linked in the data structure to specific images, scenes or models. In some embodiments, the additional information may include a 3D model that corresponds to a received partial image. In some embodiments, the additional information may include information derived from partial scans of at least one object similar to the object in a partial image. The additional information or data may be data based on a collection of partial images scans or images related to an object or a series of objects. While the present disclosure provides examples of additional information or additional data, it should be noted that aspects of the disclosure in their broadest sense, are not limited to the disclosed examples.

Information (e.g. CAD models, additional information, etc.) stored in the data structure may be associated with semantic tags or one or more spatial semantic graphs. For example, the spatial semantic graphs and semantic tags associated with a 3D model stored in the data structure may textually represent the stored information in words. For example, textual representations such as “table,” “shelf,” and “chair” may be each be a semantic tag associated with the corresponding table, shelf, and chair object models stored in the data structure. In some embodiments, semantic tags may include a classification of the 3D objects. As will be apparent to one of skill in the art, classes may be defined in a hierarchy of classes that are broader or narrower relative to each other. For example, a “furniture” class may be broader than a “chair” class, which may be broader than an “office chair” class. In other embodiments, semantic tags may represent an environment or 3D scene, such as “office,” “living room,” or “kitchen.”

The disclosed system may compare the semantic tags or spatial semantic graphs of the partial image with the semantic tags and/or spatial semantic graphs of the models, objects, and other information stored in the data structure. Consistent with embodiments of this disclosure, the disclosed system may additionally or alternatively compare the semantic tags or spatial semantic graphs using one or more of the techniques for comparing objects and/or images discussed above. In some embodiments, if required, the disclosed system may segment one or more models or objects stored in the data structure, before comparing the semantic tags or spatial semantic graphs. Consistent with embodiments of this disclosure, segmenting may additionally or alternatively be performed using techniques for segmenting discussed above. The system may identify one or more models and/or other pieces of additional information having the closest or most similar semantic tags or spatial semantic graphs relative to the partial image. The system may determine closeness or similarity based on a statistical similarity such as a covariance, a least-squares distance, a distance between vectors associated with image elements (e.g., feature vectors), a Hausdorff distance between aligned objects. In some embodiments, the system may determine the closeness or similarity based on a comparison of feature vectors associated with the partial image and the models, objects, or additional information stored in the data structure. In some embodiments, the system may identify a similar object based on a previously-conducted search of a data structure. While the present disclosure provides examples of methods for searching at least one data structure, it should be noted that aspects of the disclosure in their broadest sense, are not limited to the disclosed examples.

In some embodiments, one or more processors may be configured to determine that a data structure does not include a corresponding 3D model of an object. For example, the processor may determine that a measure of similarity, as discussed above, falls beneath a threshold, indicating that the partial image does not sufficiently match with the models and/or additional information stored in the data structure. By way of example, if the partial image represents an object (e.g. a glass), and the data structure includes models of furniture objects, the processor may determine that the data structure does not include a 3D model corresponding to the glass object.

In some embodiments, one or more processors may be configured to search the at least one data structure for a reference 3D model different from the object in the partial image but having similarities to the object in the partial image. The processor may perform a search by comparing the partial image with the models and information stored in the data structure using processes similar to those discussed above. The processor may determine that the data structure includes a 3D model different from the object but having similarities, when for example, the measure of similarity (e.g. between semantic tags, spatial semantic graphs, and/or feature vectors) exceeds a particular threshold. In some embodiments, a determination may involve tagging, labeling, identifying or otherwise classifying one or more elements of an image, scene or object to indicate the similarity.

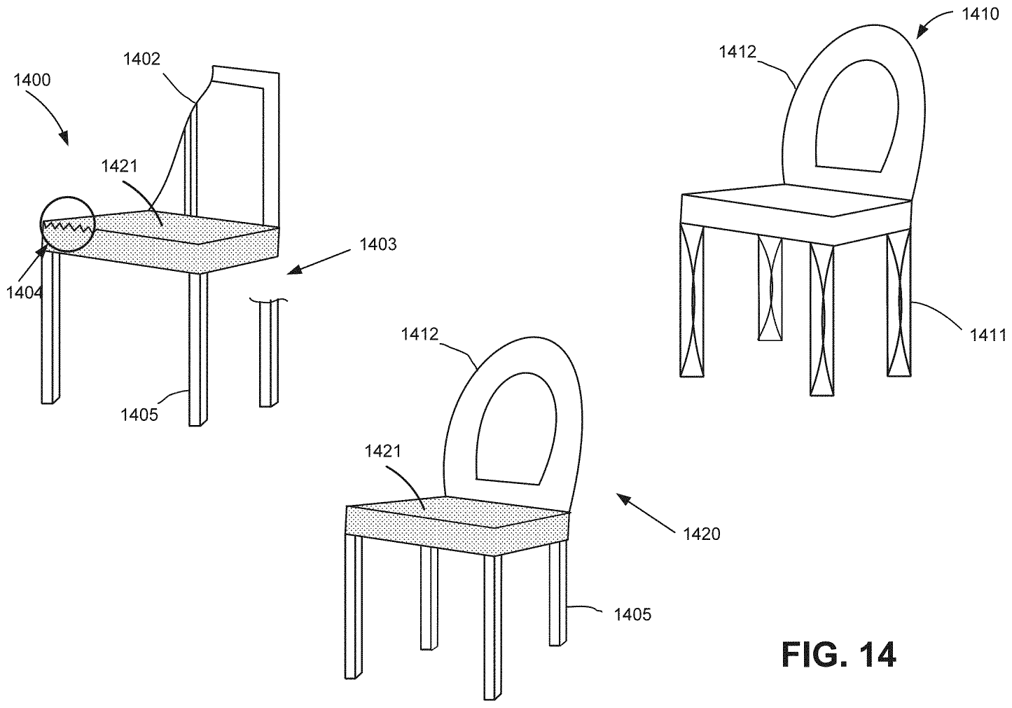

A 3D model stored in the data structure may be deemed similar based on at least one feature to the object in the partial image. In some embodiments, similarities may include any element or portion of an image or scene that has a likeness to another element or portion of an image or scene. Such a likeness may be determined based on one or more of size, shape, orientation, color, texture, pattern, position, or any other feature or characteristic associated with the partial image or a portion thereof. For example, similarities to the object in the partial image may include: CAD or other 3D object representations that may contain a part with similar 3-dimensional shape to the partial image, 3D object representations that may have similar textures to the textures appearing in the partial image, 3D object representations objects that may be of the same class as the partial image, e.g., chairs. As illustrated in FIG. 14, a reference model 1410 of a chair has been identified for chair 1400. Reference model 1410 is not identical to chair 1400, but has similar features such as seat, legs 1411 and back 1412. While the present disclosure provides examples of methods for identifying objects having similarities to the object in the partial image, it should be noted that aspects of the disclosure in their broadest sense, are not limited to the disclosed examples.

In some embodiments, the processor is configured to compare the partial image with a reference 3D model to determine portions of the reference 3D model that generally correspond to missing characteristics of the partial image. As previously discussed, missing characteristics may include data, features or portions missing due to lack of data transfer, poor quality scanning, noise, hidden objects, etc. As an example, the system discovers a reference 3D model in the data structure with similarities to the object in the partial image. To understand which parts of a reference 3D model correspond to missing data from the scan, for example, the disclosed system may look for portions of the 3D reference image that generally correspond to missing characteristics of the partial image. One way to do this may be to determine the best orientation and scale in which a part of the reference 3D model best matches the scanned object, and then consider all the parts of the 3D object representation with no direct match to parts in the scan as “missing” from the scan.

For example, the disclosed system may determine which object best matches the partial image and further determine which views of the data structure object match to views of the partial image. The disclosed system may use this determination to obtain a rough alignment of the partial image and the object from the data structure. The disclosed system may use various computing algorithms (e.g. Iterative Closest Point) to obtain a point-to-point matching between the two objects, noting that significant portions of the 3D object representation obtained from the data structure would not match the partial image. The disclosed system may also determine the transformation that must be applied to the 3D object representation of the object from the data structure such that, when inserted into the scanned scene, its location will align with the location of the existing partial image. Based on this mapping between the partial image and the 3D object representation obtained from the data store, the disclosed system may determine portions of the partial image that match with the 3D object representation. The disclosed system may additionally or alternatively employ techniques of aligning and scaling as discussed above in connection with combining two images.

The processor may perform the above operations by comparing the image elements (e.g. pixels, voxels, polygons, mesh points, etc.) of the partial image to the 3D model obtained from the data structure. Comparison of the image elements may include positioning the partial image and the 3D model in the same orientation (i.e., aligning an object) and similar size. By way of example, an alignment of the partial image and the 3D model from the data store may include an Affine transformation that transforms the (x, y, z) coordinates of the image elements of the partial image to T(x, y, z) which is the desired location of this element in the 3D model coordinates or vice-versa. After aligning and scaling, the processor may compare the image elements (e.g. pixels, voxels, polygons, mesh points, etc.) of the partial image and the 3D model to identify the image elements in the 3D model that may be missing (i.e. not present) in the partial image. The processor may label, flag, or tag these missing image elements as corresponding to the missing characteristics of the partial image.

For example, as illustrated in FIG. 14, a partial image 1400 of a chair is shown. Partial image 14110 is incomplete and is missing data 1403 associated with leg 1405, and with the back at 1402. Partial image 1400 is also missing data as a result of noise, or blurriness at 1404. Additionally, a fourth leg 1405 of the image is missing from the image.

In some embodiments, the processor may combine a partial image with additional information or additional data to construct a simulated full 3D model of an object. A simulated full 3D model of an object may include features of an object from the partial image and features from a reference 3D model. Although referred to as “full” the simulated full 3D image may still be somewhat incomplete in that it may or may not contain every detail of the object. Even so, it may still be considered “full” within the context of this disclosure because it is fuller than the partial image. Generating the simulated full 3D model may include replacing elements or features, blending elements or features, modifying elements or features, combining elements or features, or any manipulation that involves the merging of a partial image with a reference 3D model. Consistent with the present disclosure, constructing a full 3D model may include combining object data in the partial image with additional data associated with the 3D model of an object stored in the data store. For example, the system may replace the partial image with another object or portion of another object. Such a modification may be done automatically or as directed by the user or client.

Replacing an object or a portion of an object may include positioning the selected object in the same orientation (i.e., aligning an object) and similar size as the original object (i.e., scaling an object). In some embodiments, aligning an object and/or scaling an object may include an Affine transformation as discussed above and/or Principal Component Analysis (PCA). Object replacement may include allowing a client to position, scale, or otherwise manipulate the selected object within the scene. Replacing an object may involve image processing techniques (e.g., adjusting brightness, adjusting lighting, implementing a gradient domain method, etc.), consistent with disclosed embodiments. As one of skill in the art will appreciate, a gradient domain method may include constructing the simulated full 3D model by integrating the gradient of image elements in the partial image with the gradient of image elements in the 3D model obtained, for example, from the data structure. Replacement may include rendering the mesh, points, or any other digitized representation of an object based on lighting, scene resolution, a perspective, etc. Following replacement of an object, the resulting scene may be an example of a modified scene by combining information obtained from a 3d model of an object obtained from the data store and the original partial image.

In some embodiments, generating the simulated full 3D model may include combining the partial image with the 3D model retrieved, for example, from the data structure by taking the union of the two families of image elements. In yet other embodiments, generating a hybrid image may include combining properties of image elements of the partial image and image elements of the 3D model obtained, for example, from the data store to obtain a fused element. For example, suppose the partial image and the data store 3D model each include a family of polygons. Each polygon may be associated with a texture. A texture may be a 2D-mapping from an image to the polygon representing how this polygon appears to a viewer (different parts of the polygon may have different colors for example). The alignment T (e.g. using Affine transformation) of the partial image and the data store 3D model may be used to determine a matching of the corresponding polygon families. For example, a polygon from the partial image may be mapped to a polygon in the data store 3D model using the transformation T to locate the closest polygon in the partial image relative to a polygon in the 3D model. Using the matching, the system may match vertices of the polygons of the partial image and the 3D model. The disclosed system may also transfer a color, a texture, material properties, etc., from the polygon of the 3D model to the polygon of the partial image or vice versa.

In some embodiments, the combining may include meshing a partial image with determined portions of a 3D reference model. As discussed above, the processor may compare the image elements (e.g. pixels, voxels, polygons, mesh points, etc.) of the partial image and the 3D model obtained from, for example, the data structure (i.e. the 3D reference model) to identify the image elements in the 3D model that may be missing (i.e. not present) in the partial image. In some embodiments, the processor may transfer these image elements over to the partial image, for example, by copying the properties such as coordinates, position, orientation, color, lighting, texture, material properties, etc. from the 3D model to the partial image. Thus, the processor may complete the mesh in the partial image by copying the properties of corresponding image elements from the 3D model, thereby meshing the partial image with determined portions of the 3D reference model. Additional or alternative techniques for combining two images (e.g. first image and second image) discussed above may also be used to generate the simulated full 3D model of the object.

For example, as illustrated in FIG. 14, partial image 1400 is combined with additional information or additional data to construct a simulated full or complete 3D model 1420. The missing characteristics 1402, 1403 of the partial image 1400, have been replaced with additional information or additional information associated with reference 3D model 1410. In this example, the full 3D model 1420 includes a combination of features from both the partial image 1400 and the reference 3D model. The system identified that an entire leg 1405 and a portion of a leg 1403 were missing from the partial image 1400 by comparing legs 1405 of the partial image 1400 to legs 1411 of reference 3D model 1410. Although the legs have different appearances, the system is able to utilize the additional information from reference 3D model 1410 to create additional legs 1405 having characteristics found in the partial image 1400. As shown in the full 3D model 1420 the system utilized the additional data or additional information from the back 1412 of chair to create a back 1412 in the full 3D model 1420.

In some embodiments, the system may identify at least one of a texture and a color of a partial image and, during meshing, apply the at least one texture and color to determined portions of a 3D reference model. As discussed above, the partial image may be represented by image elements (e.g. pixels, mesh points, polygons, voxels, etc.). The disclosed system may determine properties of the partial image based on the properties associated with the image elements of the partial image. For example, the disclosed system may identify properties such as color, brightness, texture, material properties, etc. of the image elements of the partial image. As also discussed above, the system may copy over to the partial image, information associated with image elements of the data store 3D model found to be missing in the partial image. In some embodiments, the processor may apply the identified properties of the partial image to the image elements copied over from the data store 3D model to the partial image.

For example, as illustrated in FIG. 14, a color or texture 1421 from the partial image was reconstructed in the full 3D model 1420. In some embodiments, the system may perform the merging of a partial image 1400 with a reference 3D model 1410 automatically. However, in some embodiments, a user may select which objects in an image or partial image may be replaced by a reference 3D model also selected by a user. The user may additionally be able to choose and configure which specific portions of the image or model should be replaced, blended, or combined with another portion of the image or model. For instance, in FIG. 14, a user may select to replace all legs 1405 with the legs 1411, while maintaining original square back in the full 3D model 1420. In some embodiments, the user may also be able to select one or more of the properties (e.g. color, brightness, texture, material properties, etc.) that should be applied to the image elements (e.g. pixels, mesh points, polygons, voxels, etc.) copies over from the data store 3D model to the partial image.

In some embodiments, a processor may be configured to output the simulated full 3D model for display on a display device. In some embodiments, a full 3D model, image or scene may be configured for display via a device, such as a headset, a computer screen, a monitor, a projection, etc. In some embodiments, outputting may include exporting a simulated full 3D model into a format compatible with a 3D consumable environment. A 3D consumable environment consistent with embodiments of the present disclosure may include one or more of virtual reality (VR), augmented reality (AR), and mixed reality (MR), 3D still, video, or broadcast environments that are modeled after or simulate a physical environment. A 3D consumable environment may include at least one of a virtual reality environment and an augmented reality environment as discussed above. Aspects of a model, scene, image of an object may be encoded in a known format, such as 3D vector format, a Computer-Aided Design file, .FLV, .MP4, AVI, .MPG, .MP3, .MOV, .F4V, .VR, or any other image, video, or model format.

In some embodiments, the system may output the model by transmitting to a client device or display a scene at an interface of the system. Transmitting may include transmitting over any network, such as a TCP/IP network, a broadband connection, a cellular data connection, and/or any other method of transmitting. A client device and/or an interface of the system may include, but is not limited to, a mobile device, a headset, a computer, a display, an interface, and/or any other client device. While the present disclosure provides examples of methods for transmitting, and devices for display it should be noted that aspects of the disclosure in their broadest sense, are not limited to the disclosed examples.

The partial object detection problem includes the problem of understanding a 3D object when the 3D data of the object is not complete. The representation of the 3D object may he given in any of 3D object formats/modalities for example point cloud, mesh, voxel representation, etc. As discussed below, there may be several reasons a partial object needs to be detected.

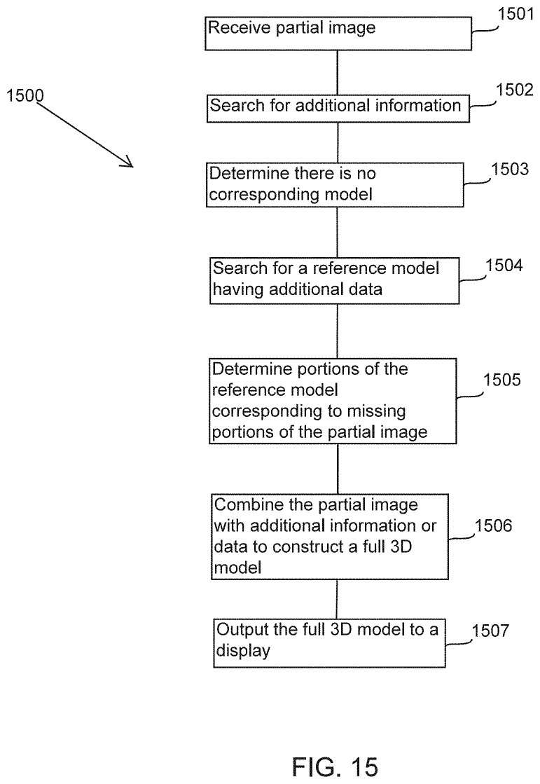

FIG. 15 depicts an exemplary method that may be performed by the system disclosed in this disclosure. As will be appreciated from this disclosure, modifications may be made to method 1500 by, for example, adding, combining, removing, and/or rearranging the steps of method 1500. Steps of method 1500 may be performed by components of system 1000, including, but not limited to, 3D generator 1020. For example, although method 1500 may be described as steps performed by 3D generator 1020, it is to be understood that user system 1010 and/or server 1020 may perform any or all steps of method 1500. As one of skill in the art will appreciate, method 1500 may be performed together with any other method described herein. The method may include receiving a partial scan and meshing the partially scanned image to generate a full 3D model of an object.

At step 1501, computation device 200 may receive a partial image of an object, wherein the partial image is at least one of a 2D image or an incomplete 3D image. As discussed herein, the computation device 200 may receive the partial image from a stored location such as memory, from a data structure or a plurality of data structures, from a user input, from any wired or wireless communication path, or from any other type of data transfer protocol.

At step 1502, the computation device 200 may search at least one data structure 130 for additional information corresponding to the partial image. In some embodiments the data structure 1030 may be local, stored in memory, or may be a remote data structure connected by a series of networks, or a cloud storage device.

At step 1503, the computation device 200 may determine that the data structure 1030 does not include a corresponding 3D model of the object. At step 1504, the computation device 200 may search at least one data structure 1030 for a reference 3D model different from the object in the partial image but having similarities to the object in the partial image, wherein the reference 3D model includes additional data. At step 1505, the computation device 200 may compare the partial image with the reference 3D model to determine portions of the 3D reference model that generally correspond to missing characteristics of the partial image.

At step 1506, the computation device 200 may combine the partial image with the additional information, the additional data, or a combination of the additional information and the additional data to construct a simulated full 3D model of the object. At step 1507, the computation device 200 may output the simulated full 3D model. In some embodiments the output includes storing, transferring or displaying the full 3D model.

The following provides an example of an implementation of an object-completion scheme based on the disclosure. A user takes a 3D-scan of a physical chair. The scan is only of some the front of the chair, and the back of the chair is not visible. Thus, the disclosed method may include a step of scanning an object or receiving a partial scan of an object. The disclosed method may include a step of searching for the resulting scan in an existing data structure of 3D objects, Furthermore, the disclosed system may not find any chair in the data structure whose front exactly matches the current chair. However, the disclosed system may locate chairs with similar proportions, but of different material and texture. Thus, for example, the disclosed method may include a step of selecting a CAD model of a selected object (e.g., a chair). The disclosed system may then create a new CAD model. For example, the disclosed method may include a step of generating a new CAD model by combining the scan of the object with the CAD model of the selected object. The new model may inherit the texture and the material from the scanned chair, and the 3-dimensional shape from the data structure complete CAD model. The new model may be a fuse (i.e. merger or combination) of the CAD model and the scan, in some sense. In some embodiments, the disclosed method may identify the material of the chair based on, for example, tags in the data structure associated with the chairs that were found to be similar to scan of the physical chair and receive input of a material from the user. The data structure may store information correlating various materials with their associated textures. The disclosed method may search the data structure for a texture corresponding to the material received as input from the user and apply that texture to the basic image elements of the CAD model. The disclosed system may present the user with the new model via a 3D viewing device such as a VR headset, a regular screen, etc. Thus, for example, the disclosed method may include a step of presenting a full, combined 3D CAD model of the object to a user, who may view the full model on a 3D viewing device. It is contemplated that the user may view the fused 3D CAD model generated by the disclosed system.

The disclosed system may fuse the two sources to create a 3D object which inherits properties from both. Thus, for example, the disclosed system may combine the partial image with the additional information to construct a simulated full 3D model. Examples for such combining of the two sources may include replacing the scan with the best fitting CAD model; replacing the scan with the best fitting CAD model, but the proportions of the CAD model may be changed to fit the proportions which can be seen in the partial scan; and replacing the scan with the best fitting CAD model, but the texture/material may be transferred from the scanned data to the CAD model, extrapolating it to the whole CAD model.

The new, fused model, may be created from the scanned model and the external CAD model. Therefore, it may contain more information than the information contained in the original scan. For example, the added information may come from the CAD data in our data structure, and this extra information may be additional information corresponding to the partial image.

In some aspects, creating a full CAD chair from a partial scan may not be needed, as a CAD model of the parts of the chair visible in the scan may be sufficient. This may be useful for example for more natural lighting computations on the model. Thus, for example, the additional information may include a 3D model that corresponds to the received partial image.

In some aspects, the disclosed data structure may not contain CAD models, but a family of scanned objects, and these scans may be partial. In this case, the disclosed system may find a subset of scans in the data structure that are similar to the partial scan, and may further combined information from this subset. For example, the disclosed system may combine data from the data structure-scans to complete parts that were obscured in the present scan, to create a fused partial image without “holes” that existed in the present scan. Thus, for example, the additional information may include information derived from partial scans of at least one object similar to the object in the partial image.

In some aspects, the scanned data may be a point cloud, and it may be desired to create a mesh best representing this point cloud. This may be a standard task related to scanning 3D objects, and there are methods to obtain a mesh directly from the point cloud, but these conventional methods may be sensitive to scanning errors. If, however, the search from the disclosed system, which is less sensitive to scanning errors as it is more global, locates a 3D CAD model similar enough to our scan, together with a mapping between the CAD model as a 3D manifold to the scanned data, the disclosed system may transfer the existing, high-quality mesh from the CAD model to the point cloud of the scan. Thus, for example, in the disclosed system and method, combining may include meshing the partial image with the determined portions of the 3D reference model. In some embodiments, the disclosed system may use a hybrid approach, meshing the point cloud directly using a standard meshing algorithm such as Poisson reconstruction. In other portions of the mesh, the disclosed system may use the mesh from the CAD model stored in the data structure.

In some aspects, the disclosed system may provide a CAD model that most accurately corresponds to the scanned partial image. Thus, for example, the disclosed system may provide additional information that may include a 3D model that corresponds to the received partial image.

In some aspects, the disclosed system may detect the texture from the scanned data (for example, for each point in the scan data, the disclosed system may deduce from the scan data whether it is metallic, wood-like, glass, etc.) The disclosed system may then fuse this texture data on the CAD model discovered by the search (or on the parts of this CAD model of interest). When a 3d-manifold mapping representing the matching between the CAD model and the scan data is available, the disclosed system may transfer the texture from the scanned data onto the CAD model, creating a model with the shape of the CAD model, but with the texture of the scanned object. Thus, for example, the disclosed system may identify at least one of a texture and a color of the partial image and, during meshing, to apply the at least one texture and color to the determined portions of the 3D reference model.

In some aspects, the disclosed system may insert the fused object into a 3D computer game. In this case, the disclosed system may add properties relevant to computer games. The disclosed system may provide a full 3D model, so the player can manipulate the object within the game. The disclosed system may also provide mass and flexibility properties, so the manipulation of the object is physically natural. Thus, for example, the disclosed system may export the simulated full 3D model into a format compatible with a 3D consumable environment.

In some aspects, the disclosed system may present the fused object to the user in a specific orientation. For example, when the chair is scanned from the front, the disclosed system may present the fused chair from the back, rotated by 180 degrees. The disclosed system may add this orientation change (a member of the 3-dimensional rotation group) as an input to the display step. In some embodiments, the at least one processor may be further configured to receive an input for rotation of the simulated full 3D model by an angle ranging between about 0° and about 360° in one or more planes. The processor may also be configured to receive inputs from the user regarding translation and/or rotation of the full 3D model about an axis of rotation defined by the processor or defined by the user. The processor may translate and/or rotate the simulated full 3D model based on the input and display the rotated simulated full 3D model on the display device.

In some aspects, the disclosed system may present a fused model in a smaller scale than in the original scan, or in the original CAD model. For example, when creating a computer game where everyday objects are turned into toys. In this case, the scale may be provided as input to the display stage of the model-fusing process described above. In other aspects, the disclosed system may scale the CAD model to correspond to a real-size seen in the scanned object. In some embodiments, the disclosed system may receive an input for scaling the simulated full 3D model, scale the simulated full 3D model based on the input, and display the scaled simulated full 3D model on the display device.

The present disclosure relates to computer-implemented systems for controlling a robot by processing scenes (e.g., 2D or 3D scenes based on scans) associated with an environment of the robot. As used in this disclosure, a robot may refer to any machine capable of performing a function that acts on or physically interacts with an object, whether an industrial robot, a humanoid robot, or vehicular robot, or other machine that is either pre-programmed, autonomous, semi-autonomous, teleoperated, or augmenting, and whether applied in industrial, domestic, military, emergency response, exploratory, consumer, medical, service, security, aerospace, or aquatic environments. Such robots may include Cartesian robots, cylindrical robots, SCARA robots, parallel robots, articulated robots, spherical robots, single and multi-wheeled robots, treaded robots, or legged robots, flying robots, swimming robots and hybrids of any of the forgoing. A vehicular robot, for example, may be capable of traveling in an environment (e.g. room, lawn, factory floor, industrial work area, etc.) or any other space.

Operations of the robot may be controlled using one or more processors located on board the robot or off-board the robot. The present disclosure provides solutions to problems in technology and applications for allowing the robot to interact with and potentially alter the position, orientation, and/or configuration of an object in the robot's environment. While the present disclosure may relate to examples of Augmented Reality (AR), Virtual Reality (VR), and Mixed Reality (MR) technologies and applications, it should be noted that aspects of the disclosure in their broadest sense are not limited to particular examples. Rather, it is contemplated that the foregoing principles may be applied to other processor-controlled technologies and applications.

By way of example, consider a cleaning robot that may enter a room. One or more cameras installed on the robot may create a 3D representation of the robot's surroundings. The disclosed systems and methods may segment the 3D representation into individual objects. Consistent with embodiments of the present disclosure, segmenting may additionally or alternatively be performed using techniques for segmenting discussed above. One of these objects may be, for example, a swivel chair. The robot's task may be to clean the floor, and the swivel chair may be situated in the middle of the room. The system may send the segmented chair to a search engine. The search engine may detect that the swivel chair in the 3D representation of the robot's surroundings is similar to several swivel chairs in a data structure associated with the search engine. The swivel chairs in the data structure may include instructions on how they interact with their environment. For example, the instructions may disclose that a swivel chair moves when pushed. Now, instead of cleaning around the swivel chair, the disclosed system may command the robot to push the chair to a side of the room, and may further instruct the robot to clean the floor freely.

For example, the robot may solve an optimization problem: clean as much as possible from the floor. The robot may scan the room searching all possible courses of action. The robot may detect the chair in the room. The disclosed system may determine that the chair may be associated with one or more scripts describing how the chair may be moved by certain interactions. The disclosed system may combine the chair scripts with the robots own modes of motion and determine a new course of action. For example, the disclosed system may determine that when the robot pushes the chair, the chair will move, in a way described by the chair script.

The combination of the robot script and the chair script may enable the robot to find a better solution to the cleaning optimization problem, such as moving the chair aside. The robot may not be able to determine apriori which chairs can be moved. Moreover, even if a chair is movable, a user may not want the chair to be moved. The user preferences may be described, for example, in a robot script that may instruct the robot not to move a particular chair. Thus, the combination of a chair script and the robot script may be essential for the task, depending on application.

The chair script may include information in addition to whether the chair is movable. For example, it may include information about how the chair moves when subject to certain forces. For example, a force exerted one way on a swivel chair may cause the seat to swivel, while a force exerted differently may cause the wheeled base of the chair to move. Additionally, the script may contain information on particularly forces required for particular movement, how the chair is expected to accelerate and decelerate, and information on how environmental conditions such as floor surface (e.g., carpet, tile, wood, etc.) impacts expected movement.

In accordance with the present disclosure, a control system for a robot is disclosed. The control system may be configured to control one or more operations of the robot. For example, the control system may be configured to propel the robot in any direction within an environment associated with the robot. The control system may, for example, be configured to adjust a speed, direction, and acceleration of movement of the robot. The control system may also be configured to cause the robot to interact with one or more objects in the robot's environment, for example, by applying an external stimulus (e.g. force, torque, etc.) on the one or more objects. The system may include at least one processor. Exemplary descriptions of a processor and memory are described above, and also with reference to FIG. 2.

The processor may be configured to receive image information for a scene depicting an environment associated with the robot. A scene may be the local environment (e.g. surroundings) associated with the robot's location. Thus, for example, the image information for the scene may include representations of one or more objects located around the robot. The image information for a scene may be an visual image itself and/or may include image identifying data in non-image form (e.g., numerical data characterizing the image information).

By way of example, a scene associated with a cleaning robot may include objects such as one or more chairs, tables, lamps, doors, toys, or other objects typically found in a room, while a scene associated with a robotic lawn mower may include objects such as one or more rocks or obstacles, outdoor lights, paving stones, walls, gates, etc. Image information for a scene may be received from another device (e.g., a client device, a user device) or may be received from an imager on the robot itself. Image information for a scene may be retrieved from a remote or local data storage or a data structure. Image information for a scene may include image data, consistent with disclosed embodiments. In some embodiments, the robot may include a camera (or a scanner) configured to generate the image information for the scene. Thus, for example, the image information for the scene may be based on a scan, the scan including image data captured using one or more cameras or scanners (e.g., a 3D scanner) associated with the robot.

Consistent with disclosed embodiments, the image information for a scene may be configured for display via a device, such as a headset, a computer screen, a monitor, a projection, etc. For example, the robot may be configured to transmit image information associated with the scene to a remotely located device (headset, computer screen, etc.). In other embodiments, the robot may include one or more display devices capable of displaying the image information. The image information for a scene may be encoded in a known format, such as 3D vector format, a Computer-Aided Design file, .FLV, .MP4, .AVI, .MPG, .MP3, .MOV, .F4V, .VR, or any other image, video, or model format. Embodiments consistent with the present disclosure may include image information represented by a mesh, point cloud, or any other representation that encodes the image information for a scene.

In an exemplary embodiment, the image information for a scene may include a 3D representation of a space, such as a living room encoded as a mesh. In some embodiments, a scene may include at least one object, as described herein. The object may be, for example, a chair, a car or other terrestrial or aerial vehicle, a painting, a person, an animal, a component, a workpiece, and/or any other anything else with which the robot may interact.

In some embodiments, the system may generate image elements based on a received scan and/or the scene may include image elements, consistent with disclosed embodiments. More generally, a scene may include a plurality of basic elements, such as image elements (2D or 3D). For example, image elements may include at least one of a voxel, a point, or a polygon. In some embodiments, the system may generate a set of polygons, the individual polygons being basic elements. As another example, if the system generates a point cloud, then individual points are image elements. If a mesh includes a plurality of voxels representing a scene or a voxel-mapping of a subset of space, then a voxel may be an image element. A voxel may be a closed n-sided polygon (e.g., a cube, a pyramid, or any closed n-sided polygon). Voxels in a scene may be uniform in size or non-uniform. Voxels may be consistently shaped within a scene or may vary in a scene.

Basic elements may be further subdivided in some cases. For example, the system may generate a mesh comprised of a plurality of n-sided polygons as image elements, and one or more polygons may be subdivided into additional polygons to improve resolution or for other reasons.

In some embodiments, a scene may include a plurality of preexisting image elements. Preexisting image elements may be received together with or separately from receiving a scene.

In some embodiments, the system may segment the scene to extract an image of at least one object in the scene, using one or more of the segmenting techniques discussed above. For example, the system may segment the scene into one or more objects representing living room furniture, such as chairs, cups, tables, or other objects, consistent with disclosed embodiments. Segmenting may include identifying objects that correspond to a known classification (e.g., identifying an object and classifying it as an “armrest”) and/or to an unknown classification (e.g., identifying an object and classifying it as “unknown object”), as discussed below.

The combination of the partitioned/classified image elements may constitute extracted images of one or more objects in the scene. A classification may include a type of object. For example, “furniture,” “chair,” “office chair” may all be classes of an object, including classes of the same object. As will be apparent to one of skill in the art, classes may be defined in a hierarchy of classes that are broader or narrower relative to each other. For example, a “furniture” class may be broader than a “chair” class, which may be broader than an “office chair” class.

For example, an extracted image of an object may include points, voxels, or polygons associated with an object such as a table, a surface of a table, a leg of a table, etc. In one example, the system may segment the scene comprising a scan of a living room into a plurality of objects, such as a chair, a doorknob, a handle, a cup, a utensil, a shoe, a wall, a leaf of a plant, a carpet, a television, etc. The system may segment image elements as belonging to an object and classifying the object with a known classification or an unknown classification. For example, during segmenting, objects may be labeled as a specific type of object (e.g., a chair), as an unknown type of object, and/or as a possible known object (e.g., a “likely” chair) based on some measure of confidence or likelihood associated with a segmenting algorithm output.

One or more image elements may remain unmapped following segmenting (i.e., unassigned to an object or component of an object). Segmenting may include mapping (i.e., assigning) 3D elements to one object or more than one object (e,g., a same 3D element may be assigned to “armrest” and to “chair”).

Disclosed embodiments may access a data structure. Exemplary data structures, consistent with the embodiments of this disclosure, are described above. The data structure may store information about one or more objects. The information about the objects may be in the form or image data with or without object image identifiers, or may contain non-image data from which characteristics of objects may be identified. For example, image data of the data structure may include 2D or 3D models or CAD models of objects. A CAD model may be stored in one or more formats, such as a mesh, a point cloud, a voxel-mapping of a 3D space, and/or any other mapping that may be configured to represent either graphically or numerically, a depiction of an object. A CAD model may represent an object and/or a component of an object (e.g., a chair and/or an armrest of a chair). An object image identifier may include text representing an object image. For example, an object image of an office chair may be represented by the text “office chair.” In some embodiments, an object image identifier may comprise at least one of a shape, a descriptor of a shape, a product, or a descriptor of a product. A shape may include shape data, the shape data comprising coordinates, vectors, a mesh or grid, a representation of a shape (e.g., a 2D or 3D model), or any other data relating to a shape. A descriptor of a shape may include text data, a label, a classification, a tag, and/or any other data describing or identifying a shape. A descriptor of a product may include text data, a label, a classification, a tag, and/or any other data describing or identifying a product.

A data structure consistent with the present disclosure may include historical information about one or more objects. As used herein, historical information refers to any information, previously collected, that characterizes an object. The historical information, in one sense may enable identification of an object, and in another sense may characterize movability information about the object. The corresponding historical information may also include a script representing movability characteristics of the at least one object. The script may describe a movement property of the one or more objects. Generally, movement properties may include any property associated with a freedom of motion of an object or a component of an object. For example, the movement properties represent how an object or a component of an object (collectively, an object) moves in response to a stimulus such as a force. The associated properties may include force to cause a motion, speed of motion, acceleration, deceleration, rotation, or any other property associated with movement. Scripts associated with an object may be configurable by a designer or other client.

In some embodiments, the movability characteristics may include at least one rule defining a movement of the at least one object based on an external stimulus. For example, the movability characteristic may include a programmatic description of the reaction of an object with degrees of freedom to one or more external forces. A script may describe an amount by which an object may move when subjected to a particular external force applied in a given direction to the object. For example, an object may have a script describing that when the object is pushed at a point x with a force vector F, the object may move at speed win the direction of a vector k. As another example, a stationary object (e.g. vase) may have a script that describes that the robot must be located at least a distance D from the object at all times to prevent contact between the robot and the object. As another example, a script for a cup may describe that when the cup is pushed at points x, y with forces Fx, Fy, respectively, the cup may move in the x and/or y directions by a certain amount (e.g. to allow the robot to lift the cup).

By way of another example, a script may describe that an object would achieve a speed V or an acceleration A when a force F is applied to the object. Here L, V, A, and F may take various defined numerical values. It is also contemplated that in some exemplary embodiments, L, V, A, and/or F may be related to each other through correlation tables, mathematical expression, algorithms etc., which may be codified in the one or more scripts associated with an object. As another example, for a swivel chair, the program may embody a rule describing an amount of rotation a CAD model of an upper part of the chair with respect to the legs of the chair, for a given rotation force applied to the upper part. The script describing the movability characteristics may be written in any code capable of animating an object (e.g., AUTOCAD, BLENDER, CINEMA 4D, and/or AUTODESK MAYA). Although properties such as force, distance, velocity, acceleration, etc. have been discussed above, it is contemplated that the scripts may include other properties, for example, angular velocity, angular momentum, rotations, deflections, stresses, and/or any other properties associated with objects.

As another example, a movability script may include several inner modes of motion of an object, not only the movement of its center of mass. For example, a spring may start to expand and contract relative to a pull, even after no force continues to be applied. As another example, a swivel chair, when pushed, may move in a combination of center-of-mass motion and rotation around its legs, and the wheeled-legs themselves may rotate relative to the floor, these are three different modes of operation. The script may contain a simulation of some or all three modes of motion. The script may also contain a simulation of the motion of the chair when no external force is applied, and how this motion changes when a short-term force is applied, and then no force is applied for some time.

A CAD model may have scripts associated with a whole object (e.g., an elasticity of a ball when bouncing), or associated with a part of an object (e.g., a motion of a rotor on a helicopter). Degrees of freedom may be complex, representing interactions between several objects such as a lever that raises a chair seat up, a handle that opens a door, etc. Accordingly, a script may represent an interaction between one object and at least one other object in the scene. For example, a script may represent an interaction between a swivel chair and another swivel chair or, for example, between a swivel chair and a ball or a toy present in the scene. Thus, for example, a script may describe an amount of movement, a velocity, an acceleration etc. of the another swivel chair, ball, or toy, when the swivel chair applies a stimulus (e.g. force, torque, etc.) to the another swivel chair, ball, or toy.

The system may compare the extracted image data with the historical information in the data structure to identify corresponding information in the data structure about the at least one object. Consistent with embodiments of this disclosure, the system may perform the comparison using one or more of the techniques for comparing objects and/or image data discussed above. For example, the system may compare object image identifiers, shapes, descriptors, labels, etc. associated with the extracted image with the information (e.g. object image identifiers, shapes, descriptors, labels, etc.) in the data structure to identify corresponding information such as a script. In some embodiments, the system may compare the extracted image information (e.g. object image identifiers, shapes, descriptors, labels, etc.) with information in the data structure to identify a matching object in the data structure corresponding to, for example, an object present in the extracted image (which may be referred to as a scene object). A matching object may include a model of the at least one object, object image identifiers, shapes, descriptors, and/or labels, consistent with disclosed embodiments. In some embodiments, a matching object may be a component that is similar to but not the same as the scene object. For example, the scene object may be a black chair on a pedestal with wheels and armrests, and a matching object may include office chairs with pedestals in various colors, with or without armrests.

In some embodiments, identifying a matching object may include mapping a 3D shape to a feature vector (i.e., generating a feature vector). In some embodiments, the system may compute a feature vector of a scene object with a feature vector of a matching object. A feature vector may include a sequence of real numbers or other data. A feature vector may likewise include information relating to a rotation and/or a location change of a scene object or a matching object. Generating a feature vector may include using a machine learning model such as a multi-view convolutional neural network. For example, a multi-view convolutional neural network may accept a plurality of 2D representations of a 3D shape (i.e., snapshots), the 2D representations including projections of the 3D shape onto 2D from various angles (e.g., photos of an object).

In some embodiments, identifying a matching object may include determining a similarity metric indicating a degree of similarity between the matching object and the scene object (i.e. an object in the extracted image). A similarity metric may be based on shape data, color data, and/or any other data. A similarity metric may be based on a statistical similarity such as a covariance, a least-squares distance, a distance between vectors associated with image elements (e.g., feature vectors), or a Hausdorff distance between aligned objects. A similarity metric may be based on a feature vector. In some embodiments, comparing may include implementing a classification model (e.g., a random forest model) to classify components of an object.

In some embodiments, identifying a matching object may include searching a data, structure of objects and generating one or more search results (i.e., matches) corresponding to objects in the data structure. A search result may include a percent match, a likelihood, or another metric representing a degree of similarity between the scene object and an object in a data structure or an object corresponding to an image object identifier in the data structure. A highest-ranking search result may define, for example, the narrowest class of a data structure object or component that matches the scene object, for example.

The system may also extract from the data structure corresponding information, including, for example, one or more scripts associated with the matching object. For example, the system may identify one or more scripts associated with the object having a highest rank (e.g. highest degree of similarity) in the search results or matches. As discussed above, the one or more scripts may define movability characteristics, for example, in the form of rules.

The system may control the robot by applying the script, to thereby cause the robot to interact with the at least one object based on the movability characteristics defined by the script. In some embodiments, applying the script may include executing the script by the at least one processor of the disclosed system. For example, the system may cause the robot to apply an external stimulus (e.g. a force, a torque, etc.) on the at least one object to cause the at least one object to move in a given direction in response to the stimulus. Thus, for example, the robot may apply a force to a chair to cause it to move to a new position. The system may determine the magnitude and direction of force in accordance with the movability characteristics described in the script to ensure that the object moves to a desired position or moves with a desired velocity or acceleration, etc. in a desired direction. In some embodiments, the at least one processor may be configured to adjust the external stimulus exerted by the robot on the at least one object based on the movability characteristics of the at least one object. For example, the system may determine based on the movability characteristics that the at least one object (e.g. chair) may move by a distance L in response to a force F applied to the chair. The system may control the robot to adjust the external stimulus to correspond to a force F to cause an object to move by, for example, distance L. In other embodiments, the movability characteristics may indicate that applying a force larger than, for example, Fmax may cause damage to the at least one object. Based on this information, the system may adjust the stimulus applied by the robot so that the force exerted by the robot on the at least one object is less than Fmax to prevent damage to the at least one object while also causing the at least one object to move from its original position in accordance with the movability characteristics. In yet other embodiments, the movability characteristics may indicate that applying a force F may cause the object to move with a velocity V or an acceleration A. The system may adjust the stimulus applied by the robot to ensure that the object moves, for example, with a velocity or acceleration less than or equal to V or A, respectively.

It is also contemplated that in some embodiments, even though an object may be movable, a user or client may not permit the object to be moved or, for example, may only permit the object to be moved in a certain direction or for a certain distance. These preferences may be encoded in one or more scripts associated with the robot. The disclosed system may control the robot by applying a combination of the one or more robot scripts and scripts associated with the movable object. Thus, the disclosed system may control the robot so that the robot may only apply external stimuli to the object such that the object may move only in the direction or by the distance permitted by the user or client.

In some embodiments, the at least one processor may be configured to generate a modified scene based on an interaction of the robot with the at least one object. Consistent with the present disclosure, generating a modified scene may include combining the extracted image or a modification of the extracted image with scene data. The system may replace the original object (e.g., chair) in the scene with the same object, for example, positioned in a new location as determined by the object movability characteristics. For example, if a chair in the scene is expected to move to a new position based on an external stimulus applied by the robot, the at least one processor may be configured to combine the extracted 2D or 3D image with the scene to depict the chair in its new moved position in the modified scene. The at least one processor may position, scale, rotate or align the object to depict the object in its new position. Positioning an object and/or scaling an object may include using Principal Component Analysis (PCA). The at least one processor may employ image processing techniques (e.g., adjusting brightness, adjusting lighting, implementing a gradient domain method, etc.), consistent with disclosed embodiments. As one of skill in the art will appreciate, a gradient domain method may include constructing a new image by integrating the gradient of image elements. The system may generate the modified scene by rendering the mesh, points, or any other digitized representation of an object based on lighting, scene resolution, a perspective, etc. Additionally or alternatively, the disclosed system may generate a modified scene by employing techniques discussed above for combining two images.

Consistent with disclosed embodiments, the at least one processor may be configured to output the modified scene for 3D display. Outputting the modified scene may include storing and/or transmitting a modified scene, consistent with disclosed embodiments. Transmitting may include transmitting over a. network, such as a TCP/IP network, a broadband connection, a cellular data connection, and/or any other method of transmitting, consistent with disclosed embodiments. For example, the system may broadcast a modified scene (i.e., transmit to a plurality of user and/or client devices via a network), transmit a modified scene to a user device, and/or store a modified scene in memory. A user or client device and/or an interface of the system may include, but is not limited to, a mobile device, a headset, a computer, a display, an interface, etc.

In some embodiments, the system may select another script associated with the object, the another script representing an interaction between the object and at least one other object in the scene. Selecting another script may be based on an image object identifier associated with the at least one object and another object. For example, a first script may be associated with a first image object identifier corresponding to a first object (e.g. chair), whereas the second script may be associated with a first image object identifier corresponding to the first object (e.g. chair) and a second image object identifier corresponding to a second object (e.g. door).

In some embodiments, the system may apply the script to the at least one object. For example, the first script may include a script describing a movement of the chair alone, and the second script may include a script that describes movement of both the chair and the door when the chair comes into contact with the door. The system may apply the second script to determine, for example, an amount of movement of the chair and/or of the door when the chair is in contact with the door.

In some embodiments, an image or representation of a scene (e.g. of a room) may be stored in the data structure together with an apriori segmentation of objects in the scene. Thus, the data structure may already include image information identifying a plurality of objects in the stored image. The data structure may also store information regarding whether the objects are movable or immovable. It is contemplated that the apriori segmentation may be performed manually by a user, or automatically, using a processor associated with the disclosed system. It is further contemplated that the robot may be able to access both the image and the apriori segmentation stored in the data structure. Based on the information regarding the image and the segmentation, the robot may search for specific objects corresponding to the objects obtained from the apriori segmentation of the scene stored in the data structure. The robot may apply a variety of computational techniques, including, for example, registration to position itself within the room.

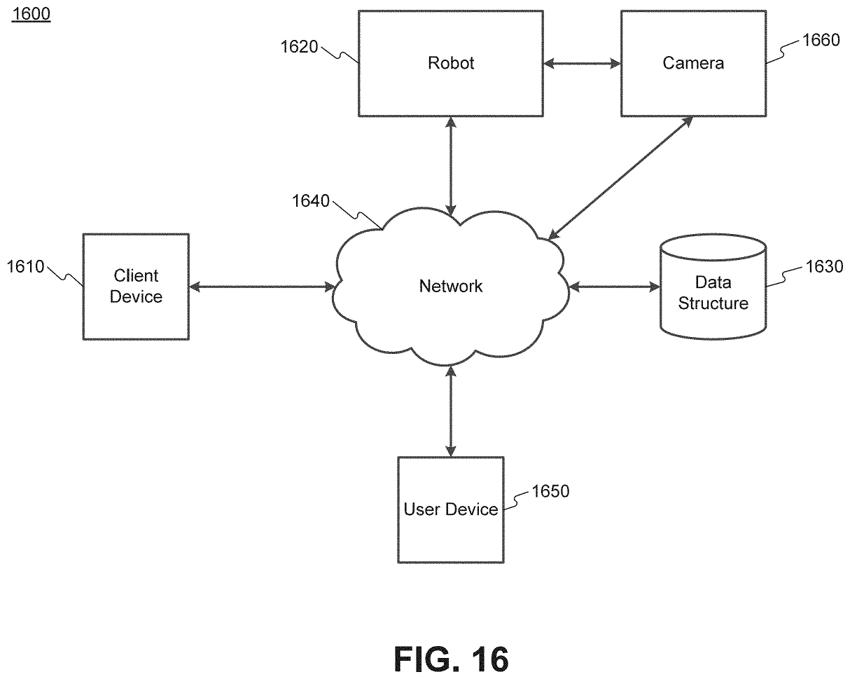

FIG. 16 depicts an exemplary system 1600 for controlling a robot, consistent with embodiments of the present disclosure. As shown, system 1600 may include a client device 1610, a robot 1620, a data structure 1630 (e.g., a database), a user device 1650, and a camera 1660. Components of system 1600 may be connected to each other or in communication with each other via a network 1640. In some embodiments, aspects of system 1600 may be implemented on one or more cloud services. In some embodiments, aspects of system 1600 may be implemented on a computing device, including a mobile device, a computer, a server, a cluster of server, or a plurality of server clusters.

As will be appreciated by one skilled in the art, the components of system 1600 may be arranged in various ways and implemented with any suitable combination of hardware, firmware, and/or software, as applicable. For example, as compared to the depiction in FIG. 16, system 1600 may include a larger or smaller number client devices, robots, data structures, user devices, cameras, and/or networks. In addition, system 1600 may further include other components or devices not depicted that perform or assist in the performance of one or more processes, consistent with the disclosed embodiments. The exemplary components and arrangements shown in FIG. 16 are not intended to limit the disclosed embodiments.

In some embodiments, client device 1610 may be associated with any individual or organization. For example, client device 1610 may be configured to execute software to capture a scene of an environment (e.g., room, office, factory floor) and provide the scene to robot 1620, consistent with disclosed embodiments. Client device 1610 may also be configured to receive a modified scene from robot 1620 and display the modified scene to a user of client device 1610, consistent with disclosed embodiments. Client device 1610 may include one or more memory units and at least one (or more) processors configured to perform operations consistent with disclosed embodiments. In some embodiments, client device 1610 may include hardware, software, and/or firmware modules. Client device 1610 may include a mobile device, a tablet, a personal computer, a terminal, a kiosk, a server, a server cluster, a cloud service, a storage device, a specialized device configured to perform methods according to disclosed embodiments, or the like. Client device may be configured to receive user inputs (e.g., at an interface), to display information (e.g., images and/or text), to communicate with other devices, and/or to perform other functions consistent with disclosed embodiments.

Robot 1620 may include a device configured to perform one or more operations in an environment, consistent with disclosed embodiments. By way of example, robot 1620 may be an autonomous cleaning robot (e.g. robot vacuum cleaner), an autonomous lawn mower, an autonomous factory assembly robot, an autonomous vehicle, an articulated arm, or any of the other robots previously described. Robot 1620 may include one or more memory units and one or more processors configured to perform operations consistent with disclosed embodiments. Robot 1620 may be configured to receive data from, retrieve data from, and/or transmit data to other components of system 1600 and/or computing components outside system 1600 (e.g., via network 1640).

Data structure 1630 may be hosted on one or more servers, one or more clusters of servers, or one or more cloud services. In some embodiments, data structure 1630 may be a component of robot 1620 (not shown). Data structure 1630 may include one or more data structures configured to store images, video data, image object information, image object identifiers, metadata, labels, movability characteristics, scripts, and/or any other data. Data structure 1630 may be configured to provide information regarding data to another device or another system. Data structure 1630 may include cloud-based data structures, cloud-based buckets, or on-premises data structures.

User device 1650 may be any device configured to receive and/or display a media content frame, including VR, AR, and/or MR data. For example, user device 1650 may include a mobile device, a smartphone, a tablet, a computer, a headset, a gaming console, and/or any other user device. In some embodiments, user device 1650 may be configured to receive and/or display a broadcast. User device 1650 may include one or more memory units and one or more processors configured to perform operations consistent with disclosed embodiments. In some embodiments, User device 1650 may include hardware, software, and/or firmware modules.

Camera 1660 may be a 2D or 3D imaging device or scanner configured to generate image information for a scene depicting an environment associated with robot 1620. As discussed above, the image information may be encoded in a known format, such as 3D vector format, a Computer-Aided Design file, .FLV, .MP4, .AVI, .MPG, .MP3, .MOV, .VR, or any other image, video, or model format. Embodiments consistent with the present disclosure may include scenes represented by a mesh, point cloud, or any other representation that encodes a scene. Camera 1660 may be configured to transmit the scene directly to robot 1620 or via network 140.

One or more of client device 1610, robot 1620, data structure 1630, user device 1650, and/or camera 1660 may be connected to or in communication with network 1640. Network 1640 may be a public network or private network and may include, for example, a wired or wireless network, including, without limitation, a Local Area Network, a Wide Area Network, a Metropolitan Area Network, an IEEE 1002.11 wireless network “Wi-Fi”), a network of networks (e.g., the Internet), a land-line telephone network, or the like. Network 1640 may be connected to other networks (not depicted in FIG. 16) to connect the various system components to each other and/or to external systems or devices. In some embodiments, network 1640 may be a secure network and require a password to access the network.

In one example, a robot may be given a task—such as “fetch me a cup of cold water.” The robot may transmit the task “cold water” to a processor associated with system 1600 (e.g. with user device 1650 or client device 1610). The processor may search data structure 1630 to identify an image of a room that includes a refrigerator object, including a water dispenser object. The processor may transmit information regarding the image and the refrigerator to the robot. The robot may use the transmitted information to search for a corresponding refrigerator object within an image or representation of a scene or scan obtained by the robot from camera 1660 and/or a scanner associated with the robot. The robot may also search for an object corresponding to the refrigerator object in the received scene. The robot may move adjacent to an identified refrigerator object. The processor (e.g. of user device 1650 or client device 1610) may then transfer movability scripts associated with the cup to allow the robot to dispense water from the identified refrigerator object into the cup.

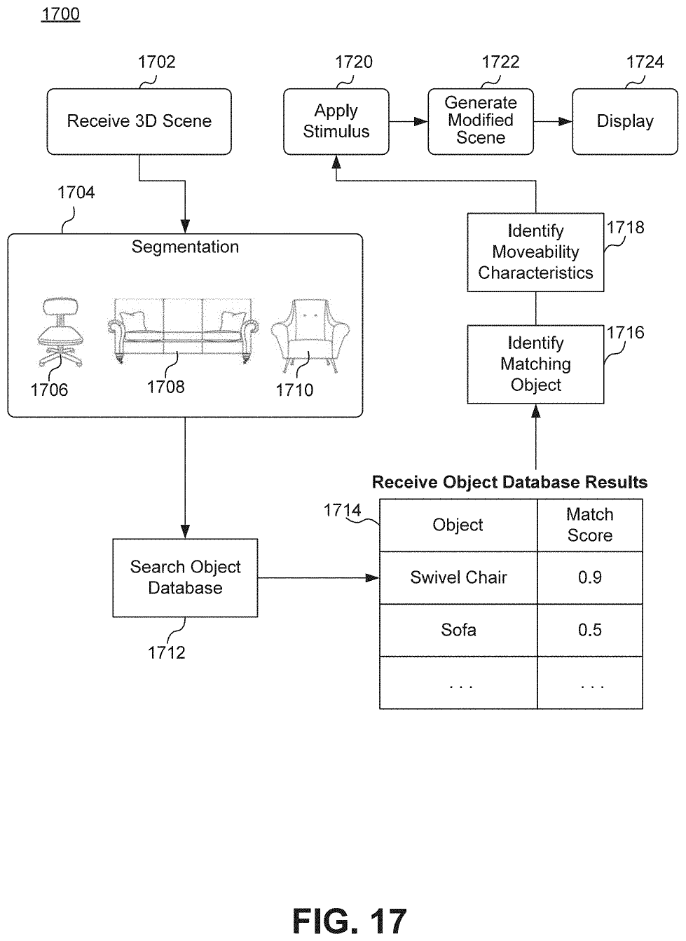

FIG. 17 depicts exemplary method 1700 of controlling a robot, consistent with embodiments of the present disclosure. The order and arrangement of steps in process 1700 is provided for purposes of illustration. As will be appreciated from this disclosure, modifications may be made to process 1700 by, for example, adding, combining, removing, and/or rearranging the steps for the process. Steps of method 1700 may be performed by components of system 1600, including, but not limited to, robot 1620. For example, although method 1700 may be described as steps performed by robot 1620, it is to be understood that client device 1610 and/or user device 1650 may perform any or all steps of method 1700. As one of skill in the art will appreciate, method 1700 may be performed together with any other method described herein. In some embodiments, process 1700 may be performed together with steps of process 400.

At step 1702, robot 1620 may receive image information for a 3D scene, consistent with disclosed embodiments. Image information for a scene may be received or retrieved from a data storage, consistent with disclosed embodiments. Image information for a scene may be received from another component of system 1600 and/or another computing component outside system 1600 (e.g., via network 140). Image information for a scene may be retrieved from a memory (e.g., memory 206), data structure (e.g., data structure 1630), or any other computing component. Image information for a scene may be based on image captured by one or more cameras 1660 (i.e., a scan), consistent with disclosed embodiments.

At step 1704, robot 1620 may segment a 3D scene, consistent with disclosed embodiments. As described herein, segmenting may include partitioning (i.e., classifying) image elements of a scene into scene-components or objects such as swivel chair 1706, sofa 1708, chair 1710, and/or other components or objects. In some embodiments, step 1704 may include generating a mesh, point cloud, or other representation of a scene.

At step 1712, robot 1620 may search an object data structure to identify one or more matching objects, consistent with disclosed embodiments. Searching an object data structure may be based on the objects identified in, for example, step 1704. An object data structure may include 3D models, image data, CAD models, image object identifiers, movability characteristics, scripts, programs, code, and/or any other data related to one or more objects.

At step 1714, robot 1620 may receive object data structure results based on the search, consistent with disclosed embodiments. Although two object data structure results are depicted at step 1714, more generally, object data structure results may include any number of results. Object data structure results may include a 3D model, a matched object, an image object identifier, and/or a similarity metric, consistent with disclosed embodiments. A similarity metric may include a “match score” or any other similarity metric, consistent with disclosed embodiments. A match score may represent a probability that an object in the scene matches with an object in the data structure. A match score may represent a degree of similarity between an object in the scene and a data structure object. A match score may be based on a shape of an object in the scene and a shape of a data structure object. As shown in FIG. 17, a “Swivel Chair” data structure object is associated with a match score of 0.9, and a “Sofa” data structure object is associated with a match score of 0.5.

At step 1716, robot 1620 may identify a CAD model or matching object based on object data structure results, consistent with disclosed embodiments. For example, robot 1620 may identify a CAD model or matching object associated with the highest match score (e.g., “Swivel Chair”).

At step 1718, robot 1620 may access one or more scripts defining movability characteristics of the matching object. For example, robot 1620 may retrieve scripts describing how, “Swivel Chair” may move when subjected to one or more external stimuli.

At step 1720, robot 1620 may apply one or more external stimuli to one or more objects in the scene. For example, robot 1620 may apply a predetermined force to the “Swivel Chair” causing the swivel chair to move according to the movability characteristics defined by the scripts obtained, for example, in step 1718.

At step 1722, robot 1620 may render a modified scene, consistent with disclosed embodiments. Rendering a modified scene may include rendering a scene in which an object has been moved to a new position based on the movability characteristics or scripts identified in, for example, step 1718. Rendering may include implementing any image processing technique, consistent with disclosed embodiments.

At step 1724, robot 1620 may transmit a modified scene, consistent with disclosed embodiments. In some embodiments, robot 1620 may transmit a modified scene to a user device (e.g., user device 1650) and/or client device 1610. In some embodiments, step 1724 may include broadcasting a modified scene. Transmitting at step 1724 may include transmitting over a network by any known method, consistent with disclosed embodiments. Additionally, at step 1724, a device may display a modified scene, consistent with disclosed embodiments. In some embodiments, client device 1610, user device 1650 or other device (e.g. on robot 1620) may display the modified scene, consistent with disclosed embodiments.

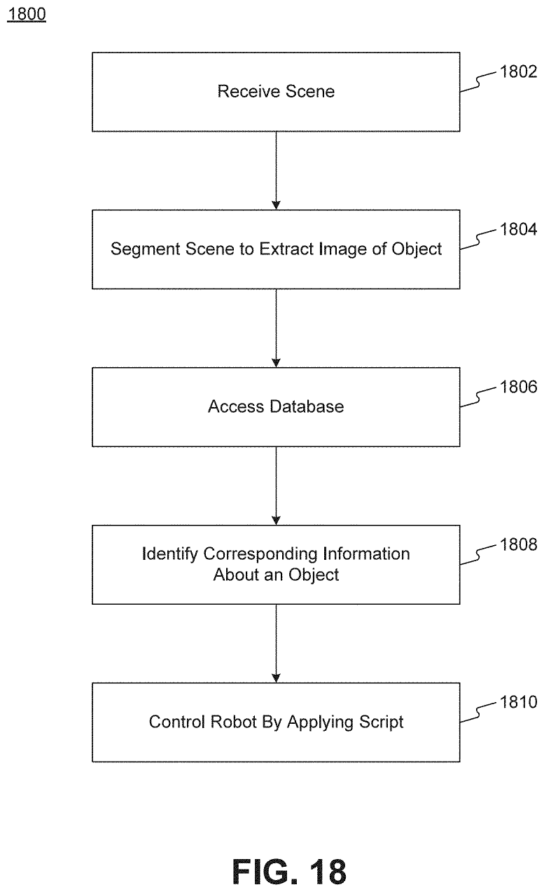

FIG. 18 depicts an exemplary method 1800 of controlling a robot, consistent with embodiments of the present disclosure. The order and arrangement of steps in process 1800 is provided for purposes of illustration. As will be appreciated from this disclosure, modifications may be made to process 1800 by, for example, adding, combining, removing, and/or rearranging the steps for the process. Steps of method 1800 may be performed by components of system 1600, including, but not limited to, robot 1620. For example, although method 1800 may be described as steps performed by robot 1620, it is to be understood that client device 1610 and/or user device 1650 may perform any or all steps of method 1800. As one of skill in the art will appreciate, method 1800 may be performed together with any other method described herein. Process 1800 may be performed in real-time to control operations of robot 1620, consistent with disclosed embodiments.

At step 1802, robot 1620 may receive image information for a scene, consistent with disclosed embodiments. The scene may be a 2D or 3D scene. The scene may be received from client device 1610, a data structure 1630, a camera 1660, a user device 1650, or any other computing component.

At step 1804, robot 1620 may segment the scene, consistent with disclosed embodiments. As described herein, segmenting may include partitioning (i.e., classifying) image elements of a scene into objects such as swivel chair 1706, sofa 1708, chair 310, and/or other objects. In some embodiments, step 404 may include generating a mesh, point cloud, or other representation of a scene. The representation of an object (e.g. in the form of a mesh, point cloud etc.) may form an extracted image of at least one object in the scene.

At step 1806, robot 1620 may access a data structure 1630 storing information about a plurality of objects. At step 1808, robot 1620 may compare the extracted image with information in the data structure to identify a matching object. For example, robot 1620 may search an object data structure based on the extracted image obtained, for example, in step 1804. An object data structure may include 3D models, image data, CAD models, image object identifiers, and/or any other data related to components and/or objects. Robot 1620 may receive object data structure results, consistent with disclosed embodiments. As previously described, object data structure results may include a match score or other similarity metric. Robot 1620 may select a CAD model or a matching object from the data structure results based on the match score or other similarity metric.

At step 1810, robot 1620 may identify corresponding information for the matching object from data structure 1630. For example, robot 1620 may identify one or more scripts representing movability characteristics corresponding to the matching object from data structure 1630.

At step 1812, a processor associated with robot 1620 may control robot 1620 by applying the one or more scripts causing robot 1620 to interact with at least one object in the scene based on the movability characteristics defined by the script. For example, the processor may cause robot 1620 to apply one of more external stimuli to the at least one object in the scene, for example, to move the at least one object to a new position.

The present disclosure relates to computer-implemented systems for three-dimensional (3D) content creation for use in virtual reality (VR), augmented reality (AR), and mixed reality (MR) technology and applications. The present disclosure provides solutions to problems in technology and applications for automatically processing 3D scenes. The present disclosure generally relates to automating 3D content creation by segmenting a scan of a 3D scene into objects, recognizing the objects, and then performing a context-based search for complementary objects that are often found together with the recognized objects. Automating may include identifying 3D representations of those complementary objects and either suggesting their inclusion in a reconstructed scene, or automatically inserting them into a reconstructed scene. While the present disclosure provides examples of AR, VR, and MR technologies and applications, it should be noted that aspects of the disclosure in their broadest sense are not limited to particular examples. Rather, it is contemplated that the foregoing principles may be applied to other computerized-reality technologies and applications.

An exemplary scenario for 3D content creation according to the disclosed system is described below. A user may view a 3D scene representing a living room on a display device. The scene may include a mesh (a mesh is a set of triangles in 3D space representing the external surface of all the objects in the scene). The disclosed system may segment the scene. Consistent with embodiments of the present disclosure, segmenting may additionally or alternatively be performed using techniques for segmenting discussed above. For example, the disclosed system may partition the scene into objects, mapping each of the hundreds of thousands of polygons of the mesh to a much smaller number of objects in the room. The objects may be, for example, chairs, tables, cups, lamps, doors, pictures, etc. The system may search for each object in an existing data structure of 3D objects where each object in the data structure may be classified with a name. For each object, the highest-ranking search results may define the class of the object. The system may classify objects in the room. For example, objects in a scene of a room may include (1) an office chair, (2) bottle and (3) a laptop (4) a whiteboard, etc. The system may infer, given the objects detected in the scene and their spatial relations, that the scene is highly likely to be an office environment. The system may scan its data structure for other scenes which may be similar to the current scene. For example, the system may identify other scenes from the scenes stored in the data structure that include similar objects having similar spatial relationships. The system may detect that in the similar data structure scenes, for example, a cup may be situated next to a bottle in many cases. The system may suggest, for example, adding a cup to the current scene. The system may present a user interface that may display, for example, several cups and several suggested locations (e.g. next to a bottle, on the table). The system may also permit a user to modify the location where the added object (e.g. cup) may be inserted in the scene.

In accordance with the present disclosure, a computer-implemented system for automating three-dimensional (3D) content creation is disclosed. The system may be capable of generating and/or displaying any 2D or 3D media, including in VR, AR, or MR environments. For example, a special case of the disclosed system may include system that generates content viewable on a VR headset such as a software-based game played on the VR headset. Other exemplary disclosed systems may include or be capable of producing content compatible with a phone or tablet with an MR experience adding elements to a camera-view of a room; an MR headset representing a 3D-experience of a viewed room, with additional elements added to the real environment; or any other device used by a user to interact with a real or virtual scene. The system may be capable of generating content for motion pictures such as cinematography, television, and video, whether dynamically generated in real time or recorded for later broadcast.

A system consistent with disclosed embodiments may include at least one processor. Exemplary descriptions of a processor and memory are described above, and also with reference to FIG. 2. While the present disclosure provides examples of a system or device, it should be noted that aspects of the disclosure in their broadest sense, may be implemented in corresponding methods and computer readable media. Thus, the present disclosure embodies all three and is not limited to the disclosed examples.

The at least one processor may be configured to receive a scan of a scene. The scan of the scene may be received from another device (e.g., a client device, a user device). A scene may be retrieved from a remote or local data storage. Receiving the scan of the scene may include capturing image data from one or more cameras or scanners (e.g., a 3D scanner). Consistent with disclosed embodiments, a scene may be configured for display via a device, such as a headset, a computer screen, a monitor, a projection, etc. Aspects of a scene may be encoded in a known format, such as 3D vector format, a Computer-Aided Design file, .FLV, .MP4, .AVI, .MPG, .MP3, .MOV, .F4V, .VR, or any other image, video, or model format. While the present disclosure provides examples of receiving a scan and formats for the scan, it should be noted that aspects of the disclosure in their broadest sense, are not limited to the disclosed examples.

A scene may include image data, consistent with disclosed embodiments. In some embodiments, the image data may include a mesh rendering that represents the external surface of all objects. In some embodiments, a scene may include a plurality of preexisting image elements. Image elements may include, for example, at least one of a voxel, a point, or a polygon. In some embodiments, the system may generate a set of polygons, the individual polygons being basic elements. As another example, if the system generates a point cloud, then individual points may be image elements. If a mesh includes a plurality of voxels representing a scene or a voxel-mapping of a subset of space, then a voxel may be an image element. A voxel may be a closed n-sided polygon (e.g., a cube, a pyramid, or any closed n-sided polygon). Voxels in a scene may be uniform in size or non-uniform. Voxels may be consistently shaped within a scene or may vary in a scene.

Basic elements may be further subdivided in some cases. For example, the system may generate a mesh comprised of a plurality of n-sided polygons as image elements, and one or more polygons may be subdivided into additional polygons to improve resolution or for other reasons. While the present disclosure provides examples of basic image elements, it should be noted that aspects of the disclosure in their broadest sense, are not limited to the disclosed examples.

In some embodiments, the system may segment the scan to identify at least one object in the scene. The objects may be, for example, a chair, a phone, a desk, and/or any other object present in the scene. The scan may be segmented to identify each object individually in the scene. In some instances, segmentation may use a higher resolution in the mesh to be able to identify smaller objects (e.g. cups or pens). For example, a scene object may include points, voxels, or polygons associated with an object such as a table, a surface of a table, a leg of a table, etc. Segmenting may include mapping large numbers of points or polygons (e.g., hundreds of thousands of polygons) to one or more objects in the scene. As an example, the system may segment a scene comprising a scan of a living room into a plurality of scene objects, such as a chair, a doorknob, a handle, a cup, a utensil, a shoe, a wall, a leaf of a plant, a carpet, a television, a picture frame, etc. While the present disclosure provides examples of segmenting, it should be noted that aspects of the disclosure in their broadest sense, are not limited to the disclosed examples.

In some embodiments, the system may extract image data corresponding to the identified object from the scan. Extracting image data may include tagging, labeling, identifying or otherwise classifying one or more identified objects of a scanned scene based on shape data, color data, semantic data, or any other data. In an exemplary embodiment, an extracted image data may include a classification for the identified object in the scanned scene. In this example, “furniture,” “Chair,” “office chair” may all be classes of an object, including classes of the same object. As will be apparent to one of skill in the art, classes may be defined in a hierarchy of classes that are broader or narrower relative to each other. For example, a “furniture” class may be broader than a “chair” class, which may be broader than an “office chair” class. Extracting image data may include identifying the image elements corresponding to or associated with an object. Thus, for example, extracting image data for a chair may include identifying a group of points, polygons, voxels, etc. associated with the chair object in the scan of the scene. Once that group is identified, image data associated with the chair can then be extracted (e.g., identified as being unique from other image data in the scene.) Extraction does not necessarily mean that the image of the chair is removed from the scene (although in some embodiments that might occur.) Rather, by identifying the chair and its associated information as being unique from other image information in the scene, the image data associated with the chair can then be differentiated from other image data in the scene for searching purposes, and in this context the image data corresponding to the identified object is said to be “extracted.”

In some embodiments, extracted image data may include semantic tags associated with at least one objects of a scanned scene. The system may generate a semantic tag for the at least one identified object in the scanned scene. For example, “table,” “shelf,” and “chair” may be each be a semantic tag associated with the corresponding table, shelf, and chair objects that are identified in a scene. The semantic tag may include a list of identified objects in the scene. For example, the semantic tag may include “table, shelf and chair.”

The disclosed system may also receive as an input and/or generate a spatial semantic graph of the received 3D scene. The spatial semantic graph may disclose spatial relationships between the identified objects in the scanned scene. The semantic tag may include one or more spatial semantic graphs. A spatial semantic graph may include a list of objects in the scene, along with a description of their spatial relationship. For example, the spatial semantic graph may include relationships such as “chair, near, table,” “chair, near, shelf,” “chair, under, desk,” “trash can on the floor,” “bottle on the table,” “lamp hanging from ceiling,” or “chair below lamp.” The system may segment a scene assign semantic tags to individual objects. The system may also generate spatial semantic graphs based on the spatial relationships between the individual objects. Further, the system may infer the scene “environment” based on the detected objects and their image data. For example, the system may infer from the semantic tag including “chair, near, table” and/or from the spatial semantic graphs “chair, near, shelf” that the scanned scene is likely that of an office environment. The system may also draw a similar inference based on the 3D images of the identified objects. While the present disclosure provides examples of extracting image data, classifying, spatial semantic tags and graphs, etc., it should be noted that aspects of the disclosure in their broadest sense, are not limited to the disclosed examples.

In some embodiments, the system may access a data structure. Exemplary data structures, consistent with the embodiments of this disclosure, are described above. In some embodiments, the at least one data structure may include 3D scenes associated with semantic tags or one or more spatial semantic graphs. For example, the spatial semantic graphs and semantic tags associated with the scene may textually represent the scene in words. The disclosed system may compare the spatial semantic graphs of the received 3D scene with spatial semantic graphs of the 3D scenes in the data structure. Consistent with embodiments of this disclosure, the system may perform the comparison using one or more of the techniques for comparing objects and/or image data discussed above. The system may identify one or more 3D scenes having the closest or most similar spatial semantic graphs. The system may determine closeness or similarity based on a statistical similarity such as a covariance, a least-squares distance, a distance between vectors associated with image elements (e.g., feature vectors), or a Hausdorff distance between aligned objects. In some embodiments, the system may determine the closeness or similarity based on a comparison of feature vectors associated with the 3D scenes. By learning from many example spatial semantic graphs, the system may suggest likely objects to add to the scene. For example, in an office environment described by the spatial semantic graphs described by office chair→near table, a whiteboard→on→wall, a laptop→connected to→screen, and screen→on→table, the system may determine that coffee mug→on→table is a likely addition to the scene. The system may make this determination because the spatial semantic graph of the input scene may be similar to the spatial semantic graphs of a family of scenes existing in the data structure, in many of which a coffee mug may be located on the table.

In some embodiments, the at least one processor may be configured to segment the 3D scenes in the data structure into objects. The at least one processor may employ one or more techniques of segmenting a scene into objects as described above, consistent with embodiments of this disclosure. The at least one processor may segment both the received scene and the 3D scenes stored in the data structure. The at least one processor may perform a single-object search using the objects segmented from the 3D scenes of the data structure. Thus, for example, the at least one processor may compare the identified object from the received scene with the objects segmented from the 3D scenes of the data structure. Consistent with embodiments of this disclosure, the system may perform the comparison using one or more of the techniques for comparing objects and/or image data discussed above. As discussed above, the at least one processor may use one or more statistical similarity measures to identify objects segmented from the 3D scenes of the data structure that may be similar to the identified object. The at least one processor may identify tags corresponding to the objects from the 3D scenes of the data structure that may be similar to the identified object.

Additionally or alternatively, in some embodiments, the at least one processor may generate spatial semantic graphs for each scene as a mathematical graph having as vertices the segmented objects of that scene and the tags corresponding to the segmented objects. The edges of the graph may be marked by the 3D-difference vector between the center of masses of the objects on the respective vertices, or the minimal distance between the objects, or any other spatial derivative of the relative locations of the objects. The at least one processor may also determine a distance between semantic graphs of two scenes as a weighted sum of the distances between feature vectors of the objects matching the vertices, the textual similarity of the tags appearing at each vertex and a sum of the differences between the vectors appearing on the edges of the two graphs with matching end vertices. The distance between spatial semantic graphs depends on the initial partial matching between the vertices of the two graphs. The at least one processor may optimize to find the best matching, for example by using optimization algorithms (e.g. genetic algorithms).

In some embodiments, complementary objects may be selected from a scene from the data structure that has a semantic graph having a closest distance to the semantic graph of the received scene. For example, the at least one processor may identify objects in the scene from the data structure that are not present in the received scene and select one or more of the identified objects as complementary objects. The at least one processor may also suggest a placement location for the one or more complementary objects based on a relative location of those objects to other objects in the scene from the data structure. In some embodiments, the user may be able to move the complementary objects to a different location.

In some embodiments, the at least one processor may be configured to use the extracted image data to search at least one data structure to identify at least one image of at least one complementary object to the identified object. Once an object such as a chair is extracted it can be compared with data in the data structure to either identify the object particularly or by class, and/or to identify complementary objects. For example, a complimentary object to a drinking glass identified on a table, may be a beverage bottle, if the data structure includes historical information associating drinking glasses with beverage bottles. If the contents of the drinking glass are the color orange, the identified complementary object may be a container of orange juice. If the contents of the drinking glass are dark, an identified complementary object may be a cola bottle.

As discussed above, classification may include a type of scene-component. For example, “furniture,” “chair,” “office chair” may all be classes of an object, including classes of the same object. As will be apparent to one of skill in the art, classes may be defined in a hierarchy of classes that are broader or narrower relative to each other. For example, a “furniture” class may be broader than a “chair” class, which may be broader than an “office chair” class. Consistent with embodiments of this disclosure the data structure may include 3D objects associated with semantic tags, which may include classifications for each object such as “table,” “shelf,” or “chair.” Each 3D object in the data structure may also be associated with an environment or 3D scene, such as “office,” “living room,” or “kitchen.” Each 3D object or 3D scene may also be associated with one or more complementary objects based on a classification and/or an environment of the object. For example, a 3D object in the data structure may be associated with “office” environment within a “chair,” classification and complementary objects associated with such a 3D object in the “office” environment may include, for example, a file cabinet, clock, or phone. By comparing the extracted image data to the data structure, the system as a result may identify at least one image of at least one complementary object to an identified object.

In some embodiments, the system may use semantic data and may compare the semantic tag of the identified object with semantic tags for objects stored in the at least one data structure and may select at least one complementary object based on that comparison. Consistent with embodiments of this disclosure, the system may perform the comparison using one or more of the techniques for comparing objects and/or image data discussed above. For example, the system may search the extracted data of an identified object, such as a chair, in a scanned scene,. The system may then infer that the chair is in an office environment, based on other identified objects around the chair. From this inference, the system may assign a semantic tag to the chair to indicate that it belongs in the classification of “chair” in an office environment. The system may then search the data structure to identify data structure scenes including objects with similar semantic tags (e.g. chairs in office environments). The disclosed system may identify complementary objects present in the identified data structure scenes. For example, the system may identify at least one image of at least one complementary object, such as a file cabinet in a data structure scene. While the present disclosure provides examples of identifying or selecting a complementary object, the examples are provided as a mechanism to illuminate the broader concepts of the disclosure and are not intended to limit the broader disclosure.

In some embodiments, after the system has identified at least one complementary object to the identified object, the system may obtain from the at least one data structure a 3D representation of the at least one complementary object. The 3D representation may include an actual image of a complementary object or a reproduction of the same. For example, the reproduction may be based on one or more Computer Aided Design (CAD) models corresponding to one or more objects. The CAD model may include image elements, consistent with disclosed embodiments. For example, the CAD model may include a mesh, a point cloud, a voxel-mapping of a 3D space, and/or any other mapping that may be configured to present a graphical depiction of an object. The system may also obtain other representations of the at least one complementary object such as, for example, a 2D representation. While the present disclosure provides examples of obtaining a representation of a complementary object, it should be noted that aspects of the disclosure in their broadest sense, are not limited to the disclosed examples.

In some embodiments, the system may be configured to automatically generate a hybrid scene by combining the 3D representation of the at least one complementary object with portions of the scan of the scene other than portions corresponding to the identified object. Consistent with the present disclosure, generating a hybrid scene may include combining the 2D or 3D representation of the complementary object with the 3D representation of the scene. For example, the system may position the complementary object at a location not occupied by the identified object. The system may also scale the complementary object to the scale of the scene. It may do so by identifying relative dimensions of an object identified in the scene to the complementary object, and then adjusting the size of the complementary object accordingly for insertion into the scene. The system may also position the complementary object in an orientation consistent with that of the identified object, based on relative orientation information in the data structure.

Generating the hybrid scene may include using image processing techniques (e.g., adjusting brightness, adjusting lighting, implementing a gradient domain method, etc.), consistent with disclosed embodiments. As one of skill in the art will appreciate, a gradient domain method may include constructing a new image by integrating the gradient of image elements associated with the complementary object with the image elements of the received scene. It is further contemplated that the system may combine any number of 3D representations of any number of complementary objects into the hybrid scene. Additionally or alternatively, the at least one processor may employ one or more techniques of combining two images discussed above, consistent with embodiments of this disclosure.

In some embodiments, the system may output the hybrid scene for presentation on a display device. Outputting the hybrid scene may include storing and/or transmitting the hybrid scene to a user or client device or displaying the hybrid scene at an interface of the system, consistent with disclosed embodiments. Transmitting may include transmitting over a network by any known method, consistent with disclosed embodiments. For example, the system may broadcast a hybrid scene (i.e., transmit to a plurality of user or client devices via a network), and/or store a modified scene in memory. While the present disclosure provides examples of outputting a hybrid scene, it should be noted that aspects of the disclosure in their broadest sense, are not limited to the disclosed examples.

In some embodiments, the disclosed system may recommend a plurality of locations in the received scene for inserting the 3D representation of the at least one complementary object. In some embodiments, the disclosed system may be configured to allow a user of the system to interact with the display device to manipulate the hybrid scene. By way of example, the system may combine a CAD model of a file cabinet into a scanned scene of an office. The system may recommend locating, for example, the file cabinet adjacent to a table or a chair in the received scan of the scene. The disclosed system may be configured to receive input from a user regarding a location for the complementary object. The disclosed system may be configured to generate a hybrid scene by combining the 3D representation of the complementary object with the image data of the scene to position the complementary object at the location selected by the user.

In some embodiments, the disclosed system may further allow the user to manipulate the hybrid scene. For example, the disclosed system may enable a user to move, scale, orient, change lighting characteristics of, etc. the complementary object in the hybrid scene using one or more exemplary input devices as discussed with respect to FIG. 2 below. Thus, for example, a user may be able to move the file cabinet within the scanned scene to a desired. location (e.g. adjacent the table or adjacent the chair).

In some embodiments, the at least one image of at least one complementary object may include a plurality of images of a complementary object. For example, a search for a complementary object may yield multiple images of the complementary object. In this example, the disclosed system may display the multiple images on a display device. The system may display the multiple images in a manner similar to that discussed above with regard to outputting the hybrid scene on a display device. In another example, the search for a complementary object may yield more than one complementary object associated with an identified object in the received scene. The disclosed system may be configured to display a plurality of images corresponding to the plurality of complementary objects on a display device.

In some embodiments, the system may be configured to output for display an index of the plurality of images of the plurality of complementary objects. An index may include a number, text, a symbol, etc. representing a corresponding image of a complementary object. The disclosed system may display the plurality of images of the complementary objects together with their respective indices on a display device.

In some embodiments, the system may be configured to receive, from a user, a selection of at least one complementary object and insert the selection into the scan of the scene. For example, as discussed above, in some embodiments, the disclosed system may display a plurality of images of one complementary object on a display device. The disclosed system may be configured to receive from a user a selection of one or more of the displayed images. It is also contemplated that the disclosed system may be configured to receive from the user an indication of one or more locations in the received scene where the user wishes to insert the selected images. The user may make the selection using one or more input/output devices associated with one or more exemplary user or client devices as described below in connection with FIG. 2. For example, the user may select the one or more images by clicking on the images using an input device. Likewise, for example, the user may select one or more locations in the received scene by pointing to the locations and clicking using an input device.

As also discussed above, in some embodiments, the disclosed system may display a plurality of complementary objects and/or associated indices on a display device from the displayed indices. The disclosed system may be configured to receive from a user a selection of one or more of the displayed complementary objects. It is also contemplated that the disclosed system may be configured to receive from the user an indication of one or more locations in the received scene where the user wishes to insert the selected complementary objects. The user may make the selection using one or more exemplary input/output devices associated with one or more exemplary user or client devices as described below in connection with FIG. 2. The disclosed system may receive the one or more selections and generate a hybrid scene by combining the 3D representations of the one or more user selected complementary objects with the scan of the received scene. While the present disclosure provides examples of receiving a user selection, it should be noted that aspects of the disclosure in their broadest sense, are not limited to the disclosed examples.

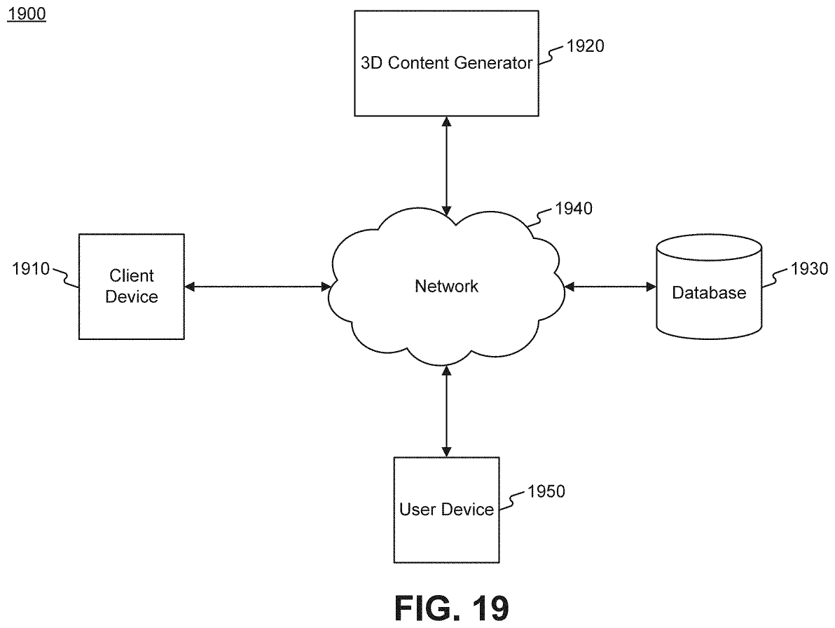

FIG. 19 depicts an exemplary system 1900 for generating 3D content, consistent with embodiments of the present disclosure. As illustrated in FIG. 19, system 1900 may include a client device 1910, a 3D generator 1920, a data structure 1930, and/or a user device 1950. Components of system 1900 may be connected to each other via a network 140. In some embodiments, aspects of system 1900 may be implemented on one or more cloud services. In some embodiments, aspects of system 1900 may be implemented on a computing device, for example, a mobile device, a computer, a server, a cluster of servers, a plurality of server clusters, and the like.

As will be appreciated by one skilled in the art, the components of system 1900 may be arranged in various ways and implemented with any suitable combination of hardware, firmware, and/or software, as applicable. For example, as compared to the depiction in FIG. 19, system 1900 may include a larger or smaller number of client devices, 3D generators, data structures, user devices, and/or networks. In addition, system 1900 may further include other components or devices not depicted that perform or assist in the performance of one or more processes, consistent with the disclosed embodiments. The exemplary components and arrangements shown in FIG. 19 are not intended to limit the disclosed embodiments.

In some embodiments, client device 1910 may be associated with a game designer, a data manager, an advertiser, an advertising agent, and/or any other individual or organization that may generate 3D content. Client device 1910 may include one or more memory units and one or more processors configured to perform operations consistent with disclosed embodiments. In some embodiments, client device 1910 may include hardware, software, and/or firmware modules. Client device 1910 may include a mobile device, a tablet, a personal computer, a terminal, a kiosk, a server, a server cluster, a cloud service, a storage device, a specialized device configured to perform methods according to disclosed embodiments, or the like. Client device 1910 may be configured to receive user inputs (e.g., at an interface to display information (e.g., images and/or text), to communicate with other devices, and/or to perform other functions consistent with disclosed embodiments.

3D generator 1920 may include a computing device, a computer, a server, a server cluster, a plurality of server clusters, and/or a cloud service, consistent with disclosed embodiments, 3D generator 1920 may include one or more memory units and one or more processors configured to perform operations consistent with disclosed embodiments. 3D generator 1920 may be configured to receive data from, retrieve data from, and/or transmit data to other components of system 1900 and/or computing components outside system 1900 (e.g., via network 1940).

Data structure 1930 may be hosted on one or more servers, one or more clusters of servers, or one or more cloud services. In some embodiments, data structure 1930 may be a component of 3D generator 1920 (not shown). Data structure 1930 may include one or more data structures configured to store images, video data, image object information, image object identifiers, semantic tags, metadata, labels, and/or any other data. Data structure 1930 may be configured to provide information regarding data to another device or another system. Data structure 1930 may include cloud-based data structures or on-premises data structures.

User device 1950 may be any device configured to receive and/or display a media content frame, including VR, AR, and/or MR data. For example, user device 1950 may include a mobile device, a smartphone, a tablet, a computer, a headset, a gaming console, and/or any other user device. In some embodiments, user device 1950 may be configured to receive and/or display a broadcast. User device 1950 may include one or more memory units and one or more processors configured to perform operations consistent with disclosed embodiments. In some embodiments, User device 9 may include hardware, software, and/or firmware modules. At least one of client device 1910, 3D generator 1920, and/or user device 1950 may be configured to perform one or more of the methods of generating 3D content consistent with disclosed embodiments.

One or more of client device 1910, 3D generator 1920, data structure 1930, and/or user device 1950 may be connected to network 1940. Network 1940 may be a public network or private network and may include, for example, a wired or wireless network, including, without limitation, a Local Area Network, a Wide Area Network, a Metropolitan Area Network, an IEEE 1002.11 wireless network (e.g., “Wi-Fi”), a network of networks (e.g., the Internet), a land-line telephone network, or the like. Network 1940 may be connected to other networks (not depicted in FIG. 19) to connect the various system components to each other and/or to external systems or devices. In some embodiments, network 1940 may be a secure network and require a password to access the network. While the present disclosure provides an exemplary description of system 1900, it should be noted that aspects of the disclosure in their broadest sense, are not limited to the disclosed examples.

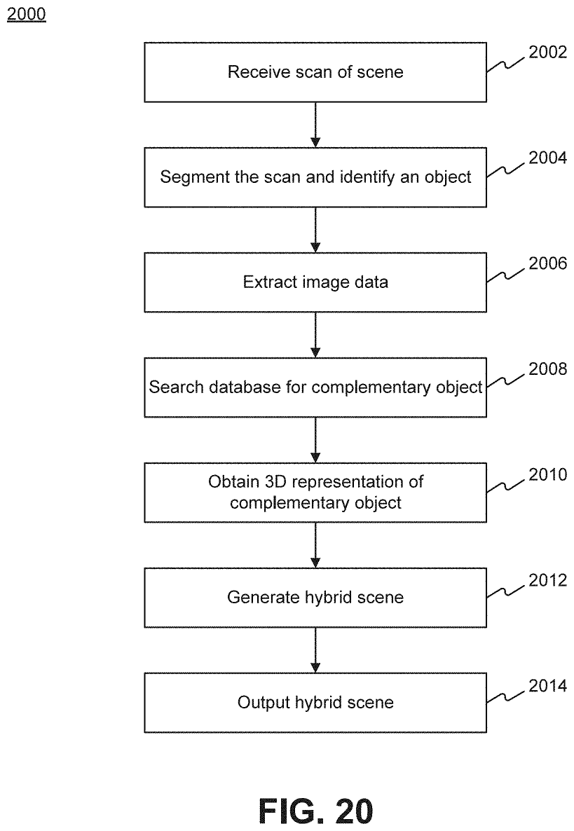

FIG. 20 depicts exemplary method 2000 of automating 3D content creation, consistent with disclosed embodiments. The order and arrangement of steps of method 2000 is provided for purposes of illustration. As will be appreciated from this disclosure, modifications may be made to method 2000 by, for example, adding, combining, removing, and/or rearranging the steps of method 2000. Steps of method 2000 may be performed by components of system 1900, including, but not limited to, 3D generator 1920. For example, although method 2000 may be described as steps performed by 3D generator 1920, it is to be understood that client device 1910 and/or user device 1950 may perform any or all steps of method 2000. As one of skill in the art will appreciate, method 2000 may be performed together with any other method described herein. In some embodiments, process 2000 may be performed together with steps of process 2100 and/or 2200. Process 2000 may be performed in real-time to alter an ongoing transmission of media content (e.g., a broadcast of a scene), consistent with disclosed embodiments.

At step 2002, system 1900 may receive a scan of a scene, which may be received or retrieved from a data storage, consistent with disclosed embodiments. A scene may be received from another component of system 1900 and/or another computing component outside system 1900 (e.g., via network 1940). A scene may be retrieved from a memory (e.g., memory 206), data structure (e.g., data structure 1930), or any other computing component. A scene may be based on image captured by one or more cameras and or scanners (i.e., a scan), consistent with disclosed embodiments.

At step 2004, system 1900 may segment the scan of the scene, consistent with disclosed embodiments. As described above, segmenting may include partitioning (and/or classifying) image elements of a scene into scene objects. In some embodiments, step 2004 may include generating a mesh, point cloud, or other representation of a scene. The scan may be segmented to identify each object individually in the scene and may use a higher resolution in the mesh to be able to identify smaller objects.

At step 2006, system 1900 may extract image data corresponding to the objects that are segmented and identified from the scan of the scene, consistent with disclosed embodiments. Image data may include tagging, labeling, identifying or otherwise classifying one or more identified objects of a scanned scene based on shape data, color data, semantic data, or any other data. The extracted image data may include, for example, a portion of a mesh, point cloud, voxels, etc. associated with each segmented object.

At step 2008, system 1900 may search an object data structure 1930 for complementary objects that correspond with the identified object at step 2004, consistent with disclosed embodiments. By using the extracted image data of the identified object, the system 1900 may search for similar objects in the data structure 1930 to identify associated complementary objects. In some embodiments, system 1900 may search for scenes similar to the received scene. The object data structure 1930 may include 3D scenes, 3D models, 2D models, image data, CAD models, classifications by object or environment, semantic tags, or any other data related to objects or 3D scenes. The data structure 1930 may include 3D scenes and/or 3D objects associated with semantic tags. It is further contemplated that system 1900 may search multiple data structures. Each search result may include any number of associated complementary objects which system 1900 may identify and suggest to a user of system 1900.

At step 2010, system 1900 may obtain a 3D representation of a complementary object from the data structure 1930, consistent with disclosed embodiments. The 3D representation may include one or more Computer Aided Design (CAD) models corresponding to one or more objects. The system may also obtain other representations of the at least one complementary object such as a 2D representation. These representations may be displayed to a user of the system as suggestions of complementary objects for user selection in a hybrid scene. The representation of the complementary object may be displayed to a user any time after the representation is obtained from the data structure 1930 at step 2010.

At step 2012, system 1900 may generate a hybrid scene by combining the 3D representation of the complementary object with the portions of the scan of the scene other than portions corresponding to the originally identified object, consistent with disclosed embodiments. It is further contemplated that system 1900 may repeat steps 2008, 2010, and 2012 of method 2000 to combine any number of 3D representations of any number of complementary objects into the hybrid scene.

At step 2014, system 1900 may output the hybrid scene in an interface of the system 1900, such as client device 1910 or user device 1950, consistent with disclosed embodiments. If a user of the system 1900 desires to modify the hybrid scene with a different complementary object or additional complementary object, the system 1900 may repeat any of the steps of method 2000 to obtain a new 3D representation of a complementary object and combine it with the received or hybrid scene.

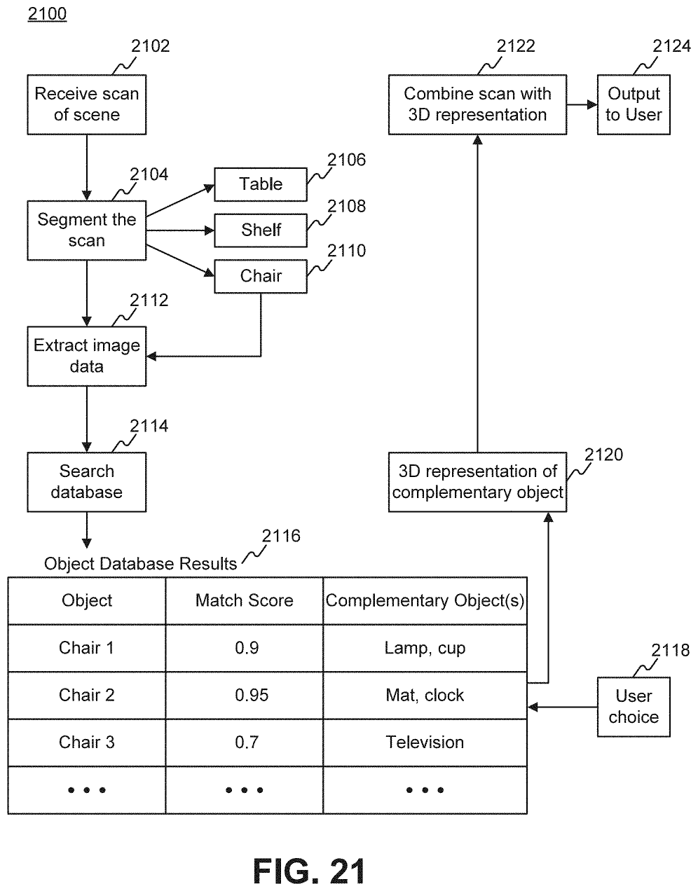

FIG. 21 depicts an exemplary method 2100 of automating 3D content creation, consistent with embodiments of the present disclosure. The order and arrangement of steps of method 2100 is provided for purposes of illustration. As will be appreciated from this disclosure, modifications may be made to method 2100 by, for example, adding, combining, removing, and/or rearranging the steps of method 2100. Steps of method 2100 may be performed by components of system 1900, including, but not limited to, 3D generator 1920. For example, although method 2100 may be described as steps performed by 3D generator 1920, it is to be understood that client device 1910 and/or user device 1950 may perform any or all steps of method 2100. As one of skill in the art will appreciate, method 2100 may be performed together with any other method described herein. In some embodiments, process 2100 may be performed together with steps of process 2000 and/or 2200. Process 2100 may be performed in real-time to alter an ongoing transmission of media content (e.g., a broadcast of a scene), consistent with disclosed embodiments.

At step 2102, system 1900 may receive a scan of a scene, consistent with disclosed embodiments. The scene may be a 2D or 3D scene. A scene may be received from another component of system 1900 and/or another computing component outside system 1900 (e.g., via network 1940). A scene may be retrieved from a memory (e.g., memory 206), data structure (e.g., data structure 1930), or any other computing component. A scene may be based on image captured by one or more cameras (i.e., a scan), consistent with disclosed embodiments.

At step 2104, 3D generator system may segment the received scene, consistent with disclosed embodiments. As described herein, segmenting may include partitioning (i.e., classifying) image elements of a scene into identified scene-components or identified objects such as table 2106, shelf 2108, chair 2110, and/or other components or objects. In some embodiments, step 2104 may include generating a mesh, point cloud, or other representation of a scene. The scan may be segmented to identify each object individually in the scene and may use a higher resolution in the mesh to be able to identify smaller objects.

At step 2112, system 1900 may extract image data, consistent with disclosed embodiments. Image data may include tagging, labeling, identifying or otherwise classifying one or more identified objects of a scanned scene based on shape data, color data, semantic data, or any other data.

At step 2114, system 1900 may search an object data structure 1930 based on the extracted image data from step 2112, consistent with disclosed embodiments. By using the extracted image data of the identified object, the system 1900 may search for similar objects in the data structure 1930 to identify associated complementary objects. The object data structure 1930 may include 3D models, 2D models, image data, CAD models, classifications by object or environment, semantic tags, or any other data related to objects or 3D scenes. The data structure 1930 may also include 3D scenes and/or 3D objects associated with semantic tags. It is further contemplated that system 1900 may search multiple data structures to search the extracted image data. System 1900 may generate a “match score” (e.g., “0.95”) for any number of search results. The match score may indicate a degree of similarity between the identified object (e.g., “Chair”) and the object searched (e.g., “Chair 2”) in the data structure 1930. Each search result may include any number of associated complementary objects (e.g., “Mat, clock”) which system 1900 may identify and suggest to a user of system 1900. For example, system 1900 may identify “Lamp” or “cup” as complementary objects to Chair 1. The higher the “match score,” the more likely that the object searched may be similar to the identified object such as chair 2110.

At step 2118, system 1900 may receive a user selection, consistent with disclosed embodiments. The user may view the data structure search results of step 2116 and make a selection of at least one complementary object. When the user of system 1900 views the data structure search results of step 2116, the system 1900 may be configured to display to the user a plurality of images of one complementary object to allow a user to view and select one or more of the plurality of images for insertion into the received scene. In other embodiments, the system 1900 may be configured to display an index of the plurality of images of a plurality of complementary objects to allow a user to view and select one or more complementary objects for insertion into the received scene.

At step 2120, system 1900 may obtain a 3D representation of the user-selected image of a complementary object or of a user-selected complementary object, from the data structure 1930, consistent with disclosed embodiments. The 3D representation may include one or more Computer Aided Design (CAD) models corresponding to one or more complementary objects. The system 1900 may also obtain other representations of the at least one complementary object such as a 2D representation.

At step 2122, system 1900 may generate a hybrid scene by combining the 3D representation with portions of the scan of the scene that do not include the identified object. (e.g., “Chair” 2110), consistent with disclosed embodiments. In this way, system 1900 may generate and insert one or more additional complementary objects into the hybrid scene. It is further contemplated that system 1900 may repeat any of the steps in method 2100 to combine any number of 3D representations of any number of complementary objects into the hybrid scene.

At step 2124, system 1900 may output the hybrid scene for display through an interface of system 1900. For example, system 1900 may output the hybrid scene for display on client device 1910 or user device 1950, consistent with disclosed embodiments. It is further contemplated that the output of the hybrid scene at step 2124 may be for final display or may be displayed for additional user input to repeat any of the steps in method 2100 to obtain a new 3D representation of a complementary object.

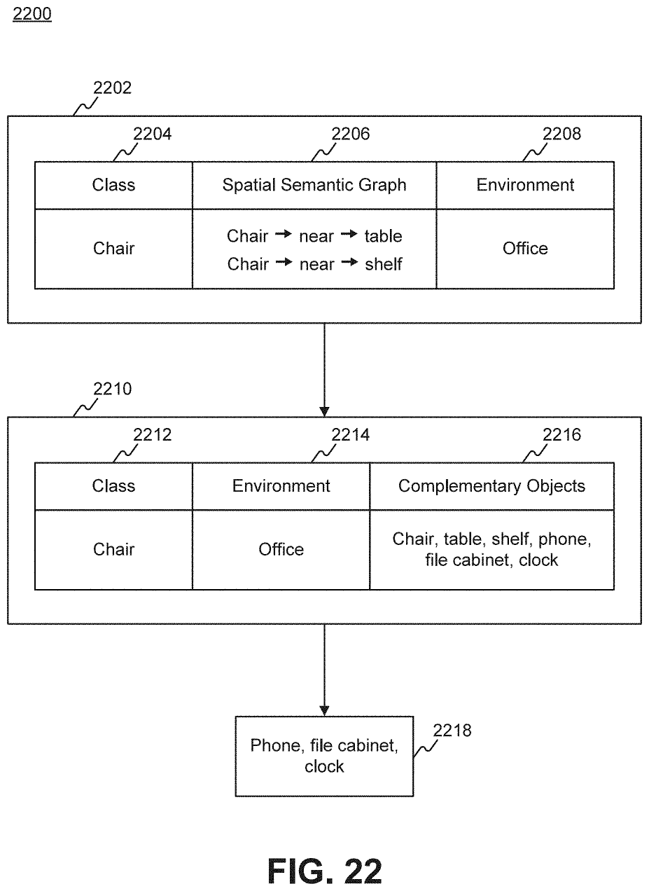

FIG. 22 depicts an exemplary method 2200 of identifying at least one complementary object, consistent with embodiments of the present disclosure. Method 2200 illustrates another embodiment of identifying complementary objects for an identified object using a semantic tag. The order and arrangement of steps of method 2200 is provided for purposes of illustration. As will be appreciated from this disclosure, modifications may be made to method 2200 by, for example, adding, combining, removing, and/or rearranging the steps of method 2200. Steps of method 2200 may be performed by components of system 1900, including, but not limited to, 3D generator 1920. For example, although method 2200 may be described as steps performed by 3D generator 1920, it is to be understood that client device 1910 and/or user device 1950 may perform any or all steps of method 2200. As one of skill in the art will appreciate, method 2200 may be performed together with any other method described herein. In some embodiments, process 2200 may be performed together with steps of process 2000 and/or 2100. Process 2200 may be performed in real-time to alter an ongoing transmission of media content (e.g., a broadcast of a scene), consistent with disclosed embodiments.

In FIG. 22, system 1900 may generate identified object semantic tag 2202 to associate with an identified object such as a chair 2110 in a scan of a scene. The identified object semantic tag 2202 may include any extracted image data corresponding to the identified object, such as semantic data, shape data, color data, or any other data. In this exemplary embodiment, identified object semantic tag 2202 includes a classification 2204, a spatial semantic graph 2206, and environment 2208. The system 1900 may segment the scan of a scene to identify and classify that the identified object belongs in the class of “Chair.” In addition, system 1900 may also generate spatial semantic graphs 2206, which includes spatial relationships between various objects identified in the scan of a scene. Spatial semantic graph 2206 may contain a single spatial relationship, or a plurality of spatial relationships for each identified object. System 1900 may generate the spatial semantic graph 2206 or may receive the spatial semantic graph 2206 as an input from a user of system 1900. Furthermore, spatial semantic graph may include a list of objects in the scene (e.g., “chair, table, shelf”). Based on the classification 2204 and spatial semantic graph 2206, system 1900 may be configured to infer the environment 2208 of the identified object, such as an “office” or “living room.” The environment 2208 may also be received as an input from a user of system 1900.

In some embodiments, the data structure 1930 may include 3D scenes and objects associated with data structure object semantic tags 2210. The data structure object semantic tags 2210 similarly may include semantic data, shape data, color data, or any other data. The exemplary embodiment in FIG. 22 illustrates a data structure object semantic tag 2210 with a classification 2212, and environment 2214, and complementary objects 2216. System 1900 may compare the identified object semantic tag 2202 with data structure object semantic tags 2210. For example, system 1900 may search for a classification 2212 of “chair” in an “office” environment 2214 when it has inferred that the identified object is an “office” “chair” in the identified object semantic tag 2202. In this comparison, the system 1900 may identify complementary objects 2216 associated with typical office chairs. Based on the comparison between the identified object semantic tag 2202 and the data structure object semantic tag 2210, the system 1900 may output additional complementary objects 2216 in the form of a suggested complementary object 2218 (e.g., “file cabinet,” “phone,” or “clock”) for user selection.

The suggested complementary object 2218 may be displayed to a user of system 1900 consistent with disclosed embodiments. For example, the suggested complementary object 2218 may display a single suggested complementary object 2218 or a plurality of suggested complementary objects 2218. System 1900 may also display an index of a plurality of images of a plurality of suggested complementary objects 2218. The system 1900 may obtain 3D representations of the user selected suggested complementary objects 2218 from data structure 1930, consistent with method 2000 and method 2100.

Aspects of the present disclosure relate to computer-implemented advertising bidding systems for use in virtual reality (VR), augmented reality (AR), and mixed reality (MR) technology and applications. The present disclosure provides a solution to a new kind of advertising within AR, VR, and MR technology and applications (as well as conventional 2D applications) to deliver accurate and effective targeting of advertisements and matching real-time consumer intent to a real-time market advertisement inventory or real-time generated supply. While the present disclosure provides examples of AR, VR, and MR technologies and applications, it should be noted that aspects of the disclosure in their broadest sense are not limited to particular examples. Rather, it is contemplated that the foregoing principles may be applied to other computerized-reality technologies and applications and conventional 2D applications as well.

The disclosed system may be configured to understand the “environment” of the scene, e.g. office scene, sports club, beach etc. A scene may be a broadcast scene associated with, for example, a virtual reality environment, an augmented reality environment, a mixed reality environment, a 3D videogame environment, a 3D movie, an online advertisement, a 3D scan, a 3D still or video camera image or images, 2D media, etc.

The disclosed system may describe the spatial relations between the detected objects in the scene by way of, for example, a spatial semantic graph. For each scene the system may generate a spatial semantic graph. The system may compare the generated graph with the spatial semantic graphs of scenes stored in a data structure. Consistent with embodiments of this disclosure, the system may perform the comparison using one or more of the techniques for comparing objects and/or image data discussed above. The system may identify one or more scenes from the data structure having a spatial semantic graph similar to that of the scene in the broadcast video. The system may also deduce information about the broadcast scene (e.g. an environment associated with the scene) based on the identified scenes in the data structure. For example in the data structure we can assume that the scenes are tagged with semantic information.

The present disclosure also generally relates to bidding to insert 2D or 3D content into preexisting 2D or 3D broadcast scenes. While this disclosure is intended to apply equally to 2D and 3D implementations, for ease of discussion, the 3D implementation is often referred to below. Reference to 3D examples are not to be interpreted as limiting of this disclosure.

Bidding includes offering something of value (e.g., money) in exchange for inserting content. Bidding may involve specifying aspects of a bid itself (e.g., an offer-period in which a bid may be accepted). Bidding may involve specifying aspects of inserted content, such as the timing, an intended audience, a duration, a monetary value, or any other aspect of inserted content. In some embodiments, bidding might involve an object (e.g., car, bottle, chair, door), a scene type (e.g., office, living room, art gallery), a time (e.g., between 1 PM-2 PM) or/and targeted to a specific place (e.g., New York City, 5th Avenue), or a class of user (i.e., a class of viewer).

Consistent with the present embodiments, bidding may be in real-time. For example, bidding may occur during a transmission to an online audience or other broadcast. The disclosed system may be configured to determine, based on a scene analysis or an analysis of an object in a scene, which objects, scenes, or elements within the scene match an inventory or a real-time market supply. Consistent with disclosed embodiments, matching may be performed based on a plurality of extracted data or features of a scene, an inventory, or a real-time market supply.

The present disclosure may also relate to advertising. The system may pass the environment of the scene to the advertisers, to determine whether the scene environment may be compatible with their advertising strategy. Advertising, from a broad perspective, includes acts of displaying information for audiences through a medium, which may include displaying specific information for a specific audience through a particular medium. Display banners, images, videos, 3D models, 3D filters, audio, or textual clickable ads are all types of advertisement units that may be targeted for specific audience segments, or even highly personalized for a specific user. The advertising industry may invest significant effort in the study of a particular media for specific audiences and their use of targeted advertising through various analysis techniques, such as incorporating big data analysis, user interactions analysis and various types of machine learning optimization techniques.

The present disclosure may relate to broadcasting AR, VR, and MR technologies. Broadcasting as used in this disclosure may include transmission to a plurality of individuals over a network. For example, broadcasting may include transmission to many players playing a multi-player game or many viewers watching a sporting event. In general, broadcasting may include transmissions to viewers exposed to a same or similar view of a real or virtual scene. Broadcasting may include transmission over the internet, cable TV, or any other medium for transmitting data to targeted users, or many users simultaneously.

In some embodiments, an advertiser object may be inserted in a transmission to all individuals receiving a broadcast. In some embodiments, an advertiser object may be inserted in a transmission to a subset of individuals receiving a broadcast. For example, an advertiser object may be inserted into or excluded from a viewer transmission based on properties of a viewer such as age and gender, viewer preferences, a viewer's history of prior consumed content, properties of a viewer's environment such as time of day, country, or language, etc.

In the following description, various specific details are given to provide a more thorough understanding of the present disclosure. However, for a skilled person it will be apparent that the present disclosure may be practiced without one or more of these details.

The present disclosure is intended to provide systems and methods to target advertising to specific audiences or specific users. The application may be used in an environment consumed through a device equipped with AR, MR, or VR application. The disclosure enables a novel way to match an observed scene or a portion of a scene, with a real-time bidding system that associates a value to a given object or objects that may be advertised within the AR, MR, VR or 2D consumed scene.

The bidding system enables advertisers or advertisements agents to bid or to associate a suggested value with a given object in a preexisting 2D or 3D broadcast scene. Associating a value may be accomplished with/or without specific filters such as time, place, scene descriptions, etc. The bidding system may push specific objects or portions of scenes to the advertisers or advertisements agents to enable them to associate their advertisement unit (e.g., a banner, an image, a video or a 3D model) and to associate a suggested value to those specific advertisements units. The interaction between the bidding system and the advertiser may occur in an automated fashion, in that the advertiser may establish, through a bidding interface, preexisting content to push along with bidding parameters. Thereafter, when bidding opportunities arise, the data entered through the bidding interface may be automatically accessed and a bid may be generated automatically to enable real-time insertion of content into a broadcast in progress, or an expected broadcast.

In some embodiments, advertisers or advertisement agents may associate an advertisement unit to a given object or objects. For example, a car manufacturer may associate a specific banner, 3D model, image, or video to an object identified as a ‘sports car.’ Based on a value the manufacturer assigns to an object ‘sports car,’ a matching system may determine when, where, and to which user an advertisement will be displayed (i.e., the matching system may determine a scene, object, time, or location for displaying an advertisement).

A typical use case may include adding a banner in an immersive manner to a real sports car in an AR or MR environment. Another use case may include adding a banner to a digitized sports car model within a VR consumed scene. Still another use case may involve an AR or MR environment and include replacing a real sports car in the AR or MR environment with an advertised sports car, so a user experiencing the AR or MR environment will see the advertised sports car displayed instead of the real one. Similar applications may involve replacing an original model in a VR scene with an advertised model.

In a VR-constructed scene for some embodiments of this disclosure, a designer or creator of the scene may predetermine which objects are good candidates for replacements or for embedding advertisement units. In some exemplary embodiments, an owner of a real object, a content provider, or any other person, machine, or organization may predefine which objects may be replaced with advertised objects in an AR or MR environment, or which objects may embed advertisements. For example, in an AR or MR environment of a real-world store, the store or a manufacturer of a product can embed AR or MR based advertisements to add content describing the product, its price, or use. These predetermined objects identified as candidates for replacements may be tagged by associating tags with those objects.

The bidding system may choose various parameters regarding which of the advertisement units should be incorporated in an AR/MR/VR consumer scene. Such parameters may include, but are not limited to, the similarity of a real or digitized object to an advertised object; a value associated with an object as assigned by an advertiser or advertisement agent; or a likelihood of a user to interact with an advertisement unit, time zone, place, etc.

According to various exemplary embodiments of the present disclosure, a novel scene augmentation and reconstruction concept may permit advertisers to bid on an object in a 3D broadcast scene, and to thereafter insert products into the 3D broadcast scene. For example, in connection with a virtual gaming environment, automotive manufacturers may be able to bid on the shape of a car, and the winning bidder's car will then be displayed in the 3D broadcast scene within the gaming environment. Similarly, beverage manufacturers may be permitted to bid on a bottle, and the winning bidder's beverage bottle may thereafter appear in a 3D broadcast scene.

An example of an implementation of a system based on the present disclosure follows. In the example, a user may play a game using a VR headset and, within the game, the user may enter a room with an office chair generated by the game (i.e., a “game-chair”). In the example, the disclosed advertising system may replace the game-chair with another chair provided by an advertiser, such as a branded chair. Of course, any object may be replaceable. Typically, such objects may include any consumer goods. However, objects may also include people. An advertiser seeking publicity for an individual (e.g. a political figure or media figure) may be able to bid to insert human images into content.

In one embodiment, a game may be programmed by a game developer using a 3D-representation of an environment. The disclosed system may analyze a part of the environment visible to a user in the game. The disclosed system may detect (i.e., recognize) objects by, for example, using scene segmentation to partition the visible environment into separate detected objects such as chair, table, bed, etc. Consistent with embodiments of the present disclosure, segmenting may additionally or alternatively be performed using techniques for segmenting discussed above. Segmenting may include identifying components of a scene or an object, such as a face of an object, a surface, or a component that is itself an object (e.g., identifying a wheel as an object-component of a car). For example, the system may use object recognition models, including machine-learning models. The disclosed system may also tag one or more recognized objects as a suitable candidates for replacement with 2D or 3D image content from an advertiser.

The disclosed system may solicit bids from one or more advertisers or advertising agents for 2D or 3D content suitable for replacing the tagged object in the broadcast scene. The disclosed system may receive and compare bids that are identified as being associated with the tagged object (e.g., bids that contain the text “office Chair”). The system may determine a maximum bid (e.g., bid with the highest dollar value) based on the comparison and select that bid as the winning bid. In addition to price, the system may also take into account compatibility with a scene. For example, if a highest bid comes from a manufacturer of a stool in a scene that requires a chair, the system may determine that a stool is not a good fit for the scene, and may select the next highest bid with a compatible chair. The system may receive from an advertiser or advertising agent associated with the winning bid, winner image data. Winner image data may be a 2D or 3D image provided by the advertiser or advertising agent for insertion into the broadcast scene. Accordingly, the disclosed system may extract the tagged object from the scene and combine the 2D or 3D winner image data with the extracted tagged object. The system may insert the hybrid rendering of the combination of the winner image data with the extracted tagged object into the broadcast scene. The disclosed system may also modify the received 2D or 3D winner image data to adjust orientation, scaling, size, lighting, color, texture, and/or other image properties to match the hybrid rendering with the 3D broadcast scene as naturally as possible.

In some embodiments, the disclosed system may transmit 2D or 3D content to one or more advertisers in advance of a broadcast. The one or more advertisers may be able to preview the content and identify one or more objects and/or scenes in which the advertisers may be interested in inserting the advertisers' own images. The disclosed system may enable the advertisers to use an interface (e.g., one or more client devices 1910) associated with the one or more advertisers to select objects of interest to the advertisers and/or to set rules that enable bidding on objects. In some embodiments, the interface may be a graphical user interface, which may allow the one or more advertisers to specify the objects and or scenes on which the advertisers may be interested in bidding for placement of their own images. For example, a user may be enabled to preview a scene and select one or more objects that the user wishes to replace with the user's own image(s)/object(s). The user interface may also allow the advertisers to specify rules for placement of advertising images. For example, an advertiser may specify that an object should be displayed whenever: the scene includes a particular other object or person; the profile of a viewer matches certain criteria; a view is in a certain demographic area; the broadcast occurs during a certain time interval, or any other criteria or combination of the forgoing criteria or other criteria of interest to the entity seeking to insert the object. Other rules may include specifying a time or duration for placement of an advertising image in the broadcast scene. Still other rules may specify the types of advertising images or identify particular images that should be displayed in the broadcast scene based on characteristics (e.g. age, race, ethnicity, demographics, political affiliations, etc.) of a user viewing the broadcast scene.

The disclosed system may also allow the advertisers to place bids during the preview phase. Advertisers may be able to place bids or specify rules for placing bids using the user interface provided by the disclosed system. For example, a bidding rule may specify a particular price, a particular image, duration of display, etc. based on a time of the broadcast and/or the characteristics of a user viewing the broadcast scene. During transmission of the broadcast scene to viewers, the disclosed system may automatically place bids for the one or more users/advertisers based on the previously specified bidding rules. The disclosed system may evaluate the bids and choose one or more winning bid from one or more users/advertisers (the winning advertisers). Further, the disclosed system may evaluate rules previously specified by the winning advertisers to identify winner image data for insertion into the broadcast scene. The disclosed system may also combine the winner image data with the broadcast scene in real time to present a scene including the winning advertisers' images in the scene being broadcast to one or more users.

Three alternative examples of operation include, 1) a user (e.g., representative of an advertiser) being presented with scenes to preview, enabling the user to select in advance objects on which to later bid. Such a selection may also include predefining the replacement objects that will be inserted into the scene if the bid is won. Then, in real time, the user's bid will compete with bids of others, and the replacement object of the winning bidder will be inserted, in real time, into the scene; 2) similar to the first example above, but with the bidding occurring in advance of broadcast, so that the winner is chosen in non-real time; and 3) presenting the user with an interface that allows the user to select rules and/or define parameters of an opportunity in which the user is interested in participating. During or prior to a real time broadcast, if the rules and/or predefined parameters are sufficiently met, the user might be automatically interjected into a bidding process that results in the user's object being inserted into a scene. The foregoing are simply a few examples providing a non-limiting sense of how the disclosed embodiments may operate.

In accordance with the present disclosure, a computer-implemented system for adding 3D content to a 3D broadcast scene is disclosed. The disclosed system may include a system capable of generating and/or displaying 3D broadcast scenes, including VR, AR, or MR environments, on a plurality of client devices. For example, the disclosed system may include a system that generates content viewable on a VR headset such as a software-based game played on the VR headset. Other exemplary disclosed systems may include or be capable of producing content compatible with a phone or tablet with an MR experience adding elements to a camera-view of a room; an MR headset representing a 3D-experience of a viewed room, with additional elements added to the real environment, or any other device used by a user to interact with a real or virtual scene.

As one of skill in the art will appreciate, the VR headset is but one example of how embodiments of this disclosure may be implemented. In this example, if previewed to a user, a representation of an object (e.g., an office chair object) may be accompanied by an indicator the object is available for replacement. For example, the office chair in the preview may include a visual indicator (highlighting, outlining, etc.) or a semantic indicator (e.g. text indicating tag “office chair”). This may enable a user (e.g. advertiser) to quickly identify the objects available for bid.

Consistent with disclosed embodiments, a 3D broadcast scene may include an image as seen or intended to be seen by a user. A 3D broadcast scene may include, for example a representation of a game environment designed by a game developer. A 3D broadcast scene may include an image as seen, for example, using a phone, computer screen, MR headset, or other device. In some embodiments a 3D broadcast scene may include images of real objects and virtual objects (i.e., AR/MR). A 3D broadcast scene may include information including a property of a viewer (e.g., a user playing a game), such as an age or an interest. Properties such as a date, time, or location may be included in a 3D broadcast scene. In some embodiments, properties of an experience may be included in a 3D broadcast scene, such as an angular speed of a view of a user experiencing a game, image data (e.g., RGB data); and/or depth camera data. A 3D broadcast scene may also include sensor data such as accelerometer data, gyroscope data, or GPS data embedded in a user device to extract position, translation and rotation of the user device, and/or speed and acceleration of a user device. Some devices, such as certain head mounted devices, capture eye movements and track eye gazing of the user to determine which elements of the scene may be more relevant to the user in a specific timing. Placement of objects inserted into scenes may take into account the user's gaze or may be optimized based on the user's gaze.

A 3D broadcast scene may include at least one of a still image, a series of video frames, a series of virtual 3D broadcast scenes, or a hologram. A still image may include an image in any image format (e.g., .JPG). A series of video frames may include a sequence of frames in 3D that, when provided to a viewer at a speed, give the appearance of motion. A series of video frames may be formatted in a known video format, such as .MP4 or any other known format. A series of virtual 3D broadcast scenes may include a series of 3D video frames configured for presentation in a VR, MR, or AR context, or a series of 3D broadcast scenes consistent with disclosed embodiments. A hologram may include data configured for projection so that the resulting projected light has the appearance of a 3D object. For example, a hologram may comprise data that, when provided to a device capable of emitting a split coherent beam of radiation (e.g., a laser), creates a three-dimensional image that arises from a pattern of interference by a split coherent beam of radiation.

In some embodiments, the disclosed system may include at least one processor. Exemplary descriptions of a processor and memory are described above, and also with reference to FIG. 2. In some embodiments, a processor of the system may be configured to display on a plurality of client devices at least one broadcast 3D scene. Displaying a broadcast scene may include displaying the images (still, video, holographic, etc.) on one or more display devices, which may include, for example, a VR headset, a phone or tablet, an MR headset, or other types of display devices. Alternative and additional descriptions of display devices are also provided in greater detail in reference to FIG. 2. While the present disclosure provides examples of display devices and of displaying a 3D broadcast scene, it should be noted that aspects of the disclosure in their broadest sense are not limited to particular examples.

In some embodiments, a processor of the system may be configured to display on the client devices at least one tag corresponding to at least one object in the 3D broadcast scene. A client device may include a phone, a tablet, a mobile device, a computer, a server, a cluster of servers, a cloud computing service, and/or any other client device. In some embodiments, a client device may comprise or be a component of an advertising system (i.e., a system managed by an advertiser, an advertising agency, an agent, or the like). A client device may connect to the disclosed system via a network (e.g., network 1940), consistent with disclosed embodiments. In some embodiments, a client device may connect to the disclosed system via a short-range wireless technology (e.g., BLUETOOTH, WI-FI) or a wired connection (e.g., a USB cable).

A tag may be an image element configured to add external information about an object, where an object may be a 3D object or a 2D image included in the 3D broadcast scene. More generally, a tag, may include any type of encoding of any piece of information. In some embodiments, a tag corresponding to at least one object in the 3D broadcast scene may include a color alteration, an object outline, or another visual indicator associated with the object, or text associated with the object. The tag may be generated by an algorithm. For example, an advertiser may provide text describing an object, and a text-parsing system may extract relevant keywords from the text for use in a tag corresponding to at least one object. Thus, for example, a tag may be a word, or a list of words. For example, a swivel chair may be tagged by one or more a “swivel,” “chair,” “swivel-chair,” “mobile-chair,” etc. A tag may include an indicator that may signal that a particular object in the 3D broadcast scene is open for bids to replace that object in the scene. For example, in a room with a table and a laptop on the table, the system may provide the tag “laptop” to the advertiser, who may then decide whether to bid on replacing a laptop object in the 3D broadcast scene with an image of a different laptop or another computing device.

In some aspects, a tag may not be attached to an existing object in the 3D broadcast scene, but may represent an object which may be added to the scene. For example, a laptop on a table in the scene may lead to the system suggesting the tag “mouse” to advertisers, for example, by associating the tag “mouse” with the laptop object. Advertisers may bid on adding a mouse to the scene, in a location suggested by the system, for example, near the laptop object. An empty table or other unoccupied space in a scene may be available for placement of predefined or undefined objects. While the present disclosure provides examples of a tag, a tag may be any indicator associatable with an object.

In some embodiments, at least one processor may be configured to display on the client devices instructions for placing at least one bid on the at least one tagged object. Instructions for placing at least one bid may include text or software programs that guide a user in bidding on either replacement or alteration of the tagged object or its surroundings. The instructions may guide the user in inputting a bid via the client device. The instructions may be incorporated into an auction system for placing a bid. For example, an interface may be configured to receive and transmit a price or a set of prices.

Placing a bid may include providing input associating a value with an object image identifier. A bid may include a duration (e.g., a bid to place an advertisement for a specific amount of time), a number of users (e.g., 1000 game players), a rate (a cost per unit time displayed or per person who receives a broadcast), or any other information. As an example, a client device (e.g., a client device operated by an advertiser) may place a bid for $0.10 per broadcast recipient. As one of skill in the art will appreciate, other examples of bids are possible. Placing a bid may include updating a previously placed bid. Placing a bid may include transmitting the bid to one or more components of the disclosed system. Transmitting may include transmitting over any network, such as a TCP/IP network.

In some embodiments, a client device may be configured to receive and transmit information via an interface. An interface may include a display, a VR headset, a touchscreen, a keyboard, a mouse, gaming console, and/or any other input or output device capable of providing information to a user and receiving information from user inputs. An interface may be dedicated to a particular use context (e.g., a kiosk). An interface may be configurable by a user. In some embodiments, a client device may be configured to implement an algorithm to generate or place a bid. While the present disclosure provides examples of placing bids on a tagged object, it should be noted that aspects of the disclosure in their broadest sense are not limited to particular examples.

In some embodiments, at least one processor may be configured to receive from the client devices one or more bids on the at least one tagged object. For example, multiple users may bid on the same object, and the system may receive bids from all such users. In some embodiments, receiving a bid may include receiving user input via a client device (e.g., a client device operated by an advertiser). In some embodiments, a bid may be received based on an algorithm or other executable code of a client device that generates and places a bid with or without real time user input. In a broadest sense, bids may be generated in any manner capable of conveying an intent of a user to make an offer.

In some embodiments, at least one processor may be configured to determine a winning bid from among the received one or more bids, the winning bid being associated with a winning client device from among the client devices. Determining a winning bid may be based on criteria such as a value (i.e., a monetary amount), a compatibility of an advertiser object to a scene, information relating to an audience, and/or any other information. In some embodiments, a criterion for determining a winning hid may be based on a likelihood that the bid winner will place a second bid after winning a first bid. For example, the disclosed system may determine that an advertiser may be likely to receive a positive result from winning the bid and that the advertiser may be likely to place a second bid at a future time. A positive result may include, for example, a product purchase, an increase in website traffic, mentions on social media, or the like. In a broadest sense, any criteria chosen by the system operator may be used to determine a winning bid.

In some embodiments, at least one processor may be configured to receive from the winning client device winner image data corresponding to the at least one tagged image. Winner image data may include any image data, consistent with disclosed embodiments. The winner image data may include a 2D or 3D image or model of an object or a label or logo to be added to an existing object. For example, winner image data may include a 2D logo of a beverage manufacturer suitable for display on the soda can, or, the winner image data may include a 3D model of a manufacturer's soda can. Consistent with disclosed embodiments, image data may be in any format, including .JPG, .BMP, .GIF, ,PNG, .SVG, a 3D vector format, a Computer-Aided Design file, .FLV, .MP4, .AVI, .MPG, .MP3, .MOV, .VR, or any other image, video, or model format. In some embodiments, winner image data may include text data (e.g., text data to project on an object in a scene) and/or any other change specified by the winning client device (e,g., a change in a level of lighting of a scene or a volume level). Winner image data can be any information to be added to the scene, whether it includes objects, labels, banners, human or animal likenesses, text, or symbols.

In some embodiments, at least one processor may be configured to isolate from the 3D broadcast scene 3D image data corresponding to the at least one tagged object. Isolating 3D image data of a tagged object may include segmenting the 3D broadcast scene into discrete objects, including the at least one tagged object. The at least one processor may employ one or more segmenting techniques discussed above. The disclosed system may compare a detected object from the broadcast scene with objects in a data structure storing objects. Comparing may include any method that permits comparing objects segmented from an image with objects stored in a data structure, including, for example, one or more of the techniques for comparing objects and/or image data discussed above. Such comparison may involve by way of example only, statistical analysis of similarities or artificial intelligence based approaches that identify similarities. In one example, comparing may involve determining a similarity metric indicating a degree of similarity between the tagged object and an object representation stored in the data structure. For example, the disclosed system may generate or retrieve a feature vector corresponding to the tagged object and compare the feature vector to a feature vector associated with an object representation stored in the data structure. The disclosed system may determine similarity between the tagged object and an object representation stored in the data structure based on a similarity metric. The similarity metric may be based on a statistical similarity such as a covariance, a least-squares distance, or a Hausdorff distance between the discrete component of the still image and a discrete component of a stored image. The disclosed system may identify an object in the broadcast scene that is similar to an object in the data structure based on the similarity metric.

In some embodiments, the system may process image elements in a broadcast scene to segment the scene into objects. The image elements may comprise at least one of a voxel, a point, or a polygon. A voxel may be a closed n-sided polygon (e.g., a cube, a pyramid, or any closed n-sided polygon). Voxels in a scene may be uniform in size or non-uniform. Voxels may be consistently shaped within a scene or may vary in a scene. During segmentation, the disclosed system may assign an image element to an object.

3D image data may comprise a 3D image or model of an object. 3D image data may include, for example, a digital or programmatic description of image elements (e.g. pixels, mesh points, polygons, voxels, etc.) associated with the object. 3D image data may also include semantic tags or graphs associated with the object. In some embodiments, 3D image data may include properties such as color, texture, shading, lighting, material properties, etc. associated with one or more image elements. In a broadest sense, any properties that describe the structure, function, appearance, or other characteristics of an object may be included in the 3D image data. Consistent with disclosed embodiments, image data may be in any format, including .JPG, .BMP, .GIF, .PNG, .SVG, a 3D vector format, a Computer-Aided Design file, .FLV, .MP4, .AVI, .MPG, .MP3, .MOV, .F4V, .VR, or any other image, video, or model format. Isolating 3D image data. may include identifying the image elements associated with a tagged object. Identifying the image elements may include labeling, or identifying; the image elements with text, a flag, or any other identifier or encoding to indicate that those elements are associated with the tagged object. In some aspects, isolating 3D image data may include storing the image elements associated with the tagged object in a separate memory or storage location. More generally, isolating 3D image data may include identifying image elements associated with a tagged object using any method of identification chosen by the system operator.

In some embodiments, a processor of the system may be configured to generate a 3D hybrid rendering of the tagged object by combining the winner image data with the extracted 3D image data. Generating a 3D hybrid rendering may include alignment of the winner image data with the isolated 3D image data. In some embodiments, an alignment of the winner image data with the isolated 3D image data may include an Affine transformation that transforms the (x, y, z) coordinates of the image elements of the winner image data to T(x, y, z) which is the desired location of this element in the coordinates of the extracted 3D image data. In other embodiments, generating a 3D hybrid rendering may include combining the winner image data with the extracted 3D image data by taking the union of the two families of image elements.

In yet other embodiments, generating a 3D hybrid rendering may include combining properties of the winner image data and the extracted image data to obtain a fused element. For example, suppose the winner image data and the extracted image data include a family of polygons. Each polygon may be associated with a texture. A texture may be a 2D-mapping from an image to the polygon representing how this polygon appears to a viewer (different parts of the polygon may have different colors for example). The alignment T of the winner image data and the extracted image data may be extended to determine a matching of the corresponding polygon families. For example, a polygon from the winner image data may be mapped to a polygon on the extracted image data using the transformation T to locate the closest winner image polygon relative to a polygon in the extracted image data. Using the matching, the system may match vertices of the polygons of the winner image data and the extracted image data. The disclosed system may also transfer a texture, material properties, etc., from the polygon of the winner image data to the polygon of the extracted 3D image data. Additional or alternative techniques for combining two images (e.g. first image and second image) discussed above may also be used to generate the hybrid rendering.

Consistent with disclosed embodiments, a 3D hybrid rendering may be in any format, including .JPG, .BMP, .GIF, .PNG, .SVG, a 3D vector format, a Computer-Aided Design file, .FLV, .MP4, .AVI, .MPG, .MP3, .MOV, .F4V, .VR, or any other image, video, or model format. In some embodiments, a 3D hybrid rendering may include text data (e.g., text data to project on an object in a scene) and/or any other change specified by the winning client device (e.g., a change in a level of lighting of a scene or a volume level). In the broadest sense, generating a 3D hybrid rendering may include any method of combining the properties (e.g. geometry, orientation, color, texture, appearance, material, movability properties, or other properties) of the winner image data with the properties of the extracted image data.

In some embodiments, a processor of the system may be configured to insert the hybrid rendering into a hybrid 3D broadcast scene. The disclosed system may employ techniques similar to those discussed above (e.g. affine transformation, polygon mapping, etc.) to combine the 3D hybrid rendering with the broadcast scene. A hybrid 3D broadcast scene may be in any format, including .JPG, .BMP, .GIF, .PNG, .SVG, a 3D vector format, a Computer-Aided Design file, .FLV, .MP4, .AVI, .MPG, .MP3, .MOV, .F4V, .VR, or any other image, video, or model format, and/or any other change specified by the winning client device (e.g., a change in a level of lighting of a scene or a volume level).

In some embodiments, the 3D broadcast scene may be a part of a video game. In some embodiments, the 3D broadcast scene be a part of a 3D movie. In some embodiments, the 3D broadcast scene may be a part of an online advertisement. It is contemplated that video game, 3D movie, and/or online advertisement may be in any format, including .JPG, .BMP, .GIF, .PNG, .SVG, a 3D vector format, a Computer-Aided Design file, .FLV, .MP4, .AVI, .MPG, .MP3, .MOV, .F4V, .VR, or any other image, video, or model format. The video game, 3D movie, and/or online advertisement may also be playable by the user.

In some embodiments, the computer-implemented system of claim 1 may be configured to perform image processing on the winner image data to render the winner image data compatible with a format of a 3D broadcast scene. For example, winner image data may be in a first format and a 3D broadcast scene may be in a second format. The disclosed system may be configured to transform winner image data from the first format to the second format, with or without intermediate transformations or processing. A format may include a broadcast format. Image processing of winner image data may include any method of image processing, consistent with disclosed embodiments. For example, image processing may include adjusting brightness, shadows, ambient light, contrast, hue, saturation, scaling, cropping, rotating, stretching, filtering, smoothing, or otherwise transforming image data. While the present disclosure provides examples of image processing to alter formats, it should be noted that aspects of the disclosure in their broadest sense are not limited to particular examples.

In some embodiments, the computer-implemented system of claim 1 may be configured to insert into a 3D broadcast scene an object from the winning image data within a plurality of frames. A 3D broadcast scene may include a plurality of frames constituting a virtual reality field of view. A virtual reality field of view may include a view of a VR, MR, or AR environment from one or more perspectives. For example, a VR environment may comprise a virtual room with a doorway, four walls, a ceiling, a floor, and furniture. A plurality of frames constituting a virtual reality field of view may include a plurality of frames of the virtual room as seen by a person standing in the doorway. As another example, a plurality of frames constituting a virtual reality field of view may include a plurality of frames of the virtual room as seen by a person sitting on the furniture. A virtual reality field of view may change over time. The disclosed system may be configured to isolate 3D image data corresponding to the tagged object from each of the frames. The disclosed system may be also configured to generate a plurality of 3D hybrid renderings by combining the winner image data with the isolated 3D image data from each of the plurality of frames. Further, the system may be configured to combine the 3D hybrid renderings with the remaining portions of the respective frames. Additional or alternative techniques for combining two images (e.g. first image and second image) discussed above may also be used to insert the 3D hybrid rendering into the 3D broadcast scene.

In some embodiments, the computer-implemented system of claim 1 may be configured to insert the hybrid rendering into a 3D broadcast scene such that the winner image data is overlaid on preexisting content in the 3D broadcast scene. In accordance with the present disclosure, inserting at least a rendition of the winner image data may render an object from the winning object image data within a plurality of frames. For example, winning object data may be virtually displayed within a broadcast. As an example, an object may be a particular sports car, and winning object image data may comprise an image of the particular sports car, and inserting a rendition of the winner image data may render the particular sports car within a plurality of frames. Winner image data may be inserted into at least one broadcast scene such that winner image data may be overlaid on preexisting content in at least one broadcast scene. As an example, overlaying winner image data on preexisting content may include super-imposing, from the perspective of a viewer of a VR environment, winner image data comprising an image (e.g. of a logo) on preexisting content comprising an image of a billboard. Overlaying winner image data may include adding a banner to an object (e.g., adding a banner to a back of a chair or to a bottle). Additional or alternative techniques for overlaying the winner image data on preexisting content may include the techniques for combining two images (e.g. first image and second image) discussed above, consistent with the embodiments of this disclosure.

In some embodiments, the disclosed system may include at least one processor configured to generate a spatial semantic graph for each scene. A spatial semantic graph may describe the spatial relations between the detected objects in the scene. The spatial semantic graphs for each scene may include features similar to those discussed above, consistent with embodiments of this disclosure. A spatial semantic graph may allow a system to infer the environment of a given scene. For example, the system may use the spatial semantic graph of the 3D broadcast scene with spatial semantic graphs of other scenes stored in, for example, a data structure to identify other scenes that include similar objects having similar spatial relationships. A spatial semantic graph may include a spatial semantic graph. A spatial semantic graph may include a list of objects in the scene, along with a description of their spatial relations. For example, the list may include “trash can, floor, bottle, table, chair, lamp, ceiling.” The list may also include the spatial relationships between these various objects. For example, the list may include relationships such as “trash can→on the→floor,” “bottle→on the→table,” “Lamp→hanging from→ceiling,” “Trash can→near→chair,” “Chair→below→lamp,” etc.

In some embodiments, the disclosed system may include at least one processor configured to compare the generated spatial semantic graph of the broadcast scene with spatial semantic graphs of scenes stored in a data structure. Exemplary data structures, consistent with the embodiments of this disclosure, are described above. Comparing may include checking for 2D or 3D object similarity, 2D or 3D semantic similarity, and/or 2D or 3D spatial semantic graph similarity. The system may identify one or more 3D scenes in the data structure having the closest or most similar spatial semantic graphs to the 3D broadcast scene. The system may determine closeness or similarity based on a statistical similarity such as a covariance, a least-squares distance, a distance between vectors associated with image elements (e.g., feature vectors), or a Hausdorff distance between aligned objects. The system may additionally or alternatively determine the distance between spatial semantic graphs using the weighted sum method disclosed above. In some embodiments, the system may determine the closeness or similarity based on a comparison of feature vectors associated with the 3D scenes. While the present disclosure provides examples of comparing spatial semantic graphs, it should be noted that aspects of the disclosure in their broadest sense, are not limited to the disclosed examples.

In some embodiments, the disclosed system may include at least one processor configured to identify scenes in the data structure having spatial semantic graphs similar to the generated spatial semantic graph. The disclosed system may identify one or more 3D scenes in the data structure having the closest or most similar spatial semantic graphs to the 3D broadcast scene. In some embodiments determining closest or most similar spatial semantic graphs may include comparing the covariance, least-squares distance, distance between vectors associated with image elements (e.g., feature vectors), or Hausdorff distance with an associated threshold. While the present disclosure provides examples of identifying scenes, it should be noted that aspects of the disclosure in their broadest sense, are not limited to the disclosed examples.

In some embodiments, the disclosed system may include at least one processor configured to determine information about the 3D broadcast scene based on identified scenes in the data structure. The information may include, for example, information regarding properties (texture, material, movability) etc. of objects in the 3D broadcast scene based on similar properties of objects in the identified scenes. The disclosed system may be configured to understand the “environment” of the scene, e.g. office scene, sports club, beach etc. based on the determined properties. The disclosed system may use the determined environment to identify particular advertisers who may be interested in bidding on a tagged object in the broadcast scene. For example, if the disclose system determines that the environment is an “office scene,” the disclosed system may display the tags and instructions for placing bids on client devices associated with office furniture manufacturers, and not, for example, beach furniture manufacturers or sporting goods manufacturers. While the present disclosure provides examples of determining information about 3D scenes, it should be noted that aspects of the disclosure in their broadest sense, are not limited to the disclosed examples.

It is to be understood that the aforementioned steps and methods may be performed in real-time. In some embodiments, the disclosed system may be configured to obtain at least one broadcast scene in real-time and to insert a rendition of the winner image data in at least one broadcast scene in real-time. As one of skill in the art will appreciate, steps may be performed in various orders, and some or all steps may be repeated to change a broadcast in real-time. For example, in some embodiments, winner image data displayed in the broadcast scene may change after a predetermined period of time. To illustrate this example, a virtual billboard in a VR environment may display winner image data comprising a first logo for ten minutes and display a second logo at the end of the ten minutes. A predetermined time may be set by an advertising system. In some embodiments, a bid may include a predetermined time (e.g., an advertiser may set an amount of time to display an image object). In some embodiments, predetermined time may be determined by a user (i.e., an audience member). As one of skill in the art will appreciate, a predetermined period of time may include a scheduled time (e.g., changing a winning image data displayed after a predetermined period of time may include changing at a set time, such as at 3:00 pm).

FIG. 19 depicts an exemplary system 1900 for adding 3D content to a preexisting 3D broadcast scene, consistent with embodiments of the present disclosure. As shown, system 1900 may include a client device 1910, a 3D content generator 1920, a data structure 1930, and/or a user device 1950. Components of system 1900 may be connected to each other via a network 1940. In some embodiments, aspects of system 1900 may be implemented on one or more cloud services. In some embodiments, aspects of system 1900 may be implemented on a computing device, including a mobile device, a computer, a server, a cluster of servers, or a plurality of server clusters.

As will be appreciated by one skilled in the art, the components of system 1900 may be arranged in various ways and implemented with any suitable combination of hardware, firmware, and/or software, as applicable. For example, as compared to the depiction in FIG. 19, system 1900 may include a larger or smaller number client devices, 3D content generators, data structures, user devices, and/or networks. In addition, system 1900 may further include other components or devices not depicted that perform or assist in the performance of one or more processes, consistent with the disclosed embodiments. The exemplary components and arrangements shown in FIG. 19 are not intended to limit the disclosed embodiments.

In some embodiments, client device 1910 may be associated with an advertiser, an advertising agent, and/or any other individual or organization. For example, client device 1910 may be configured to execute software to allow an advertiser to place a bid on inserting content into a 3D broadcast scene, consistent with disclosed embodiments. Client device 1910 may include one or more memory units and one or more processors configured to perform operations consistent with disclosed embodiments. In some embodiments, client device 1910 may include hardware, software, and/or firmware modules. Client device 1910 may include a mobile device, a tablet, a personal computer, a terminal, a kiosk, a server, a server cluster, a cloud service, a storage device, a specialized device configured to perform methods according to disclosed embodiments, or the like. Client device may be configured to receive user inputs (e.g., at an interface), to display information (e.g., images and/or text), to communicate with other devices, and/or to perform other functions consistent with disclosed embodiments. In some embodiments, client device is configured to implement an algorithm to place a bid based on information received from another device (e.g., from 3D content generator 1920).

3D content generator 1920 may include a computing device, a computer, a server, a server cluster, a plurality of server clusters, and/or a cloud service, consistent with disclosed embodiments, 3D content generator 1920 may include one or more memory units and one or more processors configured to perform operations consistent with disclosed embodiments. 3D content generator 1920 may be configured to receive data from, retrieve data from, and/or transmit data to other components of system 1900 and/or computing components outside system 1900 (e.g., via network 1940).

Data structure 1930 may be hosted on one or more servers, one or more clusters of servers, or one or more cloud services. In some embodiments, data structure 1930 may be a component of 3D content generator 1920 (not shown). Data structure 1930 may include one or more data structures configured to store images, video data, image object information, image object identifiers, metadata, labels, and/or any other data. Data structure 1930 may be configured to provide information regarding data to another device or another system. Data structure 1930 may include cloud-based data structures, cloud-based buckets, or on-premises data structures.

User device 1950 may be any device configured to receive and/or display a 3D broadcast scene, including VR, AR, and/or MR data. For example, user device 1950 may include a mobile device, a smartphone, a tablet, a computer, a headset, a gaming console, and/or any other user device. In some embodiments, user device 1950 may be configured to receive and/or display a broadcast. User device 1950 may include one or more memory units and one or more processors configured to perform operations consistent with disclosed embodiments. In some embodiments, User device 1950 may include hardware, software, and/or firmware modules.

One or more of client device 1910, 3D content generator 1920, data structure 1930, and/or user device 1950 may be connected to network 1940. Network 1940 may be a public network or private network and may include, for example, a wired or wireless network, including, without limitation, a Local Area Network, a Wide Area Network, a Metropolitan Area Network, an IEEE 1002.11 wireless network (e.g., “Wi-Fi”), a network of networks (e.g., the Internet), a land-line telephone network, or the like. Network 1940 may be connected to other networks (not depicted in FIG. 19) to connect the various system components to each other and/or to external systems or devices. In some embodiments, network 1940 may be a secure network and require a password to access the network.

Consistent with the present disclosure, the disclosed system may include at least one processor, which may be configured to execute one or more instructions, algorithms, etc. to perform the functions of the preview system. By way of example, as illustrated in FIGS. 2 and 19, system 1900 may include one or more processors 202 included in one or more of client device 1910 and 3D content generator 1920.

FIG. 3 depicts exemplary system 300 for selecting bids from advertisers and inserting an image corresponding to a winning bid into a 3D broadcast scene from an audiovisual environment, consistent with embodiments of the present disclosure. System 300 may be an example implementation of system 1900.

As shown, system 300 may include data for a 3D broadcast scene 302 which may be digitized. Scene 302 is not limited to 3D data and may include VR data, AR data, MR data, image data, video data, and/or any other scene data. Scene 302 may include a representation of image objects, such as chair 304, sofa 306, and/or table 308.

System 300 may be configured to receive advertiser bids 310. An advertiser bid may include identifying information identifying an advertiser, an account, an individual, or other identifying information. For example, identifying information may include the labels “Advertiser 1,” “Advertiser 2,” or “Advertiser 3.” An advertiser bid may include object information. Object information may include an object identifier such as an object identifier for a product such as “Chair 1,” “Chair 2,” or “Chair 3.” An advertiser bid may be associated with a respective bid amount, represented by dollar signs in advertiser bids 310.

In some embodiments, system 300 may be configured to identify a winning bid and replace an object in scene 302 with an object associated with the winning bid (e.g., winner image data). Identifying a winning bid may be based on criteria, consistent with disclosed embodiments. For example, system 300 may be configured to replace a scene chair with a chair associated with the highest bid (312) (e.g., from Advertiser 2).

System 300 may be configured to perform a rendering 314. Rendering may include processing a 3D broadcast scene to insert a rendition of winner image data at the object insertion location. As discussed above, rendering may include isolating a tagged object from the scene, combining the winner image data with the extracted image data associated with the tagged object to generate a hybrid rendering, and inserting the hybrid rendering into the broadcast scene. Rendering 314 may include any image processing technique as described herein or any other image processing technique. Rendering 314 may be formatted for display by a VR device and/or a screen (VR/Screen 316). A user 318 may view a rendered scene via VR/Screen 316.

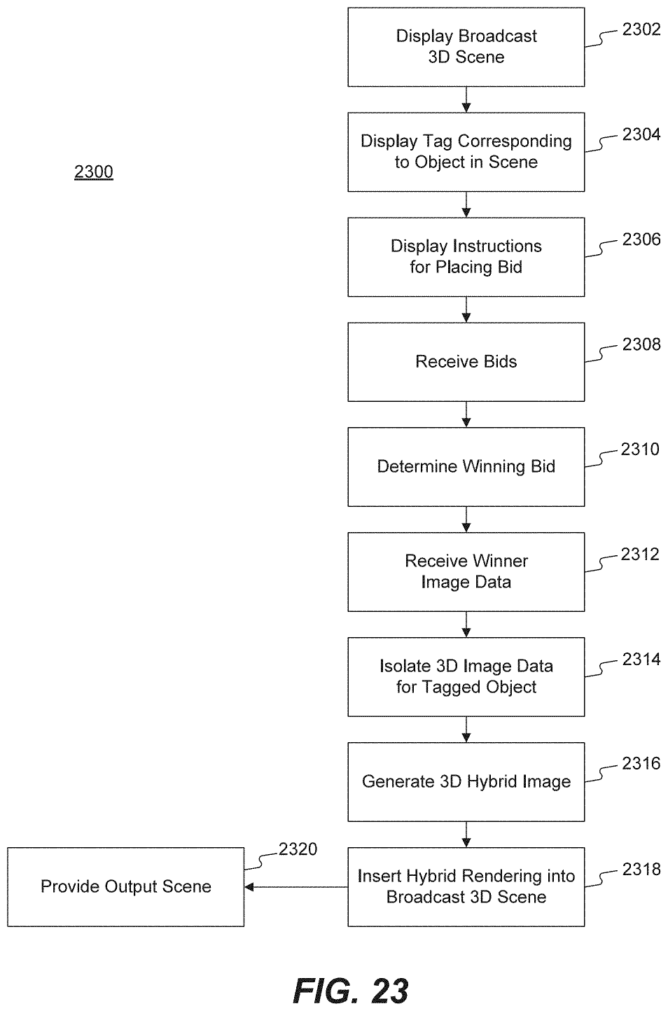

FIG. 23 depicts exemplary method 2300 of selecting and inserting advertisement images into an existing scene from an audiovisual environment, consistent with embodiments of the present disclosure. As will be appreciated from this disclosure, modifications may be made to method 2300 by, for example, adding, combining, removing, and/or rearranging the steps of method 2300. Steps of method 2300 may be performed by components of system 1900, including, but not limited to, 3D content generator 1920. For example, although method 2300 may be described as steps performed by 3D content generator 1920, it is to be understood that client device 1910 and/or user device 1950 may perform any or all steps of method 2300. As one of skill in the art will appreciate, method 2300 may be performed together with any other method described herein. For example, it is to be understood that process 2300 may include steps (not shown), and/or any other actions, consistent with disclosed embodiments. Process 2300 may be performed in real-time to alter an ongoing transmission of media content, consistent with disclosed embodiments.

At step 2302, client device 1910 may display a broadcast 3D scene. A broadcast 3D scene may be received or retrieved from a data storage, consistent with disclosed embodiments. A broadcast 3D scene may be received from another component of system 1900 and/or another computing component outside system 1900 (e.g., via network 1940). A broadcast 31) scene may be retrieved from a memory (e.g., memory 206), data structure (e.g., data structure 1930), or any other computing component.

A broadcast 3D scene may be a VR, AR, and/or MR scene, consistent with disclosed embodiments. A broadcast 3D scene may be a 2D and/or 3D scene. A broadcast 3D scene may be in any format (e.g., F4V, .VR, etc.). A broadcast 3D scene may include preexisting 3D broadcast scenes, consistent with disclosed embodiments. A broadcast 3D scene may include a previously modified scene, such as a scene that includes a processed 3D broadcast scene that comprises winner image data, as described herein. Generally, a broadcast 3D scene may include any visual media.

At step 2304, client device 1910 may display a tag, or other descriptor of a product corresponding to an object in a broadcast scene, consistent with disclosed embodiments. For example, 3D content generator 1920 may scan the broadcast scene to detect an object such as a chair, a table, or a soda bottle. Other examples of objects are possible. 3D content generator 19.20 may associate one or more tags with one or more detected objects. 3D content generator 1920 may transmit the tags to one or more client devices 1910, which may display the one or more tags on display devices associated with the client devices 1910.

At step 2306, client device 1910 may display instructions for placing one or more bids on the one or more tagged objects, consistent with disclosed embodiments. Placing a bid may include receiving input associating a value with the tagged object. Placing a bid may include updating a previously placed bid. At step 2308, 3D content generator 1920 may receive one or more bids from one or more client devices 1910, which may transmit the bids to 3D content generator 1920 consistent with data structure 1930 may display instructions for receiving a bid, consistent with disclosed embodiments.

At step 2310, 3D content generator 1920 may determine the winning bid, consistent with disclosed embodiments. 3D content generator 1920 may also identify a winning client device associated with the winning bid, consistent with disclosed embodiments. At step 2312, 3D content generator 1920 may receive winner image data from a winning client device, consistent with disclosed embodiments. In some embodiments, 3D content generator 1920 may store the winning image data in a memory and/or data structure associated with one or more components of system 1900.

At step 2314, 3D content generator 1920 may isolate 3D image data associated with the tagged object, consistent with disclosed embodiments. At step 2316 3D content generator 1920 may generate a 3D hybrid image by combining the winner image data with the extracted 3D image data associated with a tagged object, consistent with disclosed embodiments. In some embodiments, 3D content generator 1920 may mesh a 2D image file received from client device 1910 with the 3D object to create a 3D meshed rendering within the 2D scene. At step 2318 3D content generator 1920 may insert the hybrid rendering into the broadcast 3D scene, consistent with disclosed embodiments.

At step 2320, 3D content generator 1920 may provide an output scene, consistent with disclosed embodiments. Providing an output scene at step 2320, may include storing and/or transmitting an output scene, consistent with disclosed embodiments. For example, step 2320 may include broadcasting an output scene and/or storing an output scene in memory (e.g., memory 206, storage medium 208, and/or data structure 1930).

Systems and methods disclosed herein may involve unconventional improvements over conventional approaches to computer-implemented advertising bidding systems for use in VR, AR, and/or MR technology and applications. Systems and methods disclosed herein may also involve unconventional improvements over conventional computer-implemented approaches to processing images and scanned 3D or other scenes. Systems and methods disclosed herein may also involve unconventional improvements over conventional computer-implemented approaches to controlling the interaction of robots with objects in the robot's environment. Systems and methods disclosed herein may involve unconventional improvements over conventional computer-implemented approaches to automating 3D content creation. Systems and methods disclosed herein may also involve unconventional improvements over conventional approaches to computer-implemented 3D content generation systems for use in VR, AR, and/or MR technology and applications. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

Computer programs based on the written description and methods of this specification are within the skill of a software developer. The various functions, scripts, programs, or modules may be created using a variety of programming techniques. For example, programs, scripts, functions, program sections or program modules may be designed in or by means of languages, including JAVASCRIPT, C, C++, JAVA, PHP, PYTHON, RUBY, PERL, BASH, or other programming or scripting languages. One or more of such software sections or modules may be integrated into a computer system, non-transitory computer readable media, or existing communications software. The programs, modules, or code may also be implemented or replicated as firmware or circuit logic.

Moreover, while illustrative embodiments have been described herein, the scope may include any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with a true scope and spirit being indicated by the following claims and their full scope of equivalents.

1-80. (canceled)

81. A control system for a robot, the control system comprising:
at least one processor configured to:
receive image information for a scene depicting an environment associated with the robot;
segment the scene to extract image data associated with at least one object in the scene;
access a data structure storing historical information about a plurality of objects;
compare the extracted image data with the historical information in the data structure to identify corresponding information in the data structure about the at least one object, wherein the corresponding information includes a script representing movability characteristics of the at least one object; and
control the robot by applying the script, to thereby cause the robot to interact with the at least one object based on the movability characteristics defined by the script.

82. The control system of claim 81, wherein the at least one processor is configured to segment the scene by processing image elements in the scene, the image elements including at least one of a voxel, a point, or a polygon.

83. The control system of claim 81, wherein the robot includes a camera configured to generate the image information for the scene.

84. The control system of claim 81, wherein the movability characteristics include at least one rule defining a movement of the at least one object based on an external stimulus.

85. The control system of claim 84, wherein the at least one processor is configured to adjust the external stimulus exerted by the robot on the at least one object based on the movability characteristics of the at least one object.

86. The control system of claim 81, wherein the at least one processor is configured to generate a modified scene based on an interaction of the robot with the at least one object.

87. The control system of claim 86, wherein the at least one processor is configured to output the modified scene for display.

88. The control system of claim 81, wherein the at least one processor is further configured to:
select another script associated with the at least one object, the another script representing an interaction between the at least one object and at least one other object in the scene; and
apply the script to the at least one object.

89. A computer-implemented method for controlling a robot, the method comprising:
receiving image information for a scene depicting an environment associated with the robot;
segmenting the scene to extract image data associated with at least one object in the scene;
accessing a data structure storing historical information about a plurality of objects;
comparing the extracted image data with the historical information in the data structure to identify corresponding information in the data structure about the at least one object, the corresponding information including a script representing movability characteristics of the at least one object; and
controlling the robot by applying the script, to thereby cause the robot to interact with the at least one object based on the movability characteristics defined by the script.

90. The method of claim 89, wherein segmenting the scene includes processing image elements in the scene, the image elements including at least one of a voxel, a point, or a polygon.

91. The method of claim 89, wherein receiving the image information includes generating the image information for the scene using a camera associated with the robot.

92. The method of claim 89, wherein the movability characteristics include at least one rule defining a movement of the at least one object based on an external stimulus.

93. The method of claim 92, further including adjusting the external stimulus exerted by the robot on the at least one object based on the movability characteristics of the at least one object.

94. The method of claim 89, further including generating a modified scene based on an interaction of the robot with the at least one object.

95. The method of claim 94, further including outputting the modified scene for display.

96. The method of claim 94, further including:
selecting another script associated with the at least one object, the another script representing an interaction between the at least one object and at least one other object in the scene; and
applying the script to the at least one object.

97. A non-transitory computer readable medium including instructions that, when executed by at least one processor, cause the at least one processor to execute operations for controlling a robot, the operations comprising:
receiving image information for a scene depicting an environment associated with the robot;
segmenting the scene to extract image data associated with at least one object in the scene;
accessing a data structure storing historical information about a plurality of objects;
comparing the extracted image data with the historical information in the data structure to identify corresponding information in the data structure about the at least one object, the corresponding information including a script representing movability characteristics of the at least one object; and
controlling the robot by applying the script, to thereby cause the robot to interact with the at least one object based on the movability characteristics defined by the script.

98. The non-transitory computer readable medium of claim 97, wherein receiving the image information includes generating the image information for the scene using a camera associated with the robot.

99. The non-transitory computer readable medium of claim 97, wherein the movability characteristics includes at least one rule defining a movement of the at least one object based on an external stimulus.

100. The non-transitory computer readable medium of claim 99, further including adjusting the external stimulus exerted by the robot on the at least one object based on the movability characteristics of the at least one object.

101-140. (canceled)
